(19) United States
(12) Patent Application Publication
(10) Pub. No.: US 2012/0303476 A1
(43) Pub. Date: Nov. 29, 2012

(54) COMMUNICATION DEVICES, NETWORKS, SERVICES AND ACCOMPANYING METHODS

(75) Inventors: Paul Krzyzanowski, Flemington, NJ (US); Daniel Gittleman, Delray Beach, FL (US)

(73) Assignee: OPENPEAK INC., Boca Raton, FL (US)

(21) Appl. No.: 13/292,902

(22) Filed: Nov. 9, 2011

Related U.S. Application Data
(60) Provisional application No. 61/411,800, filed on Nov. 9, 2010.

(51) Int. Cl. G06Q 30/00

(52) U.S. Cl. 705/26.5; 705/27.1; 705/26.61

(57) ABSTRACT

Mobile electronic devices, docking stations, and communication systems that include the same, as well as features and services offered by such mobile electronic devices, docking stations and communication systems are described. A mobile device in accordance with one embodiment includes a dual-mode capacitance sensor that can perform both a fingerprint scanning function and a user interface device function. A docking station in accordance with another embodiment can engage a mobile electronic device and also be removably attached to a component. Docking stations are also described that can communicate with one another to extend the feature sets of each. A mobile electronic device in accordance with another embodiment supports multiple profiles. Finally, a system in accordance with an embodiment performs attribute-based presentation of applications available in an application store to a mobile electronic device.

### CROSS-REFERENCE TO RELATED APPLICATIONS

This application claims priority to U.S. Provisional Patent Application No. 61/411,800, filed Nov. 9, 2010 and entitled “Communication Devices, Networks, Services and Accompanying Methods,” the entirety of which is incorporated by reference herein.

### FIELD OF TECHNOLOGY

The subject matter described herein is related to mobile electronic devices, docking stations, and communication systems that include the same, as well as features and services offered by such mobile electronic devices, docking stations and communication systems.

### BACKGROUND

Manufacturers of mobile electronic devices such as tablet computers and smart phones and the entities that provide services related to such devices are constantly seeking ways to improve the form factor, utility and operation of these products. In particular, it has become important for manufacturers and service providers to distinguish their offered devices from those of their competitors. Thus, there is a move towards increasing the utility of mobile electronic devices, including those used in a business setting, and to improving access to and the performance of applications for mobile electronic devices and their supporting infrastructure.

### SUMMARY

A variety of mobile electronic devices, docking stations, and communication systems that include the same, as well as features and services offered by such mobile electronic devices, docking stations and communication systems.

For example, a mobile electronic device is described herein. The mobile electronic device includes a dual-mode capacitance sensor, fingerprint scanning logic, user interface device logic and sensor control logic. The dual-mode capacitance sensor receives input from a user's finger for performing a fingerprint scanning function when operating in a first mode and for performing a user interface device function when operating in a second mode. The fingerprint scanning logic is configured to process the input to perform the fingerprint scanning function when the dual-mode capacitance sensor is operating in the first mode. The user interface device logic is configured to process the input to perform the user interface device function when the dual-mode capacitance sensor is operating in the second mode. The sensor control logic is configured to determine a mode of operation of the dual mode capacitance sensor and to enable either the fingerprint scanning logic or the user interface device logic to process the input based on the mode of operation of the dual-mode capacitance sensor.

In accordance with one embodiment, the dual-mode capacitance sensor of the mobile electronic device operates in the first mode when the mobile electronic device is in a locked state and operates in the second mode when the mobile electronic device is in an unlocked state.

In accordance with another embodiment, the fingerprint scanning logic of the mobile electronic device is further configured to perform biometric authentication of a user.

In accordance with yet another embodiment, the fingerprint scanning logic of the mobile electronic device is further configured to process the input to generate digital data corresponding to a fingerprint of the user, to compare the generated digital data to known authorized user fingerprint data, to determine whether the generated digital data matches the known authorized user fingerprint data, to authenticate the user in response to determining that the generated digital data matches the known authorized user fingerprint data, and to inform the device control logic when the user has been authenticated.

The mobile electronic device may further include device control logic that is configured to lock the mobile electronic device to prevent unauthorized access of the mobile electronic device and to unlock the mobile electronic device upon authentication of a user. The device control logic may be further configured to lock the mobile electronic device in response to the mobile electronic device entering a sleep state. The device control logic may also be configured to lock the mobile electronic device in response to a user command. The locking/unlocking operation may apply to the device or be applied to specific applications or user logins (including workspaces, if the system supports, for example, separate workspaces for work and home).

In accordance with a particular embodiment, the sensor control logic of the mobile electronic device is further configured to disable one or both operating modes of the dual-mode capacitance sensor in response to a user command.

The mobile electronic device may also include display logic that is configured to generate output as graphical images presented on a display of the mobile electronic device. In accordance with such an embodiment, the user interface device logic may be further configured to process the input to determine location and movement of a user's finger on the dual-mode capacitance sensor, to interpret the location and movement of the user's finger as input commands, and to send data containing the input commands to the display logic. In further accordance with such an embodiment, the display logic may be further configured to interpret the data containing the input commands and to apply the input commands to the output to alter the graphical images presented on the display according to the input commands.

In an embodiment, the display referred to above may be disposed on a front side of the mobile electronic device and the dual-mode capacitance sensor may be disposed on a back side of the mobile electronic device. In accordance with such an embodiment, the user interface device function may allow the user to scroll through the graphical images presented on the display disposed on the front side of the mobile electronic device by swiping a finger on the dual mode capacitance sensor disposed on the back side of the mobile electronic device. In further accordance with such an embodiment, the user interface device function may further allow the user to select an item presented on the display or move a cursor presented on the display by tapping on the dual-mode capacitance sensor.

A method for using a dual-mode capacitance sensor to perform dual functions in a mobile electronic device is also described herein. In accordance with the method, input is received from the dual-mode capacitance sensor in response to a user touching a surface of the dual-mode capacitance sensor. A mode of operation of the dual-mode capacitance sensor is determined. The input is processed to perform a fingerprint scanning function in response to determining that the dual-mode capacitance sensor is operating in a first mode. The input is processed to perform a user interface device function in response to determining that the dual-mode capacitance sensor is operating in a second mode.

In accordance with one implementation of the foregoing method, determining the mode of operation of the dual-mode capacitance sensor includes determining whether the mobile electronic device is in a locked state or an unlocked state, and determining that the dual-mode capacitance sensor is operating in the first mode in response to determining that the mobile electronic device is in the locked state, and determining that the dual-mode capacitance sensor is operating in the second mode in response to determining that the mobile electronic device is in the unlocked state.

In accordance with another implementation of the foregoing method, processing the input to perform a fingerprint scanning function may include processing the input to generate digital data corresponding to a fingerprint of the user, comparing the generated digital data to known fingerprint data of one or more authorized users, determining whether the generated digital data matches any of the known fingerprint data to perform biometric authentication of the user, and authenticating the user when the generated digital data matches any of the known fingerprint data.

The foregoing method may further include locking the mobile electronic device to prevent unauthorized access of the mobile electronic device and unlocking the mobile electronic device in response to authentication of a user. The foregoing method may still further include locking the mobile electronic device in response to the mobile electronic device entering a sleep state or locking the mobile electronic device in response to a user command.

The foregoing method may also include disabling one or both operating modes of the dual-mode capacitance sensor in response to a user command.

In accordance with one embodiment of the foregoing method, processsing the input to perform a user interface device function may include processing the input to determine location and movement of a user's finger on the dual-mode capacitance sensor, interpreting the location and movement of the user's finger as input commands, and applying the input commands to manipulate an output presented on a display of the mobile device. In further accordance with such an embodiment, the output may comprise graphical images and the step of applying the input commands to manipulate the output presented on a display of the mobile electronic device may include scrolling the graphical images presented on the display in response to a user swiping the dual-mode capacitance sensor. In still further accordance with such an embodiment, applying the input commands to manipulate the output presented on a display of the mobile electronic device may further include moving a cursor presented on the display.

Another mobile electronic device is described herein. The mobile electronic device includes a front panel comprising a display, a back panel comprising a housing, and a dual-mode capacitance sensor disposed on the back panel. The dual-mode capacitance sensor performs both a fingerprint scanning function and a user interface device function depending on an operating mode of the dual-mode capacitance sensor. When the dual-mode capacitance sensor is performing a user interface device function, inputs to the dual-mode capacitance sensor on the back panel manipulate graphical images presented on the display on the front panel.

In one embodiment of the mobile electronic device, the front panel and the back panel have substantially rectangular dimensions, and the dual-mode capacitance sensor is positioned to be centered between long sides of the back panel and closer to one short side of the back panel than the other.

In another embodiment of the mobile electronic device, the dual-mode capacitance sensor is disposed in a recessed area of the housing. The dual-mode capacitance sensor may also be disposed under a glass portion of the housing. Alternatively, the dual-mode capacitance sensor may be disposed under a plastic portion of the housing and is indicated by a graphic.

The foregoing mobile electronic device may further include one or more additional features, including but not limited to a flip-out kick stand attached to the back panel or a perforated audio element that comprises a portion of the front panel and that is positioned at a peripheral edge of the display.

A docking station for a mobile electronic device is also described herein. The docking station includes an engaging structure with which the mobile electronic device can be selectively engaged and disengaged and a mounting element connected to the engaging structure. The engaging structure is configured to at least physically support the mobile electronic device when the mobile electronic device is engaged therewith. The mounting element is configured to enable the docking station to be removably attached to a component.

In one embodiment of the docking station, the mounting element is configured to enable the docking station to be removably attached to a display component. In further accordance with such an embodiment, the docking station may be configured such that both a display of the mobile electronic device and a display of the display component will be visible to a user when the mobile electronic device is engaged with the engaging structure and the docking station is removably attached to the display component.

In another embodiment of the docking station, the mounting element includes a first mounting portion connected to the engaging structure and a second mounting portion connected to the first mounting portion. The first mounting portion is configured to engage a top front edge of the component when the docking station is removably attached thereto. The second mounting portion is configured to engage a rear portion of the component when the docking station is removably attached thereto. In further accordance with such an embodiment, the first mounting portion may be pivotally connected to the second mounting portion. For example, the mounting element may further comprise a friction hinge that pivotally connects the first mounting portion to the second mounting portion.

In still further accordance with such an embodiment, the second mounting portion may be configured to act as a counter-weight to the mobile electronic device when the mobile electronic device is engaged with the engaging structure and when the docking station is removably attached to the component. Also, at least one of the first mounting portion and the second mounting portion may be spring-biased toward the other. Additionally, at least one of the first mounting portion and the second mounting portion may include a padding element that is configured to protect the component from damage when the docking station is removably attached thereto.

The foregoing docking station may further include a housing that houses a camera, wherein the camera is configured to capture images of an area in front of the component when the docking station is removably attached thereto. In accordance with such an embodiment, a field of view of the camera may be adjusted by a user. A docking station in accordance with such an embodiment may also include an interface for communicating data representing images captured by the camera to the mobile electronic device. Such interface may comprise, for example, one of a High Definition Multimedia Interface (HDMI), a DisplayPort interface, a Universal Serial Bus (USB) interface, or a Bluetooth® interface. Such an interface may also include metal connectors that form part of the engaging structure and are configured to interact with metal connectors of the mobile electronic device. Alternatively or additionally, the docking station may further include an interface for communicating data representing images captured by the camera to a network, or an interface for communicating data representing images captured by the camera to another docking station.

The foregoing docking station may also include an interface for transferring power to the mobile electronic device when the mobile electronic device is engaged with the engaging structure. Such interface may include metal connectors that form part of the engaging structure and are configured to interact with metal connectors of the mobile electronic device. Alternatively or additionally, such interface may utilize inductive charging to transfer power to the mobile electronic device.

In one embodiment of the docking station, the engaging structure is configured to at least mechanically engage the mobile electronic device. In another embodiment of the docking station, the engaging structure is configured to at least magnetically engage the mobile electronic device.

A system is described herein that includes a mobile electronic device and a docking station. The mobile electronic device includes video teleconferencing logic. The docking station includes a first camera and an engaging structure with which the mobile electronic device can be selectively engaged and disengaged. The engaging structure is configured to physically support the mobile electronic device when the mobile electronic device is engaged therewith and includes a first interface for providing images captured by the first camera to the video teleconferencing logic when the mobile electronic device is engaged therewith. The video teleconferencing logic is configured to conduct a video teleconference when the mobile electronic device is engaged with the engaging structure. Conducting the video teleconference includes transmitting the images captured by the first camera to a remote video teleconferencing system.

In one embodiment of the foregoing system, a field of view of the first camera may be adjusted by a user.

In another embodiment of the foregoing system, the mobile electronic device further includes a second camera and conducting the video teleconference comprises transmitting the images captured by the first camera and images captured by the second camera to the remote video teleconferencing system.

In yet another embodiment of the system, the docking station further comprises a mounting element connected to the engaging structure, the mounting element being configured to enable the docking station to be removably attached to a component. For example, the mounting element may be configured to enable the docking station to be removably attached to a display component. In further accordance with such an embodiment, the first camera may be configured to capture images of a workspace in front of the component and the second camera may be configured to capture images of a user of the mobile electronic device.

In an embodiment, the mounting element referred to above includes a first mounting portion that is connected to the engaging structure and a second mounting portion that is connected to the first mounting portion. The first mounting portion is configured to engage a top front edge of the component when the docking station is removably attached thereto. The second mounting portion is configured to engage a rear portion of the component when the docking station is removably attached thereto. In further accordance with such an embodiment, the first mounting portion may be pivotally connected to the second mounting portion. For example, the mounting element may also include a friction hinge that pivotally connects the first mounting portion to the second mounting portion. The second mounting portion may also be configured to act as a counter-weight to the mobile electronic device when the mobile electronic device is engaged with the engaging structure and when the docking station is removably attached to the component. Additionally, at least one of the first mounting portion and the second mounting portion may be spring-biased toward the other. Also, at least one of the first mounting portion and the second mounting portion may include a padding element that is configured to protect the component from damage when the docking station is removably attached thereto.

In another embodiment of the foregoing system, the first interface includes metal connectors that form part of the engaging structure and are configured to interact with metal connectors of the mobile electronic device. The docking station may also include a second interface for transferring power to the mobile electronic device when the mobile electronic device is engaged with the engaging structure.

Another system is described herein. The system includes a first docking station and a second docking station. The first docking station includes a first engaging structure with which a mobile electronic device can be selectively engaged and disengaged, a camera, and a first interface that is configured to provide images captured by the camera to the mobile electronic device when the mobile electronic device is engaged with the first engaging structure. The second docking station includes a second engaging structure with which the mobile electronic device can be selectively engaged and disengaged. The first docking station and the second docking station each further comprises a communication interface by which the first docking station can provide the images captured by the camera to the second docking station.

In accordance with one embodiment of this system, the second docking station further comprises a second interface that is configured to provide the images captured by the camera to the mobile electronic device when the mobile electronic device is engaged with the second engaging structure.

In another embodiment of the system, the second docking station further includes a network interface that is configured to provide the images captured by the camera to a remote entity via a network.

In yet another embodiment of the system, the first docking station further includes a microphone and the first interface is further configured to provide audio captured by the microphone to the mobile electronic device when the mobile electronic device is engaged with the first engaging structure. The first docking station can provide the audio captured by the microphone to the second docking station via the communication interfaces. In further accordance with such an embodiment, the second docking station may further include a second interface that is configured to provide the audio captured by the microphone to the mobile electronic device when the mobile electronic device is engaged with the second engaging structure. The second docking station may also include a network interface that is configured to provide the audio captured by the microphone to a remote entity via a network.

Another mobile electronic device is described herein. The mobile electronic device includes a memory and a processing unit. The memory stores one or more first applications associated with a first profile, one or more second applications associated with a second profile, and an operating system configured to operate in a first mode in which only the first application(s) are made accessible to a user or a second mode in which only the second application(s) are made accessible to the user. The processing unit is configured to execute the operating system, to execute any of the first application(s) responsive to user selection thereof when the operating system is operating in the first mode, and to execute any of the second application(s) responsive to user selection thereof when the operating system is operating in the second mode.

In accordance with one embodiment of the mobile electronic device, the memory further stores one or more third applications associated with a third profile, the operating system is further configured to operate in a third mode in which only the third application(s) are made accessible to the user, and the processing unit is further configured to execute any of the third application(s) responsive to user selection thereof when the operating system is operating in the third mode.

In one embodiment of the mobile electronic device, the operating system is further configured to store data associated with the first application(s) in a first area of the memory and to store data associated with the second application(s) in a second area of the memory that is different than the first area.

In another embodiment of the mobile electronic device, the operating system is further configured to store data associated with the first application(s) in an unencrypted format and to store data associated with the second application(s) in an encrypted format. In further accordance with such an embodiment, the operating system may be further configured to store data associated with each one of the second application(s) in an encrypted format that is determined at least in part by an encryption key that is uniquely associated with the second application. In the most general form, each profile (workspace) may have its applications store data in an encrypted form.

In yet another embodiment of the mobile electronic device, the operating system is further configured to present a first user interface to a display of the mobile electronic device when operating in the first mode and to present a second user interface to the display when operating in the second mode.

In a further embodiment of the mobile electronic device, the operating system is further configured to enforce at least one policy with respect to the execution of at least one of the second application(s) that is not enforced with respect to the execution of any of the first application(s). In the most general form, each profile—or even application—can be configured to enforce policies assigned to them.

In a still further embodiment of the mobile electronic devices, the operating system is further configured to manage a network connection request made by at least one of the second application(s) in a manner that is different than a manner in which network connection requests made by any of the first application(s) are managed.

In another embodiment of the mobile electronic device, the memory further stores a profile management client uniquely associated with the second profile. The profile management client is configured to enable a remote entity to manage one or more of the second application(s). The operating system is configured to cause the processing unit to execute the profile management client only when the operating system is operating in the second mode. In further accordance with such an embodiment, the profile management client may be configured to enable a remote entity to download, update, remove and/or track usage information associated with any of the second application(s).

In yet another embodiment of the mobile electronic device, the memory further stores a user authentication process uniquely associated with the second profile. The user authentication process is configured to authenticate the user prior to providing access to any of the second application(s). The operating system is configured to cause the processing unit to execute the user authentication process only when the operating system is operating in the second mode. In the most general form, each profile (workspace) may be protected using a different user authentication process.

Yet another mobile electronic device is described herein. The mobile electronic device includes a memory and a processing unit. The memory stores one or more first applications associated with a first profile, one or more second applications associated with a second profile, a first application launcher configured to make only the first application(s) accessible to a user, the first application(s) including a second application launcher, and the second application launcher, the second application launcher being configured to make only the second application(s) accessible to the user. The processing unit is configured to execute the first application launcher, to execute any of the first application(s) responsive to user selection thereof when the first application launcher is executing, and to execute any of the second application(s) responsive to user selection thereof when second application launcher is executing. In the most general case, any number of launchers may be supported.

In one embodiment of the mobile electronic device, the first application launcher is configured to present a first user interface to a display of the mobile electronic device and the second application launcher is configured to present a second user interface to the display.

In another embodiment of the mobile electronic device, the memory further store an operating system configured to manage resource requests generated by at least the first application(s), and application management logic associated with the second application(s), the application management logic being configured to manage at least selected resource requests generated by the second application(s). The processing unit is further configured to execute the operating system and to execute the application management logic in association with the execution of one or more of the second application(s).

The application management logic described above may be configured to store data associated with the second application(s) in a second area of memory that is different from a first area of memory in which data associated with the first application(s) is stored.

The application management logic described above may also be configured to store data associated with the second application(s) in an encrypted format. In further accordance with such an embodiment, the application management logic may be configured to store data associated with each one of the second application(s) in an encrypted format that is determined at least in part by an encryption key that is uniquely associated with the second application.

The application management logic described above may further be configured to enforce at least one policy with respect to the execution of at least one of the second application(s) that is not enforced with respect to the execution of any of the first application(s).

The application management logic described above may still further be configured to manage a network connection request made by at least one of the second application(s) in a manner that is different than a manner in which network connection requests made by any of the first application(s) are managed.

In one embodiment of the mobile electronic device, the memory further stores a profile management client uniquely associated with the second profile. The profile management client is configured to enable a remote entity to manage one or more of the second application(s). The processing unit is further configured to execute the profile management client only when the second application launcher is executing. In further accordance with such an embodiment, the profile management client may be configured to enable a remote entity to download, update, remove and/or track usage information associated with any of the second application(s).

In another embodiment of the mobile electronic device, the memory further stores a user authentication process uniquely associated with the second profile. The user authentication process is configured to authenticate the user prior to executing the second application launcher. The processing unit is further configured to execute the user authentication process when the user selects the second application launcher for execution.

Another method is described herein. In accordance with the method, a mode of operation of a mobile electronic device is determined, wherein the mode of operation may comprise a first mode of operation associated with a first profile or a second mode of operation associated with a second profile. In response to determining that the mode of operation of the mobile electronic device is the first mode of operation, only one or more first applications associated with the first profile are made accessible to a user and any of these first application(s) are executed responsive to user selection thereof. In response to determining that the mode of operation of the mobile electronic device is the second mode of operation, only one or more second applications associated with the second profile are made accessible to the user and any of these second application(s) are executed responsive to user selection thereof.

In accordance with one embodiment of the foregoing method, the mode of operation may further include a third mode of operation associated with a third profile, and the method may further include, in response to determining that the mode of operation of the mobile electronic device is the third mode of operation, making only one or more third applications associated with the third profile accessible to the user and executing any of the third application(s) responsive to user selection thereof.

The foregoing method may further include storing data associated with the first application(s) in a first area of a memory of the mobile electronic device and storing data associated with the second application(s) in a second area of the memory that is different than the first area.

The foregoing method may also include storing data associated with the first application(s) in an unencrypted format and storing data associated with the second application(s) in an encrypted format. In further accordance with such an embodiment, storing data associated with the second application(s) in an encrypted format may include storing data associated with each one of the second application(s) in an encrypted format that is determined at least in part by an encryption key that is uniquely associated with the second application.

The foregoing method may additionally include presenting a first user interface to a display of the mobile electronic device in response to determining that the mobile electronic device is operating in the first mode and presenting a second user interface to a display of the mobile electronic device in response to determining that the mobile electronic device is operating in the second mode.

The foregoing method may also include enforcing at least one policy with respect to the execution of at least one of the second application(s) that is not enforced with respect to the execution of any of the first application(s).

The foregoing method may further include managing a network connection request made by at least one of the second application(s) in a manner that is different than a manner in which network connection requests made by any of the first application(s) are managed.

The foregoing method may still further include executing a profile management client in response to determining that the mobile electronic device is operating in the second mode, the profile management client being configured to enable a remote entity to manage one or more of the second application(s). In further accordance with such an embodiment, executing the profile management client may comprise enabling a remote entity to download, update, remove and/or track usage information associated with any of the second application(s).

The foregoing method may also include executing a user authentication process in response to determining that the mobile electronic device is operating in the second mode, the user authentication process being configured to authenticate the user prior to providing access to any of the second application(s).

A method for performing attribute-based presentation of applications available in an application store to a mobile electronic device is also described herein. In accordance with the method, one or more features of the mobile electronic device are determined. It is then determined if each application in a plurality of applications in the application store is suitable for installation and/or execution by the mobile electronic device by comparing the determined one or more features of the mobile electronic device to one or more attributes associated with the application. Then a list that includes any application in the plurality of applications that is determined to be suitable for execution by the mobile electronic device is transmitted to the mobile electronic device.

In accordance with various embodiments, the step of comparing the determined one or more features of the mobile electronic device to the attribute(s) associated with the application may include: comparing an operating system of the mobile electronic device to an attribute that specifies a target operating system for the application; comparing an operating system version of the mobile electronic device to an attribute that specifies a minimum supported operating system version for the application; comparing an operating system version of the mobile electronic device to an attribute that specifies a latest version of an operating system upon which the application has been tested; comparing a product type of the mobile electronic device to an attribute that specifies a product type supported by the application; comparing the determined one or more features of the mobile electronic device to an attribute that specifies a hardware feature that is required by the application (wherein the hardware feature that is required by the application may include an accelerometer, a magnetometer, a Global Positioning System (GPS) receiver, a microphone, a camera, multiple cameras, or multiple displays); comparing one or more display resolutions supported by the mobile electronic device to an attribute that specifies one or more display resolutions supported by the application; comparing a vendor of the mobile electronic device to an attribute that specifies a vendor of mobile electronic devices; comparing a service provider used by the mobile electronic device to an attribute that specifies a service provider; or comparing a customer type associated with the mobile electronic device to an attribute that specifies a particular customer type.

In accordance with one embodiment of the foregoing method, comparing the determined one or more features of the mobile electronic device to the attribute(s) associated with the application includes obtaining the attribute(s) associated with the application from descriptive metadata associated with the application.

In accordance with another embodiment of the foregoing method, comparing the determined one or more features of the mobile electronic device to the attribute(s) associated with the application includes obtaining the attribute(s) associated with the application from a relational database that maps attributes to applications. It is noted that the invention is not limited to the use of a relational database. Any storage structure that allows one to enumerate capabilities (attributes) with an application reference may be used.

In accordance with a further embodiment of the foregoing method, determining if each application in the plurality of applications is suitable for installation and/or execution by the mobile electronic device by comparing the determined one or more features of the mobile electronic device to the attribute(s) associated with the application to comprises determining a set of attributes necessary to install and/or execute an application on the mobile electronic device based on the determined one or more features of the mobile electronic device, and comparing the set of attributes to the attribute(s) associated with each application in the plurality of applications. In further accordance with such an embodiment, comparing the set of attributes to the attribute(s) associated with each application in the plurality of applications may include querying a relational database that maps attributes to applications to identify applications that have attributes that match the set of attributes.

In accordance with another embodiment of the foregoing method, determining the one or more features of the mobile electronic device comprises querying the mobile electronic device to determine the one or more features. Determining the one or more features of the mobile electronic device may alternatively comprise obtaining an identifier of the mobile electronic device and using the identifier to obtain the one or more features of the mobile electronic device from a database that maps identifiers of mobile electronic devices to features of mobile electronic devices.

The foregoing method may also include identifying the plurality of applications by executing an application search based on search criteria selected and/or input by a user of the mobile electronic device.

The foregoing method may additionally include providing an interface by which a developer can submit a new application to the application store and specify one or more attributes associated with the new application.

The foregoing method may still further include providing an interface that enables an administrator to add or remove attributes associated with applications.

A system that performs attribute-based presentation of applications available in an application store to a mobile electronic device is also described herein. The system includes a feature determination module, an application search module and an application presentation module. The feature determination module is configured to determine one or more features of the mobile electronic device. The application search module is configured to determine if each application in a plurality of applications in the application store is suitable for installation and/or execution by the mobile electronic device by comparing the determined one or more features of the mobile electronic device to one or more attributes associated with the application. The application presentation module is configured to transmit to the mobile electronic device a list that includes any application in the plurality of applications that is determined by the application search module to be suitable for execution by the mobile electronic device.

In accordance with a variety of implementations, the application search module may be configured to compare the determined one or more features of the mobile electronic device to the attribute(s) associated with the application by: comparing an operating system of the mobile electronic device to an attribute that specifies a target operating system for the application; comparing an operating system version of the mobile electronic device to an attribute that specifies a minimum supported operating system version for the application; comparing an operating system version of the mobile electronic device to an attribute that specifies a latest-released version of an operating system upon which the application has been tested; comparing a product type of the mobile electronic device to an attribute that specifies a product type supported by the application; comparing the determined one or more features of the mobile electronic device to an attribute that specifies a hardware feature that is required by the application (wherein the hardware feature that is required by the application may comprise an accelerator, a magnetometer, a GPS receiver, a microphone, a camera, multiple cameras, or multiple displays; comparing one or more display resolutions supported by the mobile electronic device to an attribute that specifies one or more display resolutions supported by the application; comparing a vendor of the mobile electronic device to an attribute that specifies a vendor of mobile electronic devices; comparing a service provider used by the mobile electronic device to an attribute that specifies a service provider; or comparing a customer type associated with the mobile electronic device to an attribute that specifies a particular customer type.

In accordance with one embodiment of the foregoing system, the application search module is configured to obtain the attribute(s) associated with the application from descriptive metadata associated with the application.

In accordance with another embodiment, the application search module is configured to obtain the attribute(s) associated with the application from a relational database that maps attributes to applications.

In accordance with yet another embodiment, the application search module is configured to determine a set of attributes necessary to install and/or execute an application on the mobile electronic device based on the determined one or more features of the mobile electronic device and to compare the set of attributes to the attribute(s) associated with each application in the plurality of applications. In further accordance with such an embodiment, the application search module may be configured to query a relational database that maps attributes to applications to identify applications that have attributes that match the set of attributes.

In accordance with a further embodiment of the foregoing system, the feature determination module is configured to receive the one or more features from an application store application that queries the mobile electronic device to determine the one or more features. Alternatively, the feature determination module may be configured to obtain an identifier of the mobile electronic device and to use the identifier to obtain the one or more features of the mobile electronic device from a database that maps identifiers of mobile electronic devices to features of mobile electronic devices.

In accordance with one embodiment of the system, the application search module is further configured to identify the plurality of applications by executing an application search based on search criteria selected and/or input by a user of the mobile electronic device.

The foregoing system may further include a developer interface server configured to provide an interface by which a developer can submit a new application to the application store and specify one or more attributes associated with the new application.

The foregoing system may also include an administrator interface server configured to provide an interface that enables an administrator to add or remove attributes associated with applications.

A computer program product is also described herein. The computer program product comprises a computer-readable medium having computer logic recorded thereon for enabling a processing unit to perform attribute-based presentation of applications available in an application store to a mobile electronic device. The computer program logic includes first computer program logic, second computer program logic, and third computer program logic. When the first computer program logic is executed by the processing unit, it causes the processing unit to determine one or more features of the mobile electronic device. When the second computer program logic is executed by the processing unit, it causes the processing unit to determine if each application in a plurality of applications in the application store is suitable for installation and/or execution by the mobile electronic device by comparing the determined one or more features of the mobile electronic device to one or more attributes associated with the application. When the third computer program logic is executed by the processing unit, it causes the processing unit to transmit to the mobile electronic device a list that includes any application in the plurality of applications that is determined to be suitable for execution by the mobile electronic device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1-6 provide various perspective views of a handset that may be used in a communication system in accordance with an embodiment.

FIG. 7 is a perspective view of a handset engaged with an accompanying docking station that may be used in a communication system in accordance with an embodiment.

FIG. 8 is a perspective view of a docking station that may be used in a communication system in accordance with an embodiment.

FIGS. 9 and 10 provide additional perspective views of a handset engaged with an accompanying docking station that may be used in a communication system in accordance with an embodiment.

FIG. 11 is a perspective view of a handset engaged with and an accompanying docking station that may be used in a communication system in accordance with an embodiment, wherein the docking station is configured to be attached to a component.

FIG. 12-14 provide perspective views of a handset engaged with an accompanying docking station that may be used in a communication system in accordance with an embodiment, wherein the docking station is attached to a component.

FIG. 15 provides a perspective view of a docking station that may be used in a communication system in accordance with an embodiment, wherein the docking station is configured to be attached to a component.

FIG. 16 shows example main docking stations that may be used in a communication system in accordance with an embodiment.

FIG. 17 shows example simple docking stations that may be used in a communication system in accordance with an embodiment.

FIGS. 18 and 19 show a tower docking station that may be used in a communication system in accordance with an embodiment.

FIGS. 20-22 illustrate a docking station that may be used in a communication system in accordance with an embodiment, wherein the docking station is configured to be attached to a component.

FIG. 23 provides multiple perspective views of a handset that may be part of a communication system in accordance with an embodiment.

FIG. 24 illustrates an example of a charger that may be part of a communication system in accordance with an embodiment.

FIG. 25 illustrates another example of a handset that may be part of a communication system in accordance with an embodiment.

FIG. 26 illustrates an example of a handset that may be part of a communication system in accordance with an embodiment, wherein the handset can support multiple profiles.

FIG. 27 illustrates an example of a handset that may be part of a communication system in accordance with an embodiment, wherein the handset can support multiple users.

FIG. 28 illustrates several example use cases for a handset that may be part of a communication system in accordance with an embodiment.

FIG. 29 illustrates an example of a handset that includes a biometric identification mechanism and that may be part of a communication system in accordance with an embodiment.

FIG. 30 illustrates an example of a handset that can permit remote control of linked components and that may be part of a communication system in accordance with an embodiment.

FIG. 31 illustrates an example of a handset that may be part of a communication system in accordance with an embodiment, wherein the handset can enable document recognition and/or sharing.

FIG. 32 illustrates an example of a handset that may be part of a communication system in accordance with an embodiment, wherein the handset can be used to assist in the transport of goods.

FIG. 33 illustrates an example of a handset that may be part of a communication system in accordance with an embodiment, wherein the handset can be used for permitting access.

FIG. 34 illustrates an example of a handset that can communicate with a headset, wherein both the handset and the headset may be part of a communication system in accordance with an embodiment.

FIG. 35 illustrates examples of various components that may be part of a communication system in accordance with an embodiment and several features that may be offered by such components.

FIG. 36 illustrates an example of a user interface (UI) for an application shop that may be part of a communication system in accordance with an embodiment.

FIG. 37 illustrates an example of another UI for an application shop that may be part of a communication system in accordance with an embodiment.

FIG. 38 illustrates an example of yet another UI for an application shop that may be part of a communication system in accordance with an embodiment.

FIG. 39 illustrates an example of a tablet that may be part of a communication system in accordance with an embodiment.

FIG. 40 illustrates an example of another tablet that may be part of a communication system in accordance with an embodiment.

FIG. 41 illustrates another example of a tablet and associated docking station that may be part of a communication system in accordance with an embodiment.

FIG. 42 illustrates an example of a tablet that may support a Virtual Desktop Infrastructure (VDI) and that may be part of a communication system in accordance with an embodiment.

FIG. 43 illustrates examples of several UIs that may be presented by a tablet that may be part of a communication system in accordance with an embodiment.

FIG. 44 illustrates examples of several UIs that may be presented by a tablet that may be part of a communication system in accordance with an embodiment.

FIG. 45 illustrates various example UIs for managing multiple user accounts that may be presented by a tablet that is part of the communication system in accordance with an embodiment.

FIG. 46 illustrates examples of several views that may be presented by a tablet that may be part of a communication system in accordance with an embodiment.

FIG. 47 illustrates examples of several telephony UIs that may be provided by a tablet that may be part of a communication system in accordance with an embodiment.

FIG. 48 illustrates examples of several security/monitoring UIs that may be presented by a tablet or handset that may be part of a communication system in accordance with an embodiment.

FIG. 49 illustrates an arrangement in which multiple components are coupled to one another through cloud services, all of which may be part of a communication system in accordance with an embodiment.

FIG. 50 is a block diagram of a managed ecosystem that may be implemented by a communication system in accordance with an embodiment.

FIG. 51 is a block diagram of a mobile device that includes a dual-mode capacitance sensor in accordance with an embodiment.

FIG. 52 depicts a flowchart of a method of use of a dual mode capacitance sensor of a mobile device in accordance with an embodiment.

FIG. 53 provides a perspective view of a handset that may be used in a communication system in accordance with an embodiment.

FIG. 54 is a block diagram of a system in accordance with an embodiment in which a camera of a docking station can be used to extend video teleconferencing abilities of a mobile electronic device.

FIG. 55 depicts a flowchart of a method for conducting a video teleconference in accordance with an embodiment.

FIG. 56 depicts a block diagram of a system in accordance with an embodiment that includes a first docking station, a second docking station, and a mobile electronic device that can be selectively engaged with either the first docking station or the second docking station, wherein the first docking station and the second docking station are also communicatively connected to each other.

FIG. 57 is a block diagram of a set of profiles that may be supported by a single mobile electronic device in accordance with an embodiment.

FIG. 58 is a block diagram of an example architecture of a mobile electronic device that includes a mobile operating system (OS) that is configured to provide support for multiple profiles.

FIG. 59 is a block diagram of an example architecture of a mobile electronic device that is configured to provide support for multiple profiles in a manner that does not involve modifying a mobile OS thereof.

FIG. 60 depicts a flowchart of a method for supporting multiple profiles on a mobile electronic device in accordance with an embodiment.

FIG. 61 is a block diagram of an example system that performs attribute-based presentation of available applications in an application store in accordance with an embodiment.

FIG. 62 depicts a flowchart of a method for performing attribute-based presentation of applications available in an application store to a mobile electronic device.

FIG. 63 is a block diagram of a processor-based computing system that may be used to implement various components described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Introduction

The following detailed description refers to the accompanying drawings that illustrate exemplary embodiments. However, the scope of the subject matter presented herein is not limited to these embodiments, but is instead defined by the appended claims. Thus, embodiments beyond those shown in the accompanying drawings, such as modified versions of the illustrated embodiments, may nevertheless be encompassed by the claims. Furthermore, numerous specific details are set forth herein in order to provide a thorough understanding of the described embodiments. However, it will be understood by persons skilled in the relevant art(s) that the embodiments described herein can be practiced without these specific details. In other instances, methods, procedures and components have not been described in detail so as not to obscure the related relevant feature being described. Also, the description is not to be considered as limiting the scope of the embodiments described herein.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

A communication system is described herein. In one embodiment, the communication system includes numerous handsets and docking stations, examples of which will be presented below. The communication system can provide call manager support over Wi-Fi (IEEE 802.11), 3G (third generation mobile telecommunications) or 4G (fourth generation mobile telecommunications), which can allow a user to carry his/her office phone for use in various locations. The use of Wi-Fi can also reduce reliance on mobile networks, thereby reducing expenses. The system can also provide services like Web-based conference calls or video calls, including configurations where calling parties can view one another and engage in face-to-face collaborations. The system can also simplify virtual private network (VPN) access and offer mobile VPN hotspots.

A handset of the system can dock at a docking station in a person's place of business or office to replicate a traditional phone experience and offer desktop interactive video call services, while simultaneously providing integrated charging. The handset can also include a headset that can be used in the office or when a person is moving or travelling. The system can also permit information technology (IT) personnel to implement required security controls, update firmware, push applications, or the like. Biometrics can also be implemented for enhanced security, and Global Positioning System (GPS) can be employed for mobile workplace management. As part of the system, an enterprise-class application shop can be offered. This shop can offer an application experience that leverages, for example, an established marketplace for existing electronic devices (e.g., the Android™ Market for Android™ Operating System (OS) devices) and can also provide enterprise features for licensing, management, or the like. The system can also permit the sharing of applications across various platforms.

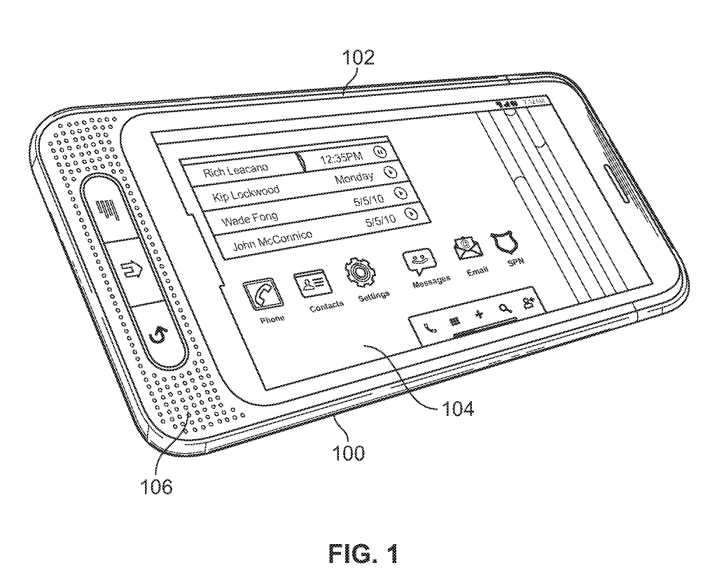

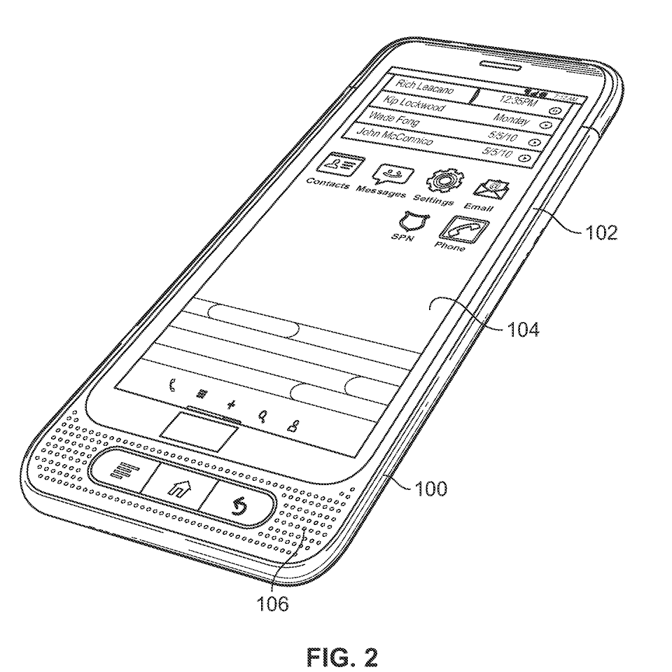

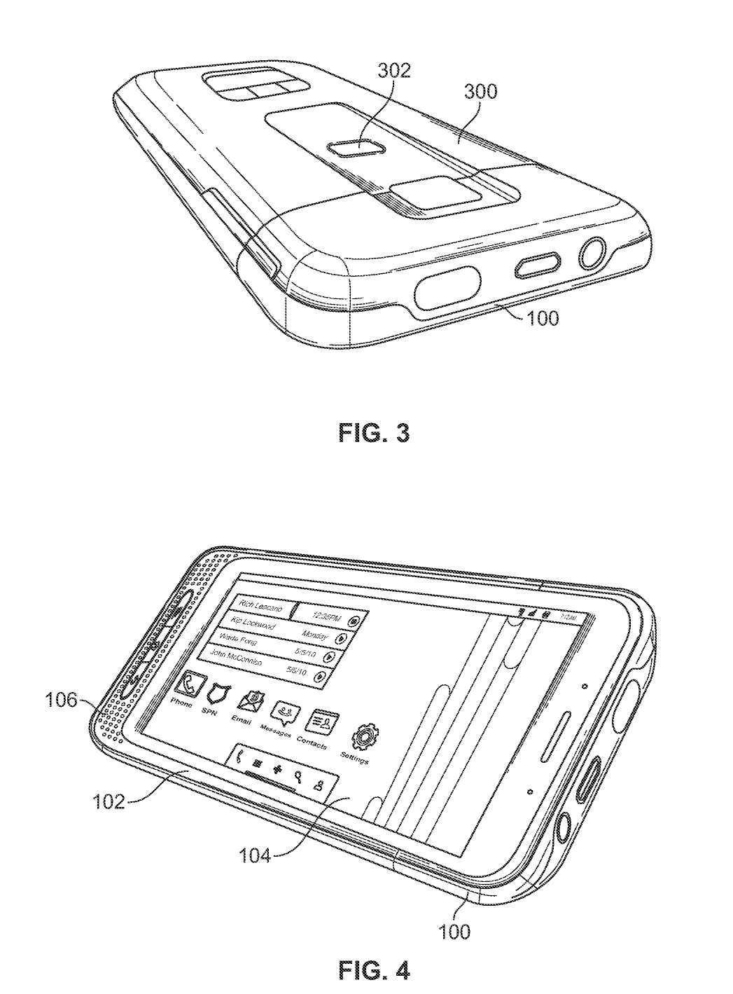

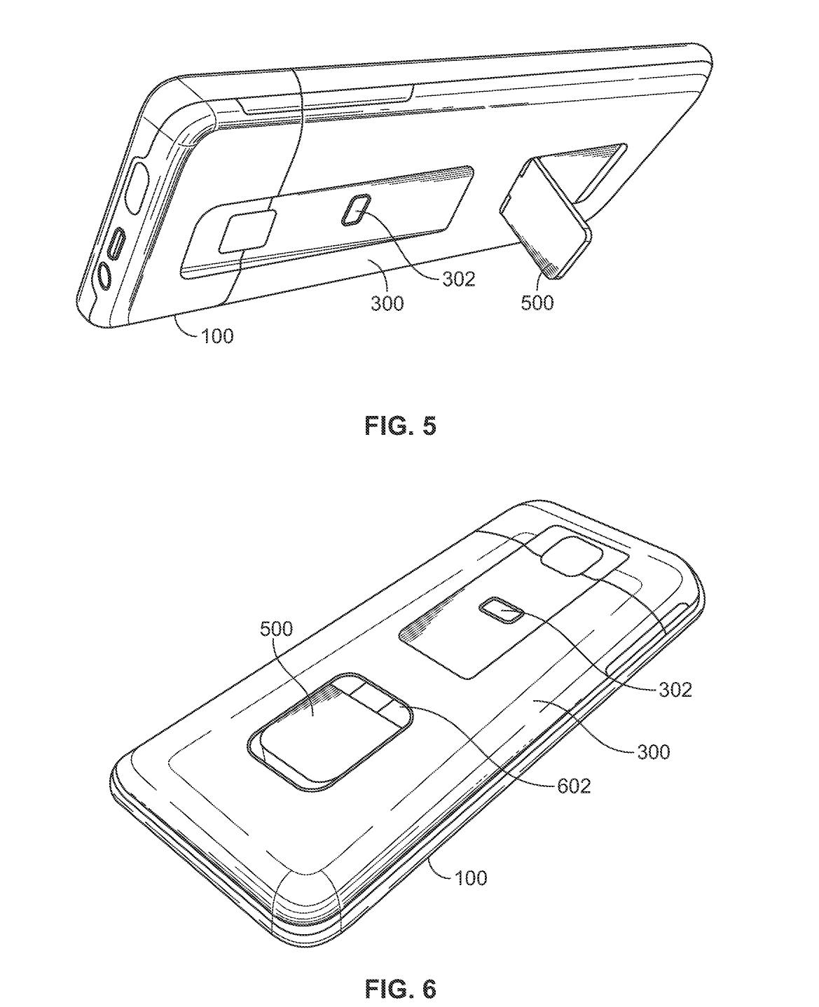

Referring to FIGS. 1 and 2, perspective views of an example of a handset 100 that may comprise part of the system are presented. Handset 100 can support multiple user accounts through any suitable platform or operating system, such as the Android™ OS. If desired, the front of handset 100 can include a perforated audio element 106 for a more direct and present audio delivery. Referring to FIGS. 3-5, several more perspective views of handset 100 are presented. As can be seen, handset 100 can include a kick-stand 500 that can provide a more controlled and relaxed video experience, as it presents an improved viewing angle. As reflected in FIGS. 3, 5 and 6, handset 100 can include, for example, a sensor 302 that can operate both as a fingerprint scanner and a user interface device to allow for single-handed authentication, web/document scrolling, or the like, making for even faster interactions. More details regarding an implementation that include such a dual-mode sensor are provided below in Section B. In addition, kickstand 500 may include a hinge plate 602 that can be broken out into one or more pieces (such as three pieces), thereby providing contact surfaces for dock charging. Radio frequency identification (RFID) technology can also be integrated into handset 100, which can allow access control to be managed remotely and can eliminate the need for separate key cards or key fobs.

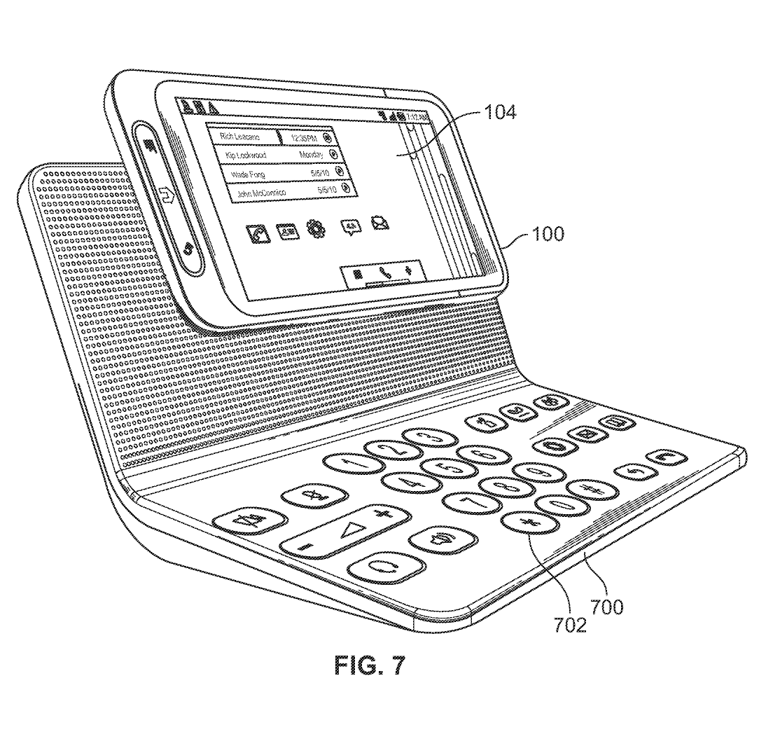

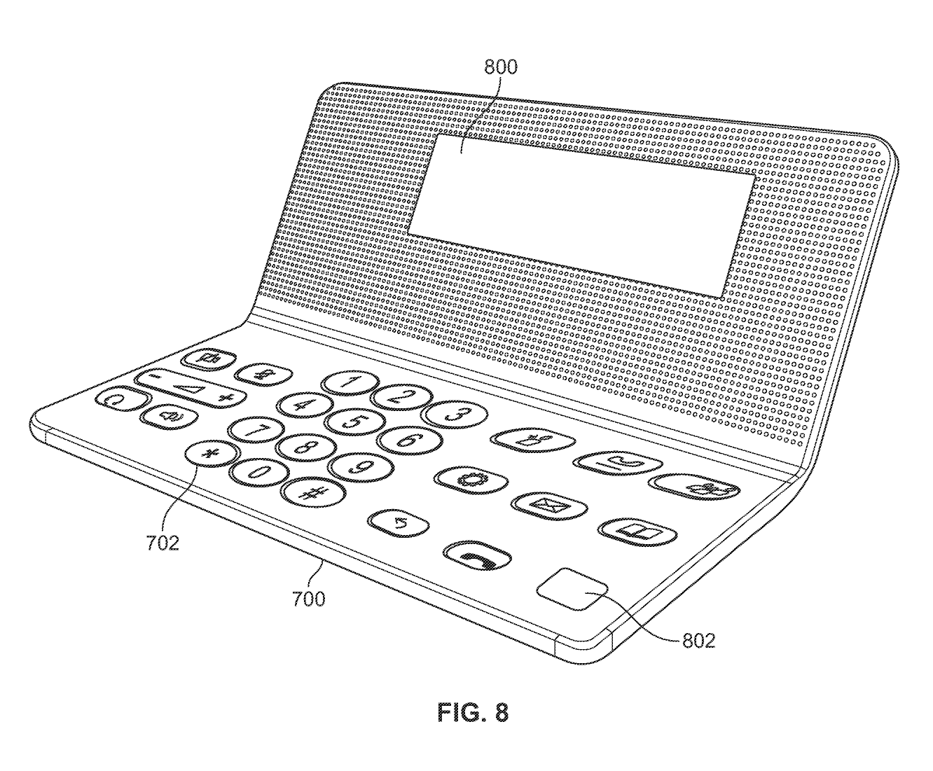

As shown in FIGS. 7 and 8, the system can include one or more docks or docking stations, such as docking station 700. Docking station 700 can include any suitable structure for engaging handset 100. In the example embodiments shown in FIGS. 7 and 8, a horizontal engaging structure 800 is utilized to engage handset 100. Such engagement may be carried out using simple mechanical engagements or magnetic engagements, for example. Docking station 700 can also increase the functionality of handset 100 in many ways. For example, docking station 700 can include structure to enable handset 100 to be charged. In particular, a metal element may be in the form of a logo and can be positioned on horizontal engaging structure 800. The metal element may be part of a charging circuit for docking station 700, and it can be designed to engage exposed charging contacts of handset 100. Docking station 700 can also provide a keypad 702 or keyboard, additional speakers, cameras and biometric readers, like a fingerprint reader 802 integrated into a portion of docking station 700. Such fingerprint reader 802 may be used to enable secure access when handset 100 is docked.

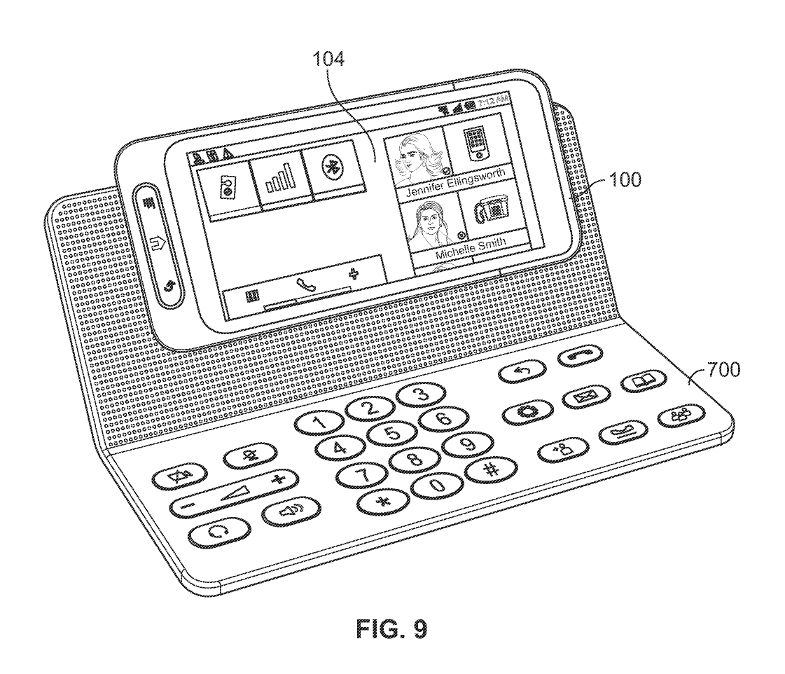

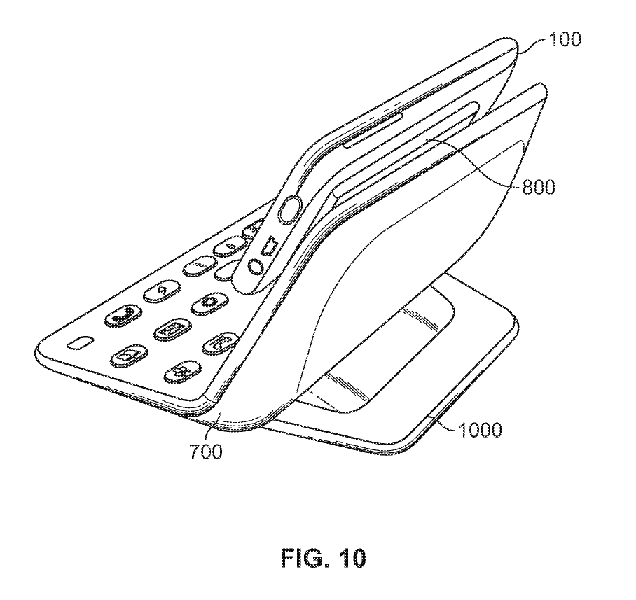

FIG. 9 presents another perspective view of docking station 700 engaging handset 100. As can be seen, docking station 700 can permit handset 100 to carry out all of its normal functions and can enhance or improve on some of these features as desired. As seen in FIG. 10, docking station 700 can be configured to permit handset 100 to be tilted at a certain angle to improve the viewing experience. Such tilting may be achieved by utilizing a hinge to connect horizontal engaging structure 800 to a main body of docking station 700, thereby enabling horizontal engaging structure 800 to be adjusted to any number of suitable angles. As an option, docking station 700 can include a brace that extends from the main body thereof for providing additional support for this tilting feature. As another option, an upper portion of docking station 700 can be pivotally engaged with a lower portion of docking station 700, which can enable at least the upper portion to be moving to any number of suitable angles. As further seen in FIG. 10, docking station 700 may comprise a foot 1000 that provides support for docking station 700 when docking station 700 is placed on a surface such as a desktop or tabletop. In one embodiment, foot 1002 comprises a fixed-position “D” style foot.

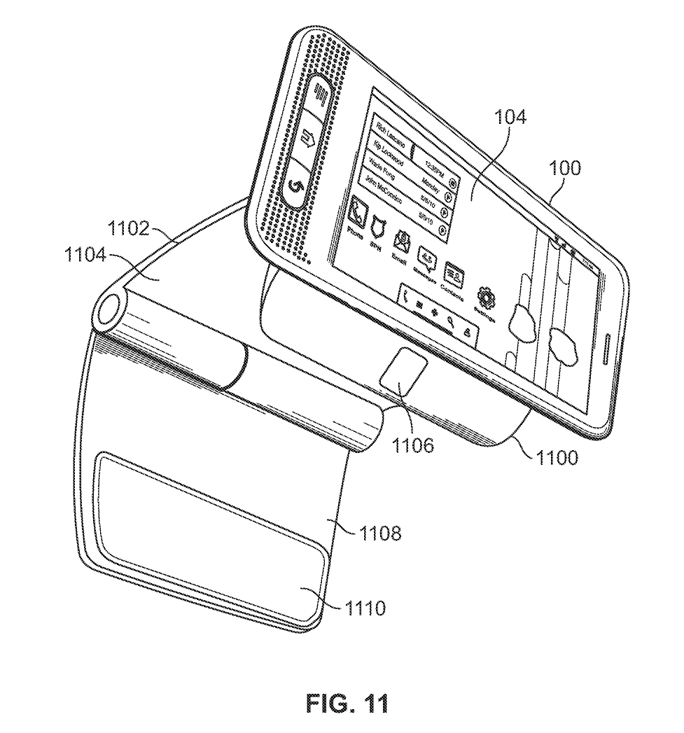

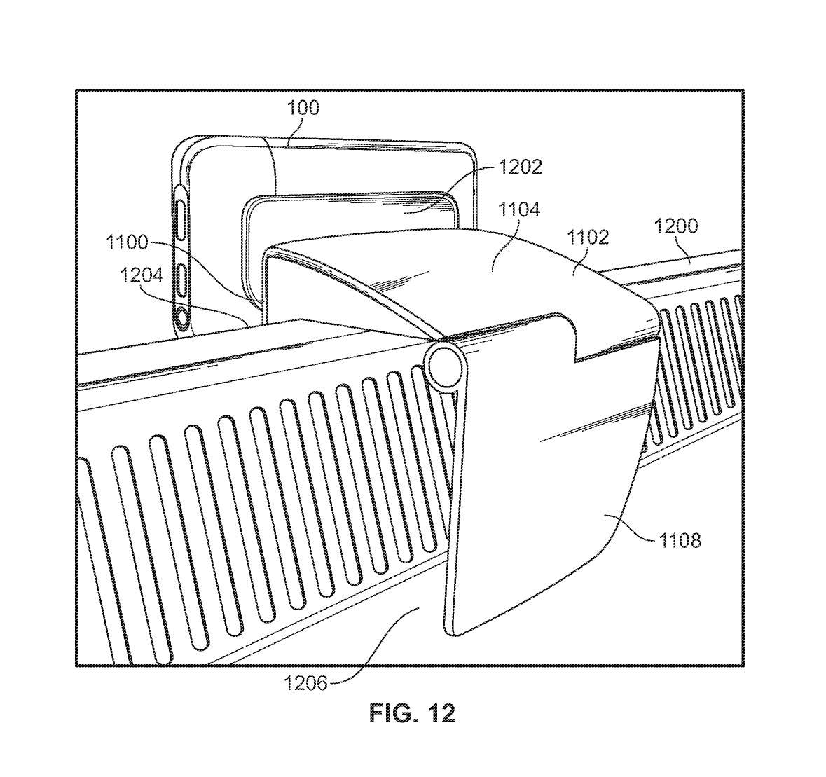

Referring to FIG. 11, a perspective view of another docking station 1100 is shown. Docking station 1100 can engage handset 100 and can charge handset 100 in a fashion similar to that described in relation to FIGS. 7-10. In this case, however, docking station 1100 can engage another component, such as a monitor 1200 as shown in FIG. 12. Docking station 1100 can include a first main portion 1104 and a second main portion 1108 that can be (although not necessarily) pivotally engaged with one another. First main portion 1104 and second main portion 1108 of docking station 1100 can be configured such that they can engage a portion of monitor 1200. To assist in this engagement, one or both of main portions 1104 and 1108 may be biased, such as through a spring. Main portions 104 and 1108 can also include padding, such as plastic or rubber, to prevent docking station 1100 from marking up monitor 1200. As an option, main portion 1104 can include a camera 1106, which can capture images as needed. Camera 1106 can be positioned such that a user's face is within a suitable viewing angle when docking station 1100 is engaged with monitor 1200.

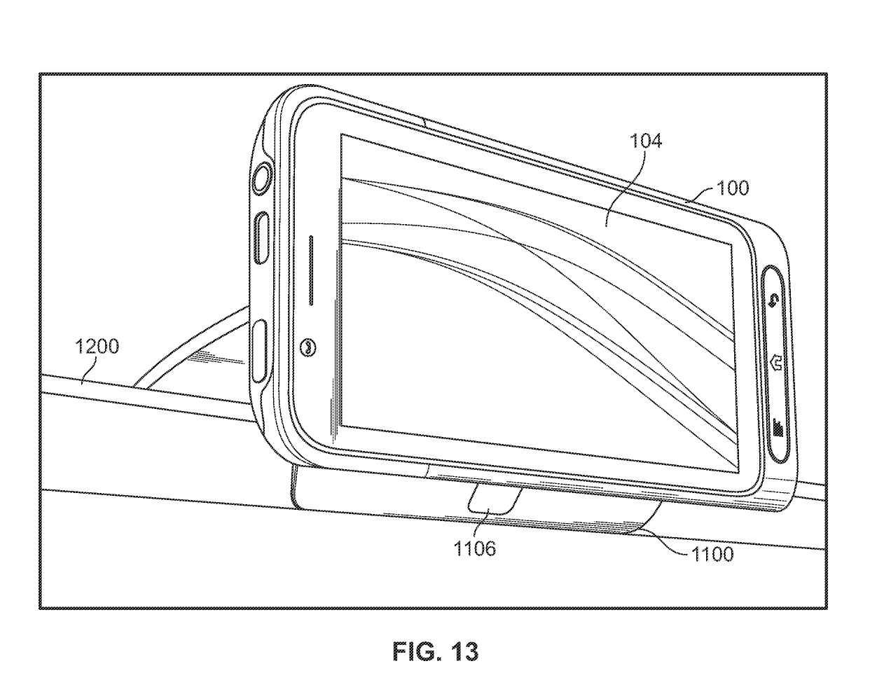

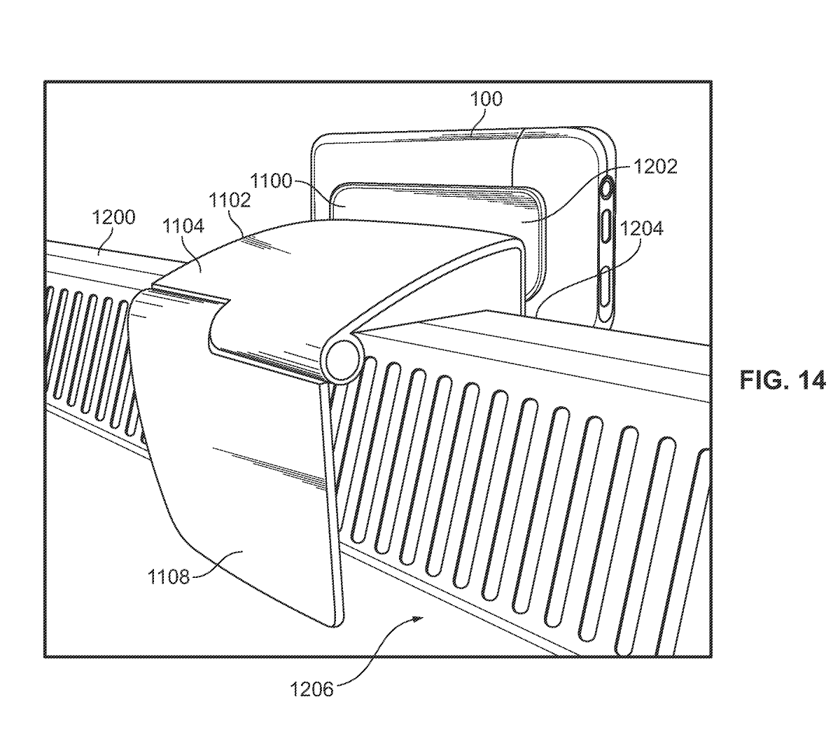

Moving to FIGS. 13 and 14, additional perspective views are provided that show handset 100 engaged with docking station 1100. In these views, handset 100 and docking station 1100 are engaged with monitor 1200, and a user can easily see images being displayed on handset 100 without having to turn his/her head away from monitor 1200 supporting docking station 1100 and handset 100. Camera 1106 of docking station 1100 is also positioned to acquire images of the user at an optimal angle, i.e., a more direct view of the user's face. In one embodiment, camera 1106 may be tilted at a non-zero degree angle with respect to a surface upon which monitor 1200 is resting (e.g., from 10 to 80 degrees). Camera 1106 can also capture images of documents or other physical objects that are positioned near monitor 1200. In fact, camera 1106 can have a high enough resolution to enable capture of text or symbols on documents to enable a participant on a call to view such text/symbols. As another option, the positioning of camera 1106 can be adjustable, as opposed to simply fixed, to ensure optimal viewing angles.

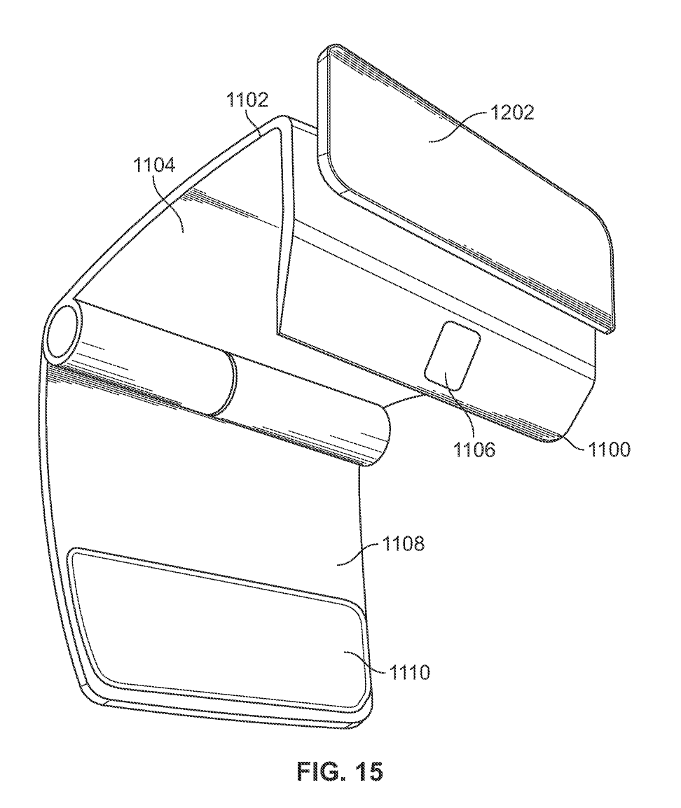

FIG. 15 provides a perspective view of docking station 1100 when docking station 1100 is not attached to any other component and when no handset is engaged therewith.

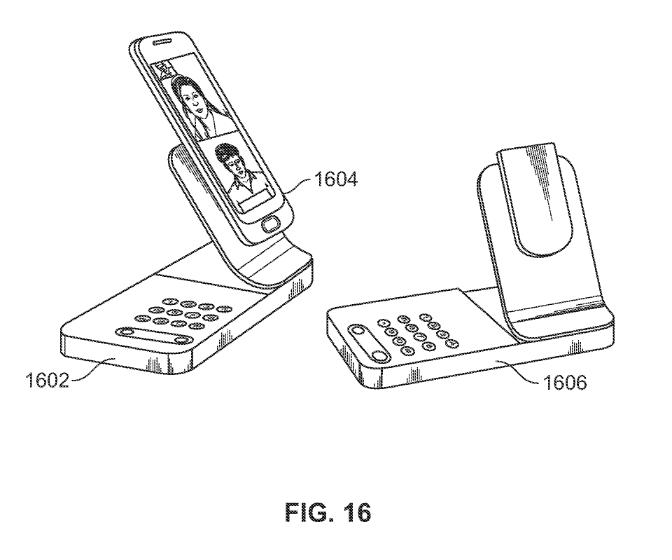

Turning to FIGS. 16-22, several views of various docking stations and docking configurations are presented. For example, FIG. 16 shows a main docking station 1602 that is engaged with a handset 1604 and a main docking station 1606 that is not engaged with a handset. Docking station 1602 and docking station 1606 are similar to docking station 700 as shown in FIGS. 7-10 in that they provide additional features to a handset, such as providing charging and a keyboard/keypad for increasing the utility of the handset.

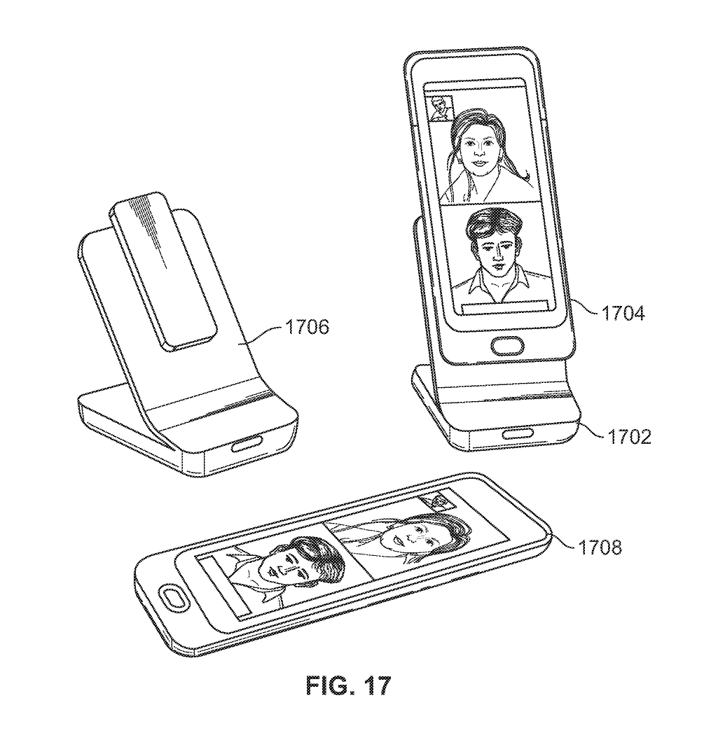

FIG. 17 shows a simple docking station 1702 that is engaged with a handset 1704 and a simple docking station 1706 that is not engaged with a handset. FIG. 17 also shows an additional handset 1708. Each of simple docking station 1702 and simple docking station 1706 can provide support and charging for a handset. Such simple docking stations can be useful in tight spaces.

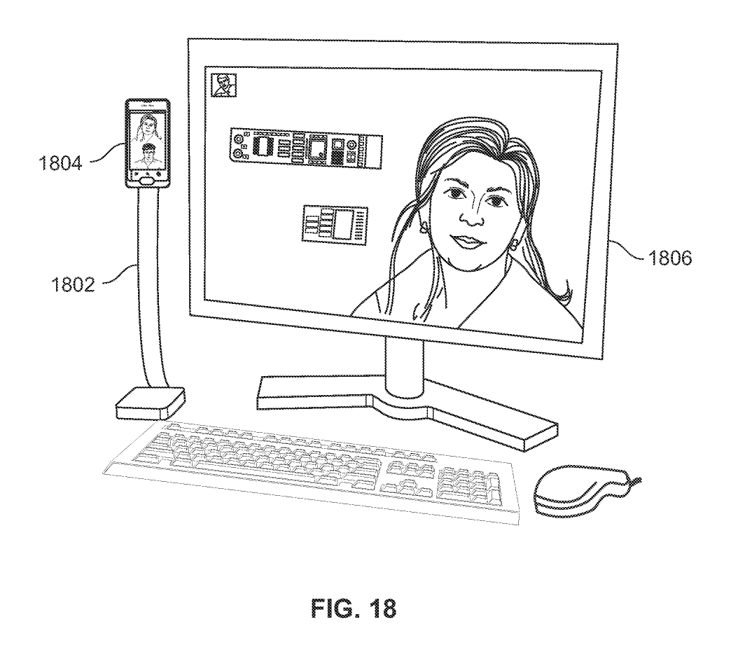

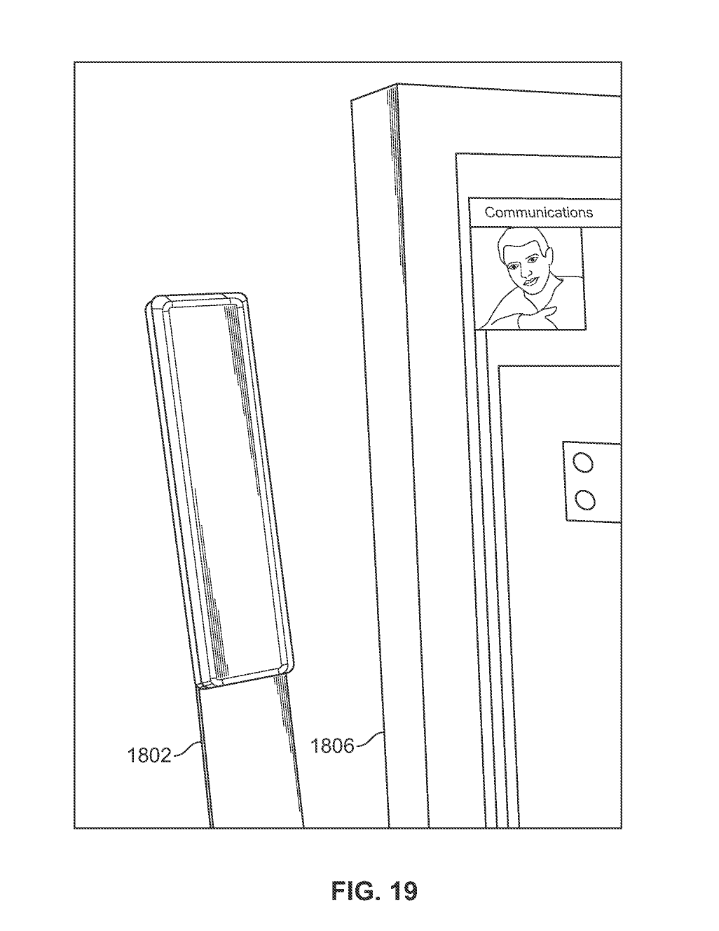

FIG. 18 shows a tower docking station 1802 that is engaged with a handset 1804, wherein tower docking station 1802 is adjacent to a monitor 1806 that may reside on a desktop or tabletop. As shown by FIG. 18, tower docking station 1802 can support handset 1804 at an elevated level. For example, in accordance with certain implementations, tower docking station 1802 may support handset 1804 at a level that is 0-24 inches above surface upon which tower docking station 1802 rests. This additional height can be useful for positioning handset 1804 at eye level, which can be advantageous in a video call. That is, the user can easily see images being displayed on handset 1804, and the user's head can be suitably positioned for a camera that may be incorporated into handset 1804. FIG. 19 shows a top portion of tower docking station 1802 when no handset is engaged therewith.

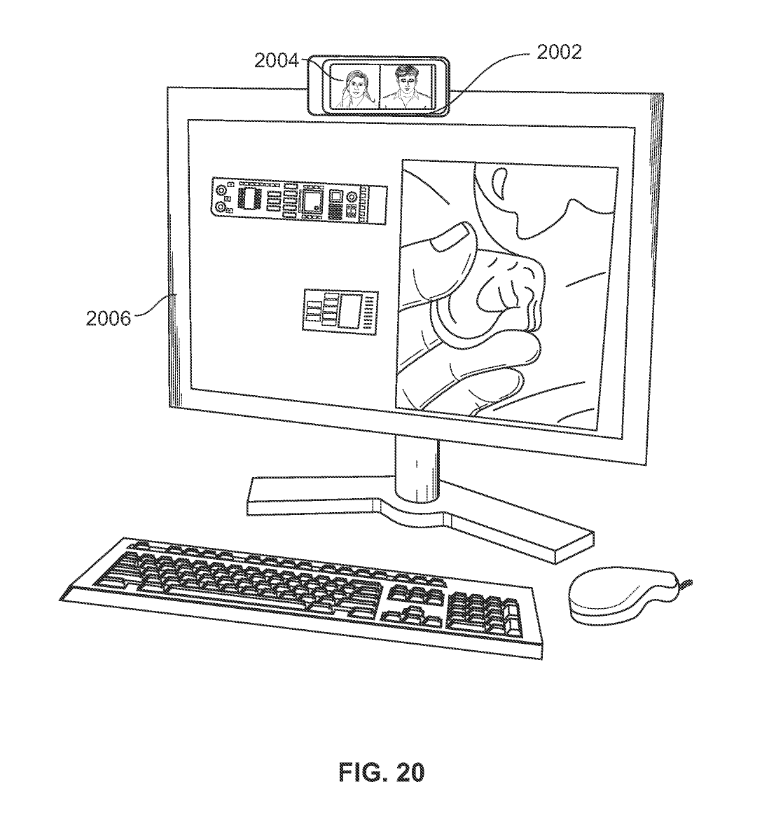

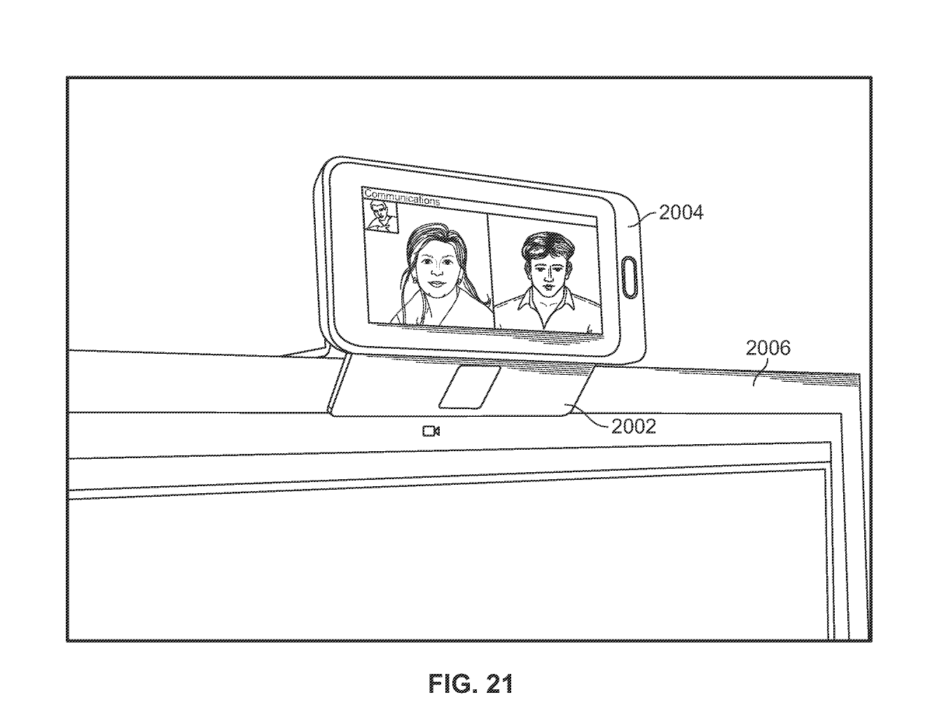

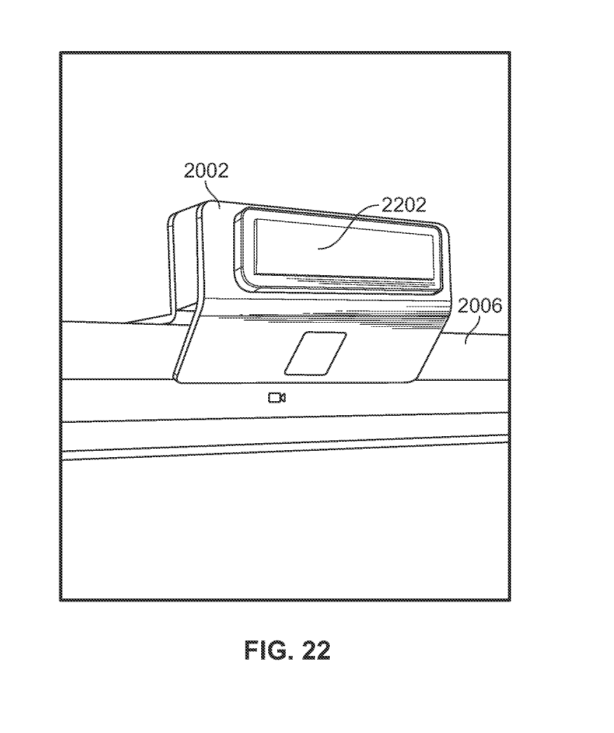

FIGS. 20 and 21 illustrate another example of a docking station 2002 that can support a handset 2004 that is engaged therewith and that is also engaged with a monitor 2006. FIG. 22 shows docking station 2002 engaged with monitor 2006 but not engaged with any handset. As can be seen, docking station 2002 can enable a camera of handset 2004 to be positioned optimally for a video call. While a camera of docking station 2002 can capture a user's face and body language, docking station 2002 can also (simultaneously or at a later time) capture activities, information, etc. that are occurring on a computer or other device that monitor 2006 supports.

Each of the docking stations discussed thus far and those to be presented below can be configured to provide charging through direct connections or through induction. In fact, inductive charging pads can be incorporated into a structure that is used to support the handset. The handset can be equipped with suitable circuitry and software to enable such charging. Additionally, the handset can be configured to include various connectors for transmitting or receiving data, including but not limited to connectors for USB, power (in addition to USB), and video or multimedia connectors such as HDMI or DisplayPort connectors. The handset may also include sensors for detecting or sensing docking stations and engagements to docking stations. For example, certain pins can be employed for this detection, or magnetic sensors can be used that may be triggered by patterns of magnets in the handset.

The docking stations may also include various forms of connectivity to enhance the operation of the handsets. For example, the docking stations can have Ethernet connectivity (such as through USB) to the handset and any other suitable networked components. The docking stations may also be configured to support wireless communications with the handsets and other network components, like access points or cellular networks or through Bluetooth® connections. In another arrangement, the docking stations can have HDMI or DisplayPort outputs/inputs, built-in USB hubs, speakers for broadcasting audio generated by or transmitted to the handset and displays for displaying images from any suitable source. Also, the docking stations can be configured to connect with one another so that the services or features offered by one docking station can be offered by one or more other docking stations. For example, images that are captured by the camera of a docking station that can engage a monitor, such as docking station 2002, can send these images (including any related audio) to any other docking station. The docking station that receives the video (and audio, if relevant) can then display/broadcast this material or can forward it to, for example, the handset that it is supporting or to another component.

As another example, assume that a handset is engaged with a docking station that is coupled to a monitor, such as docking station 2002. A main docking station, such as main docking station 1602, can then interact with the handset by freely exchanging signals with the handset, even though the handset is docked with the docking station coupled to the monitor. This concept can apply to all the docking stations and handsets described herein. The handsets can also be equipped with a secondary power source, such as a second battery or a capacitor, which can supply power when a main battery is swapped to ensure non-stop operation. Although the docking stations may receive their power from conventional power outlets, they may also be powered by batteries, secondary power sources or by receiving power from other components, like a desktop computer, laptop, etc. The handsets may also include RFID transponders to server for access control in buildings or other areas or for indoor or outdoor location identification.

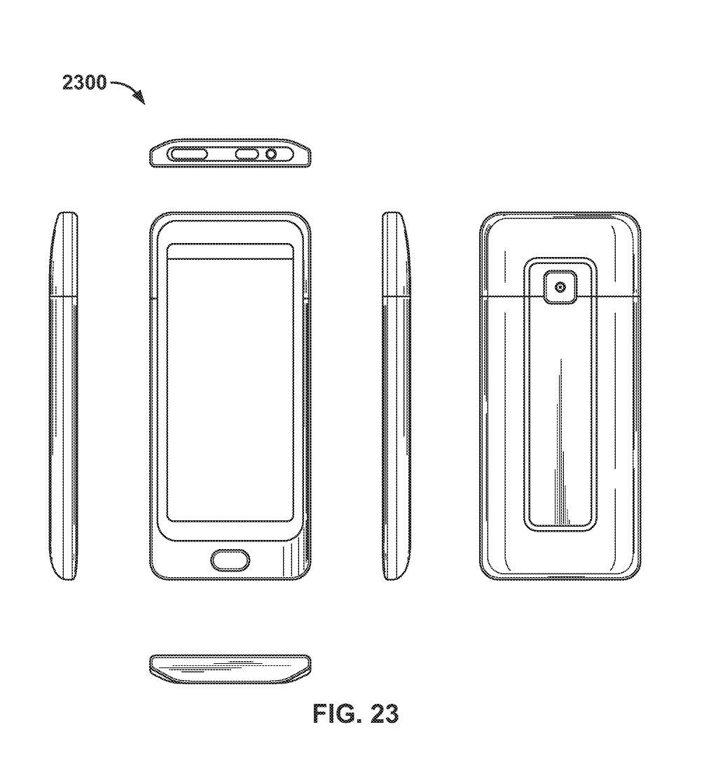

FIG. 23 provides multiple perspective views of a handset 2300 that may be part of the communication system.

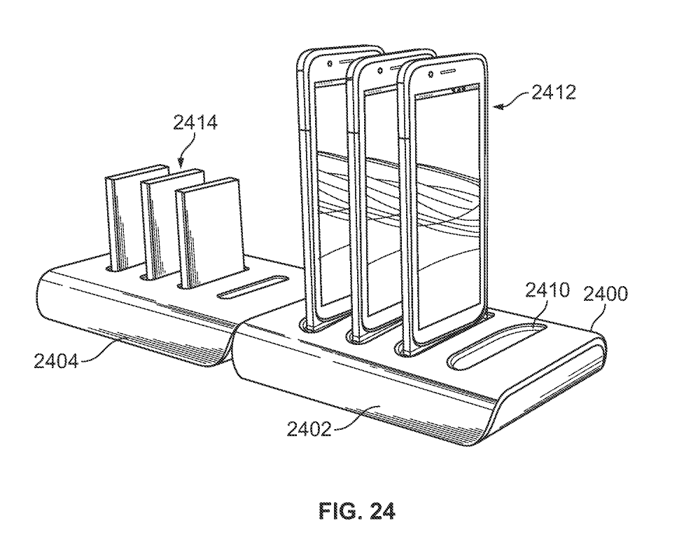

Referring to FIG. 24, an example charger 2400 that can be part of the system is shown. Here, charger 2400 can include a first main portion 2402 and a second main portion 2404 that can be, for example, pivotally attached to one another. This can allow charger 2400 to be stored in a compact space when not being used. One or both of main portions 2402 and 2404 can include one or more charging ports 2410, which can receive any suitable number of handsets 2412, batteries 2414 or other devices that require charging.

The communication system described thus far (or at least certain parts of it) can be used in a variety of ways. For example, the handset can be used as a complete call manager console (includes the management of audio, video, interactive video calls and contacts) and for audio and video conferencing. The handset can be used in accordance with any suitable number of protocols or standards, like Wi-Fi or 3G or 4G and can provide seamless VPN access. The handset can also serve as an electronic notebook, such as by providing a way to generate and store meeting notes, to-do lists and mindmaps, i.e., diagrams or other presentations that are used to show various words, tasks, ideas, etc. linked to and arranged around a central idea. Moreover, the handset can be used for various multimedia purposes, such as providing training videos or other demos and on-site photo and video documentation, which can be useful for the insurance and construction industries. Office documents or other sensitive material may be viewed on the handset. The handset can also provide a control interface for interactive (face-to-face) video calls and an application dashboard for one or more applications. The handset can also be used for RFID access and control. Specific non-limiting examples will now be presented.

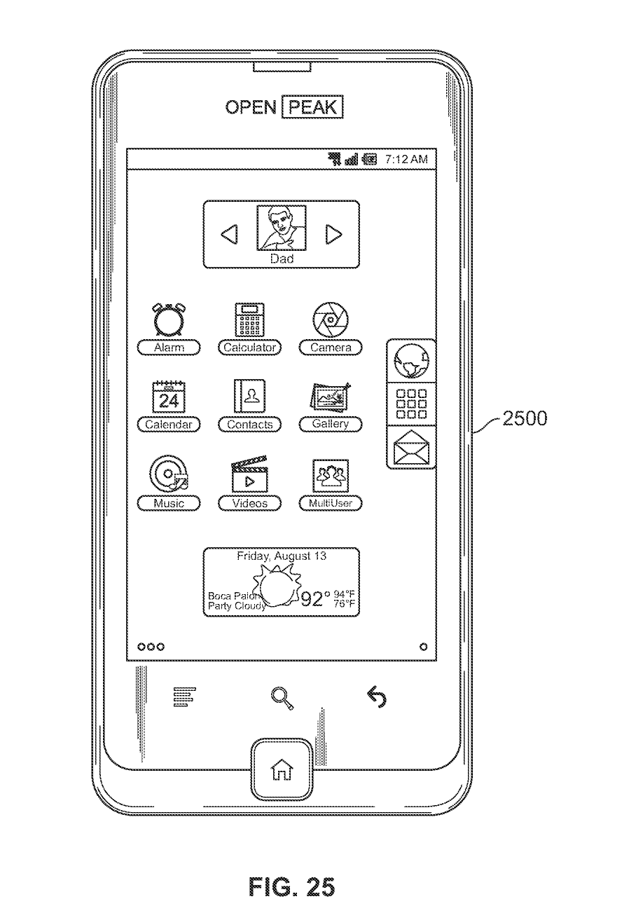

Referring to FIG. 25, an example handset 2500 that can be used with the communication system is shown. Handset 2500 can be, for example, a business-based (i.e., enterprise) handset that can conduct communications over VoIP or cellular and can be used to install various applications. Updates or installs can be pushed to handset 2500 via enterprise channels or those controlled by wireless carriers, as opposed to those controlled by wireless carriers, and handset 2500 can also function as a desk phone, which can allow companies or other entities to eliminate the need for providing desk and cell phones. Handset 2500 can also support multiple users and can provide multiple profiles for all or at least some of the users. These profiles can be in the form of, for example, managed (e.g., enterprise) and unmanaged (e.g., residential) settings or personalities.

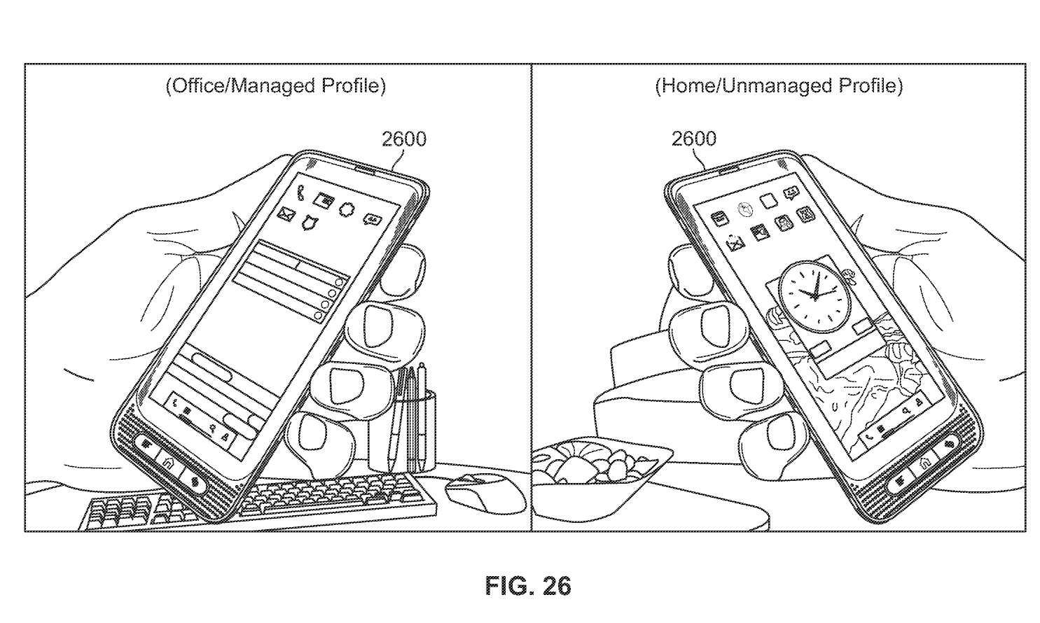

FIG. 26 illustrates an example handset 2600 that can support multiple profiles. In one arrangement, one of the profiles can be a managed profile, which can be associated with a business or enterprise setting. When this profile is active, one or more settings, parameters and applications that are suitable for the business/enterprise setting can be activated and/or loaded. For example, work contacts and applications that are related to work can be loaded, and e-mail can be conducted through a LAN or WLAN. This profile can be made active when the user is located in an enterprise or business travel environment, which can be detected through various means, including automatically or set by the user. For example, the unmanaged profile may be selected if the handset detects a particular access point. Thus, the selection of a profile may be made manually be a user and/or automatically by handset 2600 based on one or more factors, such as device location or a network or access point detected by the device.

Similarly, when the unmanaged profile is active, one or more settings, parameters and applications that are suitable for a home or social environment can be activated and/or loaded. This profile can be made active when the user is at home, on vacation or in some other social setting and can be set automatically or by the user. As an example, social contacts and social-related applications can be loaded or activated, and e-mail or other communications can be conducted through a secure connection, like VPN. As such, one or more applications, routing tables, firewalls, VPNs, etc., can be tagged to one or more profiles. Some of these applications or other features can overlap both profiles and can be loaded or activated when either profile is active. It is understood that the handset can support other suitable profiles. For example, a work remote profile can be established, which can include setting, parameters or applications that are relevant to a worker working from home or some other non-work setting. These profiles may be hidden from a selection menu if not relevant considering the location of the handset. As an example, if the user is in a work location, a “work remote” profile may not be presented to the user as a selection because it is not relevant considering the location of the handset.

It must also be noted that different billing procedures may be activated or set based on which profile is active. For example, a first billing rate may apply to an application when the unmanaged profile is active. If the unmanaged profile is deactivated, and the managed profile is activated, a second billing rate for the application may apply in this circumstance. That is, different billing rates may be applied based on the type of profile that is active. This feature may be applicable to virtually any setting, parameter or application of the handset and is certainly not limited to those settings, parameters or applications that are common to multiple profiles.

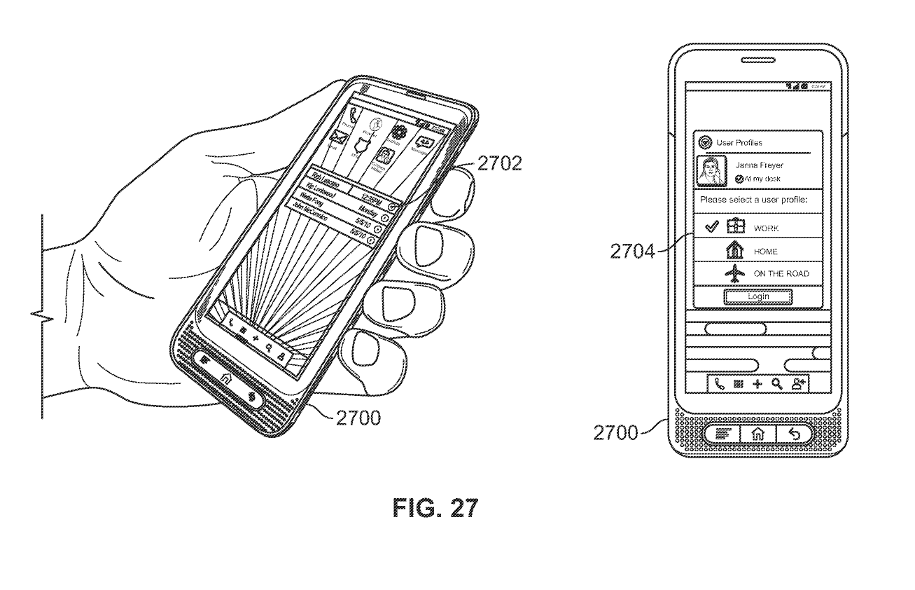

As noted earlier, the handset can support multiple users. This is illustrated by FIG. 27, which shows a handset 2700 that provides an easy-to-user user interface (UI) element 2702 that can be used to select one or more user accounts out of multiple accounts. Such UI element 2702 may comprise, for example, a widget. As further shown in FIG. 27, handset 2700 may include a further UI element 2704 by which each user can select a particular user profile, which can be loaded when the user logs in. A security feature, such as a displayed or physical keypad that requires a passcode entry or a biometric system, can be used to authorize the user before loading that user's account. All or at least some of the users can have multiple profiles (work, home, travel) set up on their accounts.

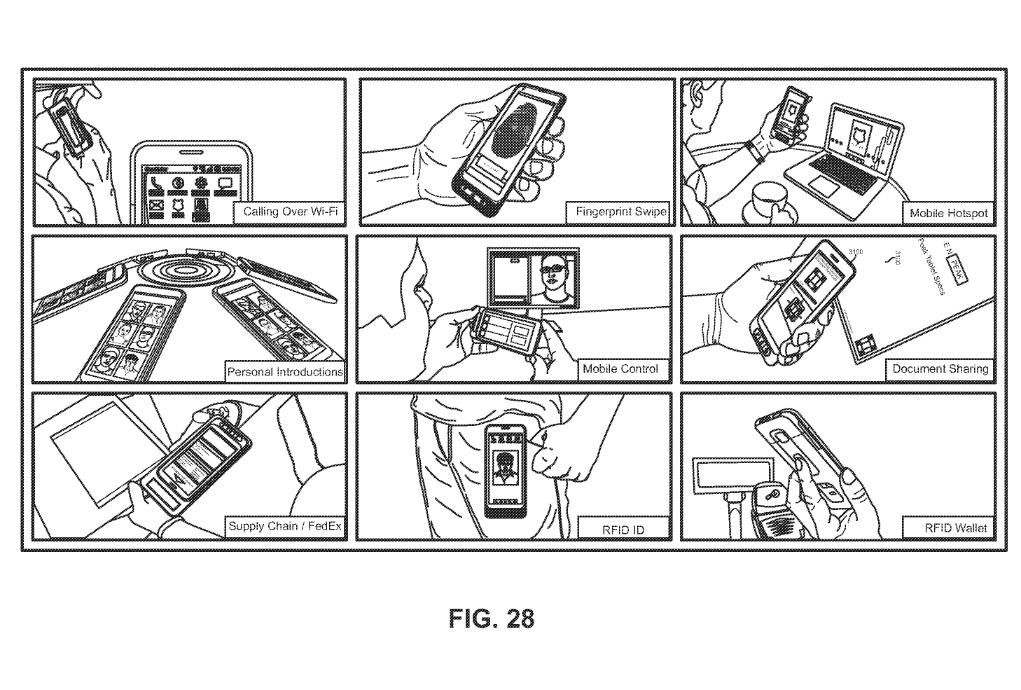

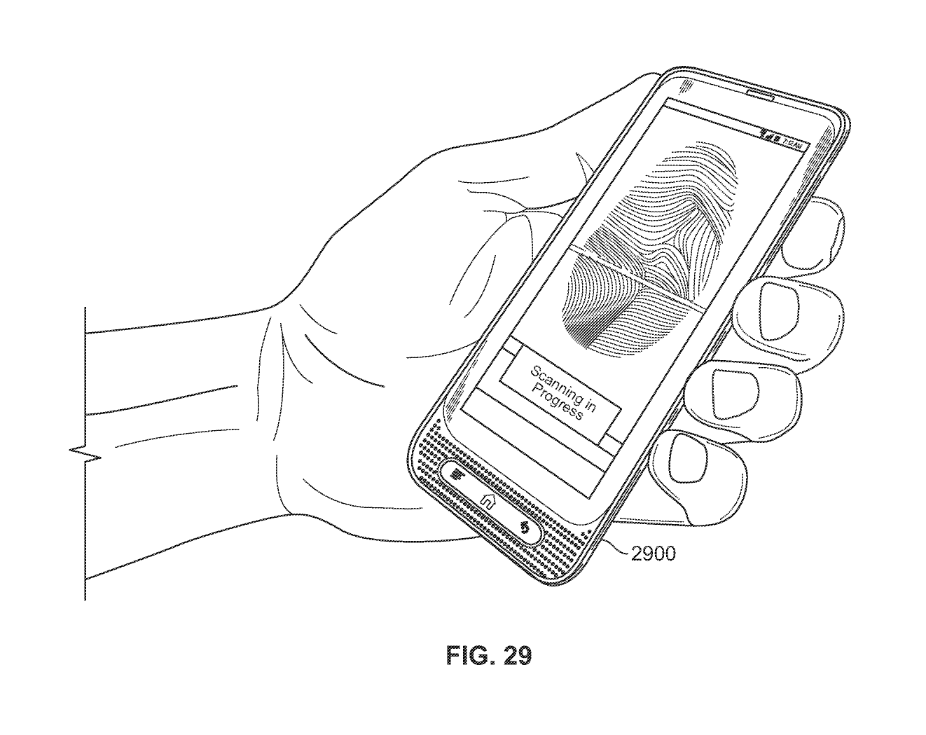

Referring to FIG. 28, several use cases for the handset are illustrated. For example, starting with the image in the upper left and moving to the right, the handset can conduct Wi-Fi communications, and can provide a mechanism for biometrics, like fingerprint swiping. For example, referring to FIG. 29, a handset 2900 can provide a fingerprint swipe mechanism that can be used for rapid and secure authentication and personalization. Once a user's fingerprint scan is confirmed, the user can have access to the handset and other components with which the handset is operating, functioning or sharing information. Moving back to FIG. 28, it can be seen that the handset can serve as or otherwise support a mobile hotspot, as shown in the upper right corner. Jumping back over to the far left middle, the handset can be part of an interactive communications system in which the participants of a call or other communication can be displayed on the handset. Moreover, the displayed participants can view the user of the handset. As such, each user can participate in the call by viewing the other participants and being seen by the other participants. Information about each of the participants can also be appropriately displayed, such as next to or below their image.

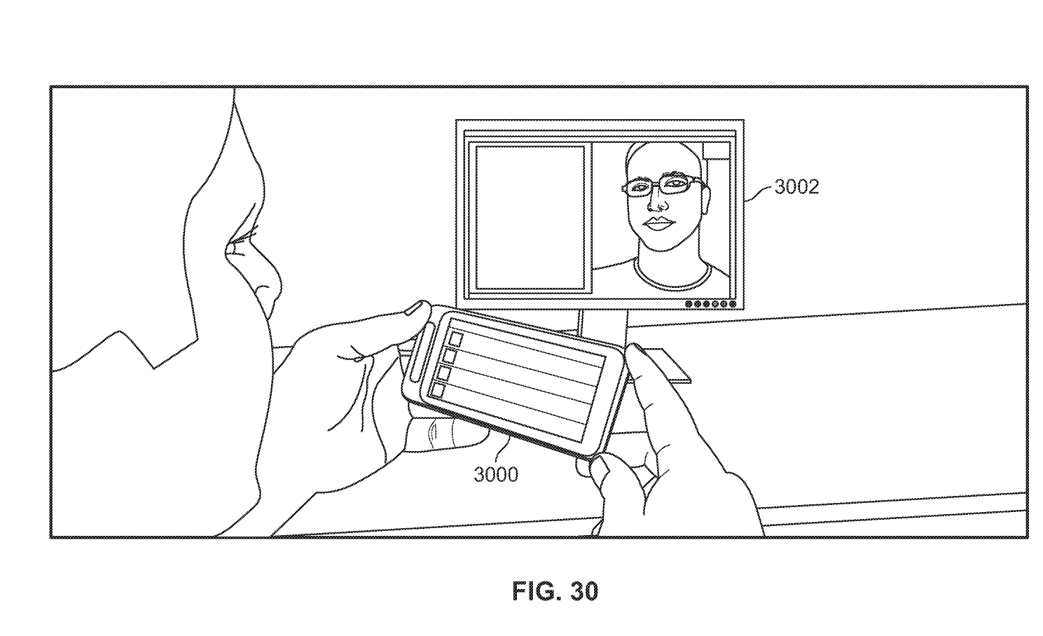

Continuing to the right, the handset can also assist users in controlling linked components. For example, referring to FIG. 30, a handset 3000 may be registered with a desktop computer system that includes a monitor 3002, and handset 3000 can be used to control features of the desktop computer system. As a specific example, a user can use handset 3000 to direct the computer system to retrieve documents, conduct web-based communications or perform many other features that are within the capability of the computer system. Any suitable interface on handset 3000 can be used to manipulate the computer system, including touch screen controls or motion-based input, such as when a user moves the handset to select a particular setting or feature.

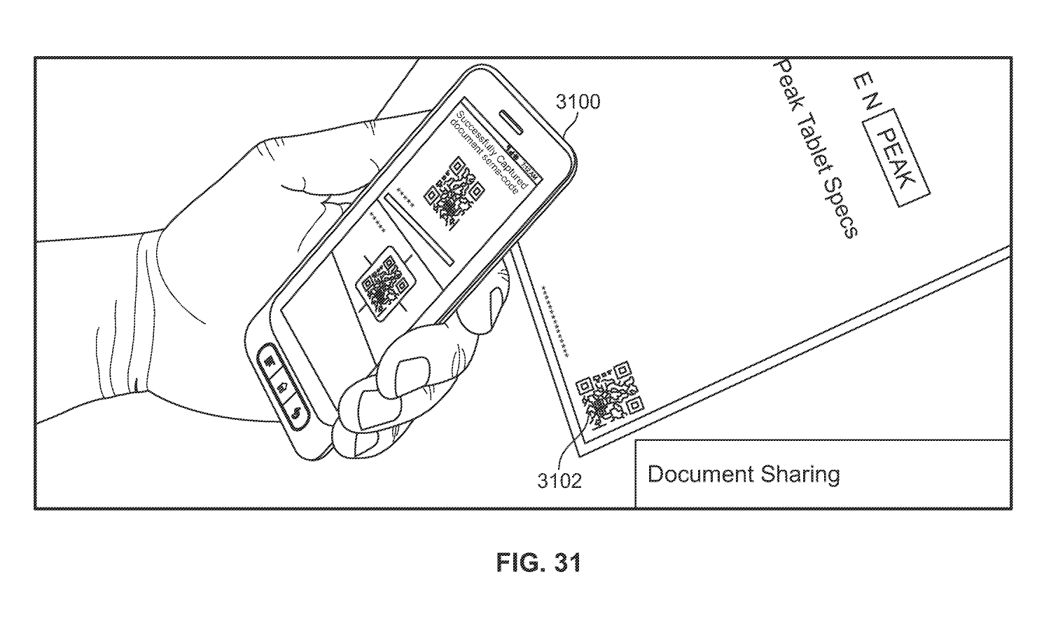

Referring back to FIG. 28, in the middle row to the far right, it is shown that the handset can enable document sharing. A more detailed view is presented in FIG. 31. For example, as shown in FIG. 31, a handset 3100 can capture and recognize images of machine readable code that are on a document 3102 or some other suitable medium. Handset 3100 can then obtain and share additional information that is related to the captured code. As a specific but non-limiting example, the machine readable code can be Semacode dot-matrix symbols. For instance, machine readable code can be placed on posters for events, and a user could obtain additional information about the event by capturing the code with handset 3100. The code may contain an embedded URL, to which the handset's browser could be directed. A similar process can be used for name tags. As another example, handset 3100 could read code and launch a related application or set one or more parameters in response. That is, the code could signify that a particular language setting should be activated and a translation application if the user travels to another country. Handset 3100 can also capture images of various objects, like buildings, places, faces, animals, plants, objects, documents, etc, and handset 3100 can recognize such objects and access information about them. Any information that is gleaned from the images recognition for any object can be shared with other users.

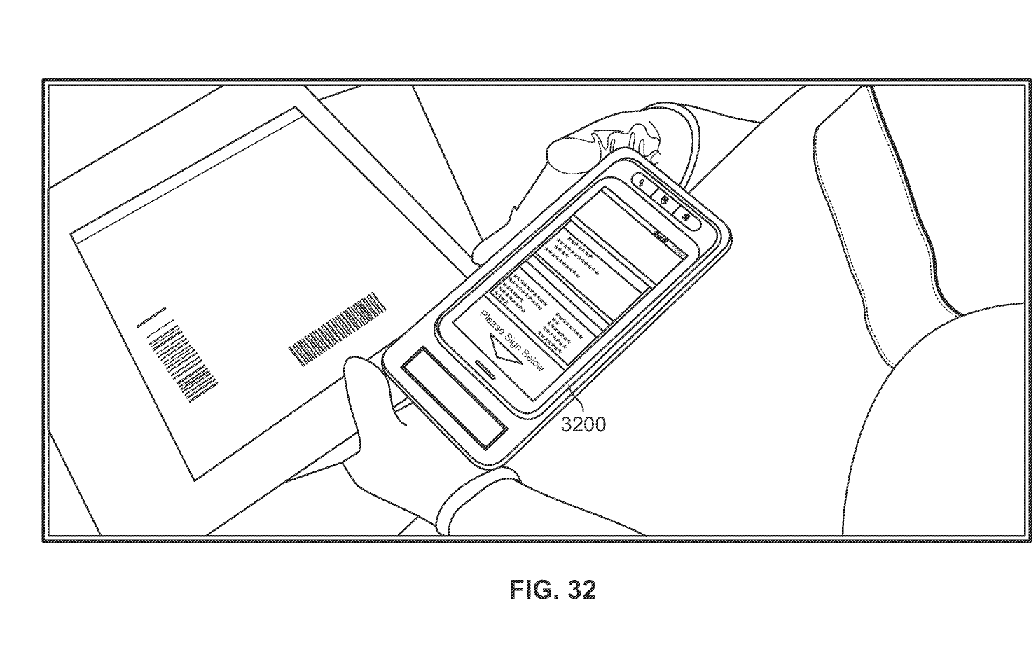

Returning once again to FIG. 28, bottom row to the far left, it can be seen that the handset can assist in the transport of goods or documents. For example, in FIG. 32, it can be seen that a handset 3200 can be used to track packages through any suitable transport system. Moreover, because handset 3200 can be equipped with GPS, handset 3200 can easily provide information about a package's whereabouts. Handset 3200 can also determine when it is nearing a delivery location, and handset 3200 can automatically contact (call, e-mail, message, etc.) the location with relevant information, like estimated delivery time, size of package, requirement of signature, etc. The delivery location or some other entity can also authorize handset 3200 entry to the location or some other sensitive area. As such, handset 3200 can be used to gain entry to restricted areas to enable the delivery person to deliver the package.

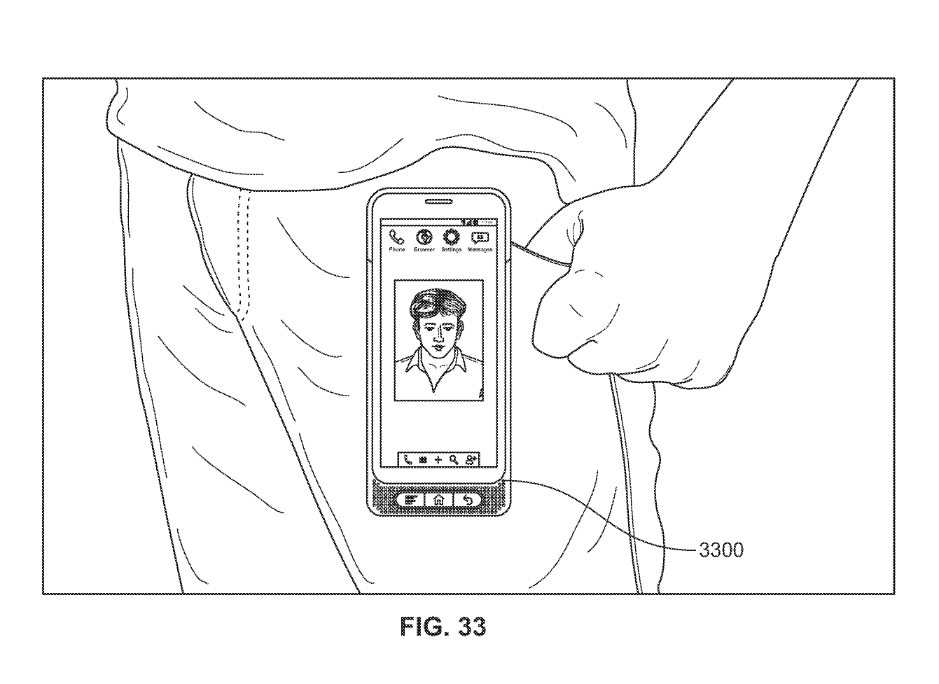

Turning back to the last two images on the bottom row in FIG. 28, it can be seen that the handset can implement RFID procedures, techniques or protocols and can serve as an electronic wallet. For example, referring to FIG. 33, a handset 3300 can be programmed with credentials relating to a particular user. In addition, handset 3300 can be equipped with RFID technology, which can allow handset 3300 to act as an employee access card. This can reduce the amount of material that a worker may need to carry or possess to gain entry to sensitive areas. In another arrangement, the user's picture ID and other information relevant to allowing access, like business unit, supervisor name, etc. can be displayed on handset 3300, similar to an employee security badge. Handset 3300 can also include any suitable securing structure to enable the user to secure handset 3300 to an article of clothing to enable the proper display of the picture ID and relevant information.

In view of the RFID technology, the handset may also serve as an electronic wallet. For example, the handset can be programmed with a user's credit or debit card information, and the user can swipe the handset near a properly-equipped point of sale terminal to pay for the goods or services. To increase security, the user may be required to enter a passcode or to provide a biometric measurement (e.g., fingerprint scan).

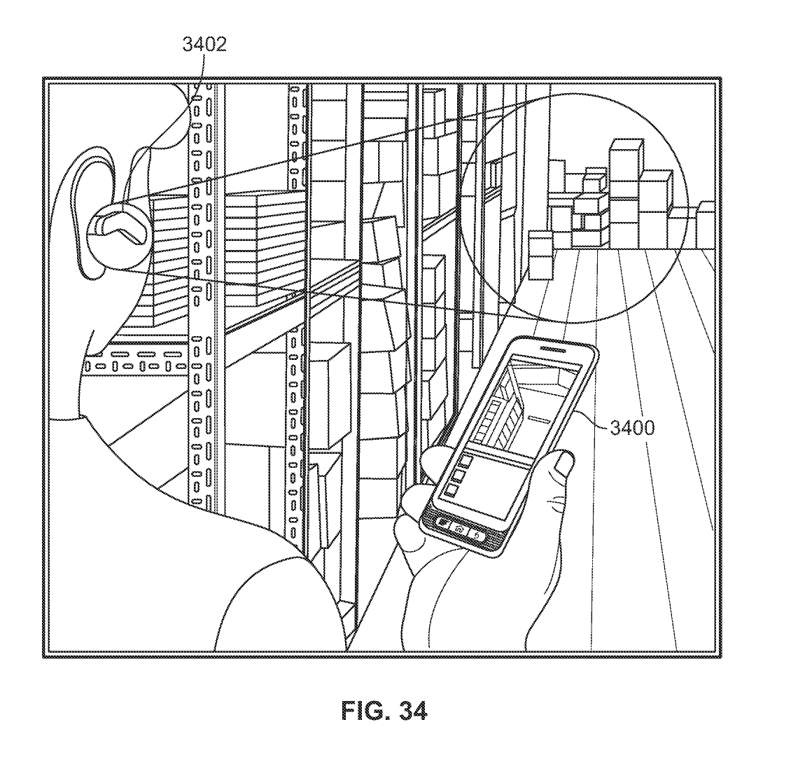

Referring to FIG. 34, a handset 3400 can include a Bluetooth® transceiver, which can allow it to communicate with other components having similar configurations. In one example, an employee can wear a Bluetooth® headset 3402 that includes a camera. The images captured by this camera can be transmitted to handset 3400 and/or to some other component, whether through Bluetooth® or some other standard. In addition, handset 3400 can display these images and can also forward them to some other component. This process can help an employee locate a particular object or location and can be used to allow a remotely located individual to provide instructions or guidance to the employee for any suitable task assigned to the employee.

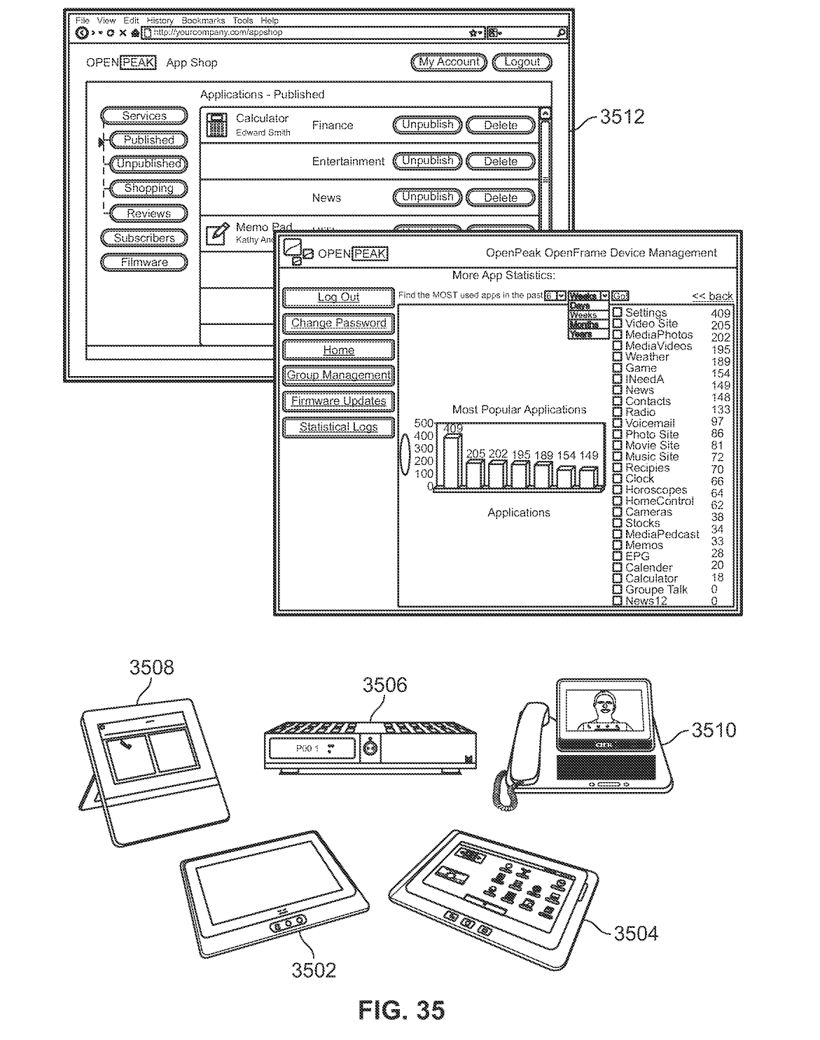

The communication system is certainly not limited to the above description. The system can include or offer services to multiple products. Examples of these products include but are not limited to tablets, set-top boxes and land-line docking stations. For example, as shown in FIG. 35, such products may include tablets 3502 and 3504, set-top box 3506 and docking stations 3508 and 3510. The system can offer cloud services through an open and/or managed platform. The services can be fully managed by an enterprise or service provider and may utilize Web Services implemented using operating system agnostic APIs. By offering such cloud services, the system can make it easy to deploy services that contact and interact with clients and can turn products into fully managed platforms, which can allow for large-scale remote management. For example, a utility company or energy service may send a demand response event to a plurality of customers, or a healthcare provider or service may send a reminder to a connected individual to test some health care related measurement, like blood glucose levels. Other examples include a service provider sending new applications, updates or configuration changes to customers or a customer service representative probing a component's configuration. These services may be managed by an enterprise or service provider or some other suitable entity, and APIs can be provided for virtually any operating system or platform.

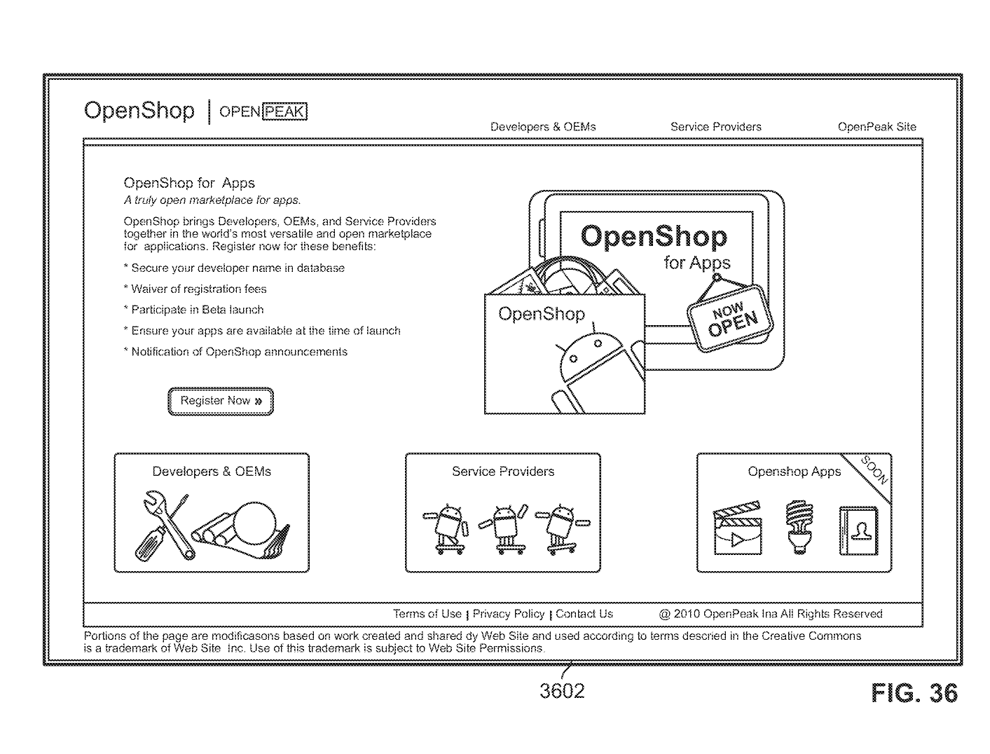

A web-based storefront that offers applications and other software, commonly referred to as an application shop (“app shop”), can also be provided as part of the services of the communication system. The app shop is scalable and fault tolerant through, for example, redundancy and load balancing at each point of presence (POP), as well as failover across POPs. FIG. 35 shows an example UI 3512 for an app shop in accordance with an embodiment. FIG. 36 shows another example UI 3602 for an app shop in accordance with an embodiment.

The app shop can be managed by any suitable entity and can offer applications and other software for any type of operating system. As an example, the applications offered can be based on the Android™ operating system, although the app shop is not limited as such. In fact, the app shop can be designed to accept applications for multiple operating systems. The applications can be conforming to a particular operating system, or they may be non-conforming to one or more systems. For example, the applications offered may meet all the requirements set up by the developer of the relevant operating system, and the applications may be considered conforming Some of the offered applications, however, may not meet all the requirements set up by the developer of a certain operating system. For example, the developer of the operating system may include a requirement that an application receive location information from a handset's GPS. The developer of the application, however, may believe that such a requirement is not necessary, and the application may operate in a normal or suitable fashion without the GPS information. This application would not normally be available for install from any app store controlled by the operating system developer. Here, being an open app shop, such applications may be offered. As such, developers of applications who choose to not support all features required by the operating system provider can have a forum for offering their applications.

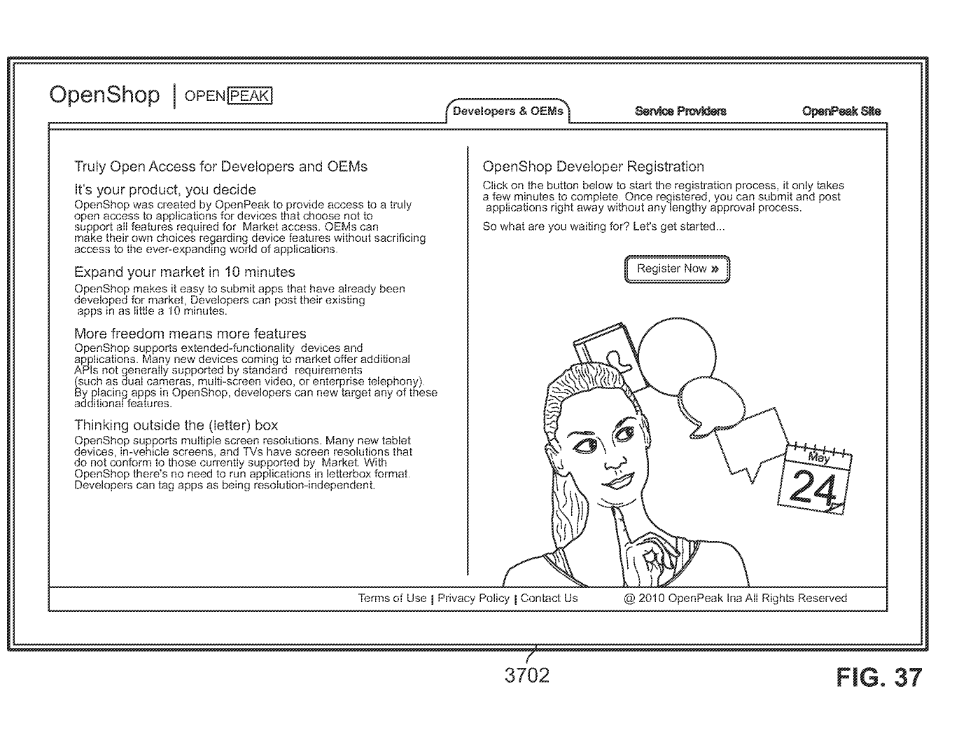

Because it provides an open forum for applications, the app shop allows developers to submit applications that offer functionality beyond that permitted or called for by an operating system. For example, many new computing devices may offer additional APIs not generally supported by a standard operating system, such as multiple cameras, multi-screen video or enterprise telephony. Applications that support these additional features can now be offered to the owners of these devices, even though the applications may be considered as non-confirming with the installed operating system. As another example, the app shop supports applications that call for multiple screen resolutions. In particular, many devices with displays have screen resolutions that do not conform to those currently supported by many operating systems and affiliated elements. Because of the ability to support multiple resolutions, there is no need to run applications in letterbox format. In fact, developers can tag or identify applications as being resolution-independent. At least some of the foregoing features are described in an example app shop UI 3702 shown in FIG. 37.

Moreover, the app shop can implement various hierarchical control and child filters. This feature can be designed for the family or enterprise, and groups can have their access restricted, if necessary. For example, a parent may institute filters on the app shop to limit the type and/or number of applications that a child can access. The applications can be assigned to categories and can be given ratings to assist in the filtering process. As another example, filters can be implemented for enterprise settings to ensure that employees do not install applications that are inappropriate and to provide departmental controls. If desired, budget limits can be put into place to prevent someone from spending excessive amounts of money on applications or exceeding an allowance.

There are other examples of restrictions or limits that can be implemented, which can be applied to an individual user or a group of users. For example, a device can be locked after a certain number of hours of usage of one or more applications or of usage of the app shop. As another example, the device can be restricted from usage of applications or the app shop during certain times of the day or based on particular locations or settings. These usage restrictions can also be selectively applied such that access to critical applications can be excluded from them.

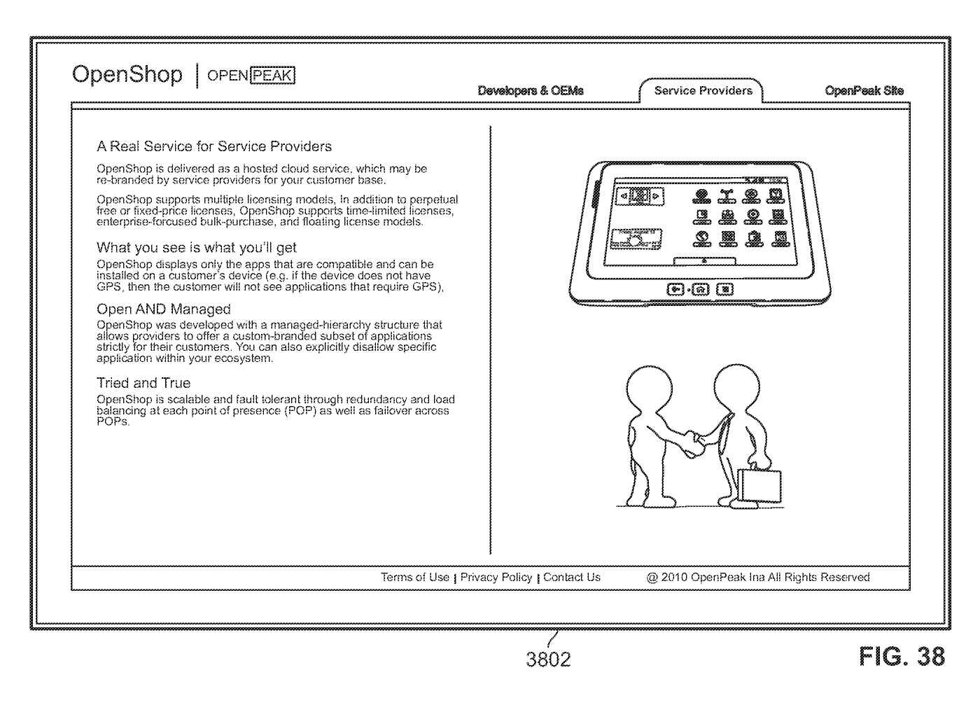

In one arrangement, as described in UI 3802 of FIG. 38, the app shop can be delivered as a hosted cloud service, which may be re-branded by service providers for a customer base. In addition, the app shop can support multiple subscription or fee models. For example, the app shop can support multiple licensing models, such as perpetually-free or fixed price licenses (one-time payment or multiple payments over time). The app shop can also support time-limited licenses, bulk purchase licenses (such as for a business or school) and floating license models. Features can be provided to allow for credit card transactions, billing from the service provider or direct billing.

In another arrangement, the app shop can be configured to selectively offer applications based on whether the apps are compatible with a particular computing device. For example, if the device does not have GPS, then the app shop can be designed to not offer those applications that require the use of GPS.

Consider the following scenario. Devices operating on the Android™ platform are required to pass conformance testing. For example, these devices must have a display that conforms to one of several resolutions, a GPS unit, an accelerometer, a vibrating motor, an external status light, etc. A device must meet all these requirements before it is allowed to have access to the Android™ Market, Google Inc.'s (Google) application store for Android™ applications. This mechanism was put in place to ensure that a developer can program for one platform and the application will run on devices with that platform. The operating system offered by Apple, Inc. (Apple) is available for install on many fewer devices, and Apple is in full control of them. With Apple's application store, a developer can develop an iPhone® application (which can run on an iPad®, too) or target it specifically for an iPad®.

Devices that do not meet all the necessary requirements for conformance cannot access the relevant application store and are relegated to using third-party application downloading services/platforms, like GetJar® (published by GetJar, Inc.). Users have to hope that they can find applications that will work on their specific device.

The app shop, however, offers a solution to this problem. In particular, when a developer uploads an application, the developer may provide information that identifies attributes of the application. For example, the information can include the type and version of the operating system that the application is designed for and any specification resolutions, including maximum and minimum resolutions. Further examples include listing whether the application requires a GPS, a still camera, a moving images camera, an accelerometer, etc. In effect, a developer can “tag” the application with a list of attributes or characteristics when uploading the application to the app store.

Manufacturers may also list required attributes or characteristics for applications to be installed on a device that they offer, and these attributes or characteristics can be supplied to the app shop. The app shop or some other service can then map these devices to applications that meet these requirements. As such, when a user accesses the app shop, the user can select their device from, for example, a menu, and the app shop can present to the user those applications that are compatible with the user's device. This process opens up the number and type of applications that can be provided by an app shop.

There are several other issues that exist today in the management and control of applications that are addressed here. For example, many users have multiple computing devices that are capable of installing applications. If a user downloads an application onto one device, the application is not automatically downloaded onto another device. In Apple's iTunes® ecosystem, for example, the user can download the same applications explicitly onto other devices or synchronize the devices with a local computer, where they can administer which applications should not be installed on specific devices. In addition, users have to download individual applications. There is no concept of downloading, for example, a productivity pack that may include a word processor, spreadsheet and presentation software. Also, all downloaded applications are currently downloaded under a common perpetual license. Further, any changes to the installed set of applications on one device do not affect changes on another device. While this is desirable in many cases, there are also cases where one may want several devices to remain synchronized (for example, a set of wall-mounted control panels throughout the house).

The app shop presents several mechanisms to address these issues. Specifically, the app shop can be configured to support application groups. That is, an app store administrator (or developer) can group several applications into a package. To a device user, these packages may appear as a single downloadable application that may result in each of the individual applications being installed on the device. An independent price and license can be assigned to this application package. This process enables an administrator (or developer) to offer discount pricing for groups of applications, the convenience of loading related applications, ensuring that all required applications are present if there are interdependencies or trial licenses for a group of applications.

This mechanism can be implemented in several ways. For example, the administrator can create a single package containing the various applications and can present it as a new application. To the system, this may appear as one application. Upon download, the system can extract the contents and can install all the applications contained therein. The single package can be created programmatically via an interface where the administrator can specify the component applications. The app store can be aware of the concept of a multi-application package and can assemble the package on demand when the user selects the download. The application can be aware of the concept of a multi-application package, and the client device may, upon purchase/selection, download each of the components individually.

In one arrangement, specific licenses can be assigned to applications or application packages. For example, the administrator (or submitting developer) may assign a license to an application that will be hosted on the app store. Conventional app stores only deploy applications with fixed-price, perpetual licenses. In contrast, the app store described herein can maintain an association between an application and a specific license assigned to that application. Examples include perpetual licenses, time-limited licenses (not valid after a specific time), delayed licenses (not valid before a specific time), time-period licenses (not valid before a specific time and not valid after another specific time) and floating licenses (the device must fetch a valid license from a license server prior to launch). Licenses may also specify whether the license applies to any devices that a user owns or is valid only for one specific device.

In another arrangement, update notifications can be enabled. For example, a server associated with the app store may keep track of which devices downloaded which applications and can use this information to send messages to that device informing the device of an update to an application. The update message may be tagged to result in different actions. One example of such an update is a mandatory silent update, where the device is told to download a specific updated application without informing the user. Another example is a mandatory update, where the user can be informed that there is an application update and the current version of the application is locked (i.e., the license is revoked). Yet another example is a discretionary update, where the user is informed of an application update and given the option of downloading the new application or ignoring the update. Of course, these examples are not meant to be limiting, as various other update notifications can be provided to the device.

In one embodiment, updates can be generated by the server automatically when a new version of an application is made available on the application store. That action can trigger the update notification mechanism, which can find all devices that have the application installed and send the appropriate notification. When an application is deleted on the device, a deletion notification can be propagated to the server. The server can still maintain the information that the application has been purchased (assuming that there was a fee) or installed but that there is one less device that has it installed. The device list can be null in the case where the application is uninstalled from all devices.

In another embodiment, a user can designate two or more devices to be synchronized devices. In this case, if an application is installed on one device, it may be automatically installed on one or more other devices, such as all the devices that make up a group. Likewise, if the application is deleted from any one device, then the application may be deleted from one or more other devices, such all the devices in a group.

When an application is downloaded from the server, the action may trigger a query for synchronized devices in the user-device-applications database. A “silent mandatory application install” message may be sent to one or more of the devices in the group. Likewise, a deletion of an application can result in a message being sent to the server that can trigger a query for synchronized devices and a sending of a “silent mandatory application delete” message to all devices in the group. In another arrangement, the application install/delete messages may be made non-silent and discretionary, allowing the user to accept or reject the action on each of the devices. As another option, the act of installing or deleting an application on one device can contain an “apply to all (or just some) devices in the group” option that may need to be selected for the group actions to take place.

Several mechanisms can be used to allow users to create groups of synchronized devices. For example, an arbitrary group name can be assigned to a device via a configuration setup interface. The first device on which this is performed may result in the group being created on the server with that one device associated with it. When this operation is performed on additional devices, these devices can become associated with the group of the same name. The UI may simplify the process and query the user-devices-applications server for the names of one or more created groups and allow the user to select an existing group or define a new one. As another example, the action can be performed via a web portal where the device owner logs in, sees the devices he/she owns and has the ability to define one or more groups and select which devices belong in each group.

In another arrangement, applications may be grouped and presented based on a location. For example, a person or a business may have multiple computing devices, each of which is capable of receiving applications from the app store. A profile or group of applications, from the app store or some other entity, can be grouped and presented to the user based on where a particular device is to be placed. For example, if the device is to be placed in a kitchen, then applications that are related to that setting can be presented to the user. As a specific example, applications that provide recipes or food preparation tips can be presented to the user. In another example, if the device were to be placed in a family room, applications that relate to home entertainment, like remote control applications or electronic programming guide (EPG) applications, can be presented. As another example, if the devices are to be placed in certain hotel rooms, like a deluxe suite with extra amenities, the applications presented can be related to the features that are related to that particular type of room.

In addition to location, applications can be grouped based on a specific user or that person's demographic. For example, if the device is one that supports multiple accounts, then a particular person's profile can be selectively activated, such as when that person logs in. This profile can include applications that are specifically related to the person assigned to the profile. This profile can be constructed by the person or by another person. In another arrangement, the person can provide demographic and other pertinent personal information, such as age, sex, likes and dislikes, and a profile that includes applications tailored to this person can be automatically generated.

It must be noted that these concepts are certainly not limited to the particular examples described above, as there are other ways to group applications together based on a location or a particular person. Moreover, the applications can be grouped in the app shop and presented prior to download, or the applications can be grouped and presented from a larger set following download and install on the device.

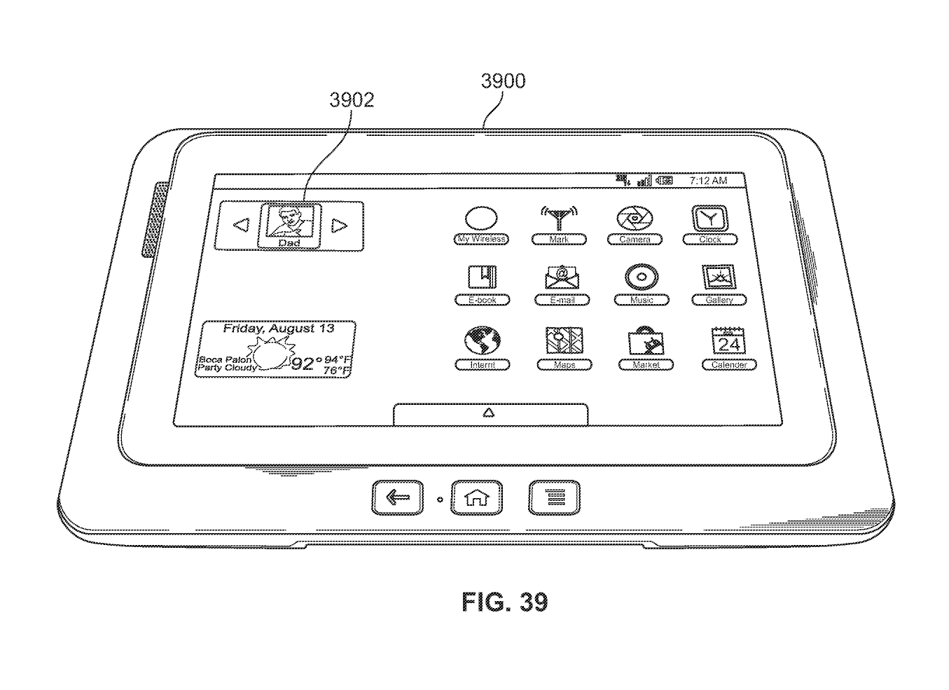

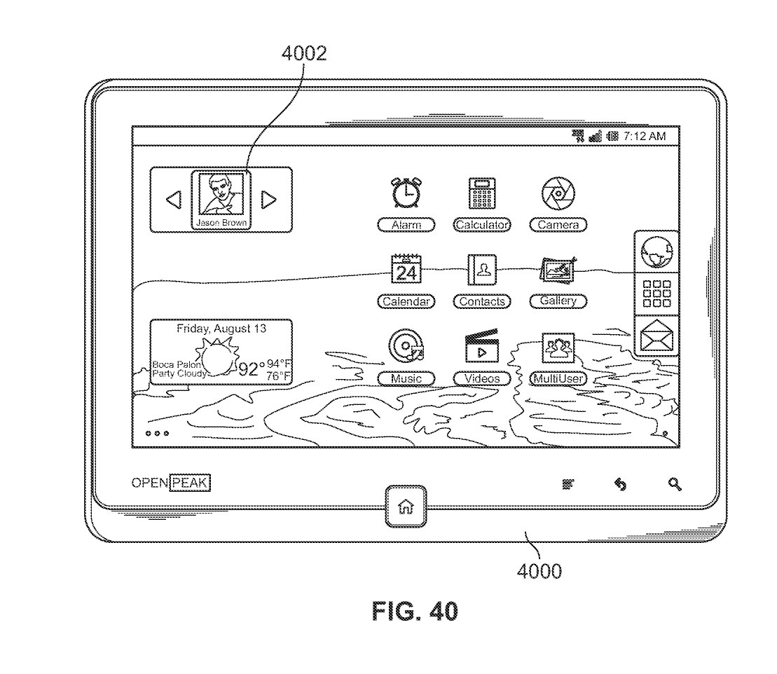

The communication system described thus far can also support electronic tablet devices. Examples of several tablets for use with the communication system are shown in FIGS. 39 and 40. In particular, FIG. 39 depicts a tablet 3900 while FIG. 40 depicts a tablet 4000. As can be seen, the tablets can support multiple user accounts. In particular, tablet 3900 presents a widget 3902 that allows users to scroll through and select their accounts for loading, and tablet 4000 presents a similar widget 4002. In view of the multi-user support, security features can be included, such as passcode entry or biometric scanning, to prevent unauthorized users from accessing sensitive data. The displays can be, for example, touch screen displays, including a capacitive touch display. The tablets can be configured to communicate over various protocols/frequencies, like Wi-Fi, cellular, Bluetooth®, etc., and can be configured to run the Android™ operating system (any suitable version), although the tablets may operate using other suitable operating systems. The tablets can also be configured to download applications from the app shop described above or from other suitable sources. If desired, a core set of applications can be pre-installed on the device before being sold to consumers. In one particular arrangement, system level scale or letterbox format can be enabled for applications that are not yet optimized for the tablet. The tablets can include a GPS receiver and may provide 3G/Long Term Evolution (LTE) options.

The tablets described herein can support a wide variety of services and can form part of a digital communications package that offers multiple services, like advanced digital TV and DVR, Internet connection and digital phone lines. The tablets can also provide a Web browser that fully supports Adobe Flash® or other multimedia platform. Such tablets can also provide features related to home automation and security, home energy management, home healthcare and independent living and other digital communications.

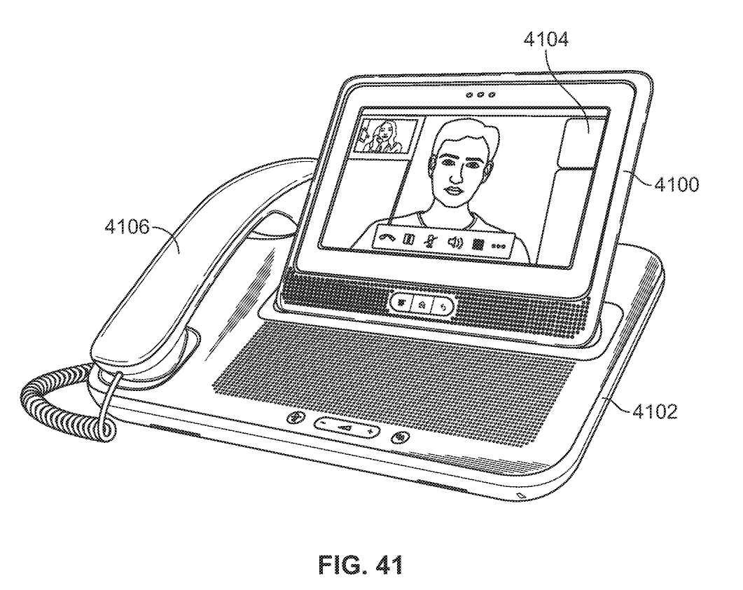

Referring to FIG. 41, another example of a tablet 4100 that is associated with the communication system and a docking station 4102 that can receive tablet 4100 are shown. Tablet 4100, like the ones previously described, can support multiple user accounts, can provide a touch screen display 4104, can communicate in accordance with numerous wireless protocols (e.g., Wi-Fi, 3G, 4G, Bluetooth, etc.) and can access applications from the app shop. Tablet 4100 can also be docked to a docking station, such as docking station 4102, that can include a handset 4106. This docking can increase the utility and features offered by tablet 4100.

Additional features may be associated with tablet 4100. In particular, tablet 4100 may be able to conduct 3G or even 4G cellular communications and can provide HD video output and multiple cameras, like still and moving images cameras. This configuration can be helpful in conducting video calls, for example. Tablet 4100 can also include software and circuitry for conducting interactive video calls and can run on the Android™ operating system or other suitable platforms. Tablet 4100 can also transmit and receive data using various protocols and communication infrastructures including but not limited to IEEE 802.11a/b/g/n Wi-Fi, Bluetooth®, 3G and 4G.

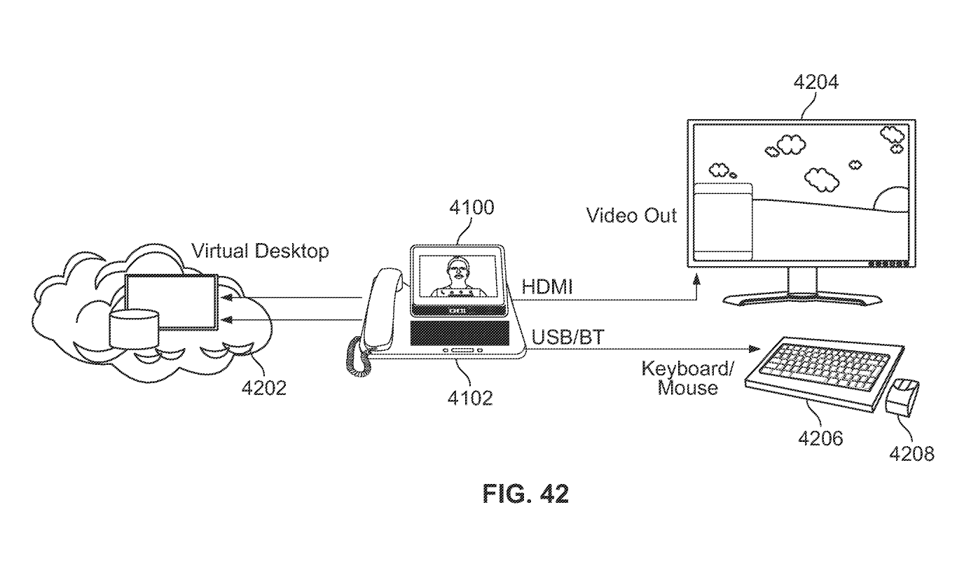

Referring to FIG. 42, as an option, tablet 4100 (and, if applicable, docking station 4102) can be configured to support desktop virtualization in which tablet 4100 can be coupled to a central server through any suitable communication medium, such as a network 4202. Also, tablet 4100 and/or docking station 4102 can support HDMI or some other suitable interface for enabling images (mirrored or other) to be displayed on an external display 4204. These components can also be configured to support wireless communications between certain peripherals, like a keyboard 4206 or a mouse 4208.

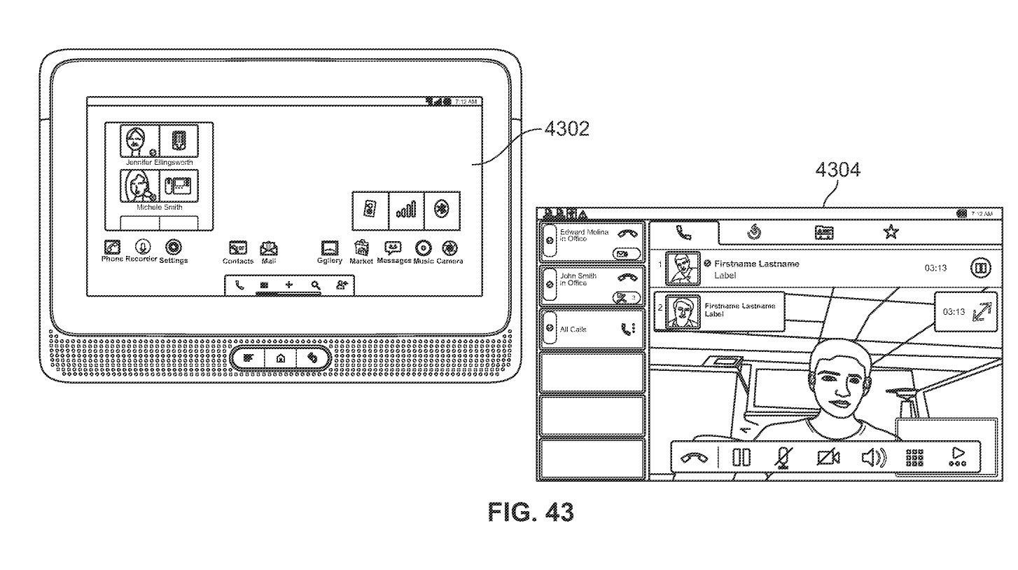

Referring to FIG. 43, several non-limiting examples of user interfaces (UI) that may be presented to a user are shown. In particular a UI 4302 and a UI 4304 are shown. These UIs are related to video calls, and participants of the call can be listed, along with pictures or other symbols identifying these participants. Various controls, such as volume, speakerphone, mute button, etc., can be presented to the user in the UI. Icons that represent the type of device that a participant is using to participate in the call can be shown, and indicators can be displayed to show whether a participant is still on the call.

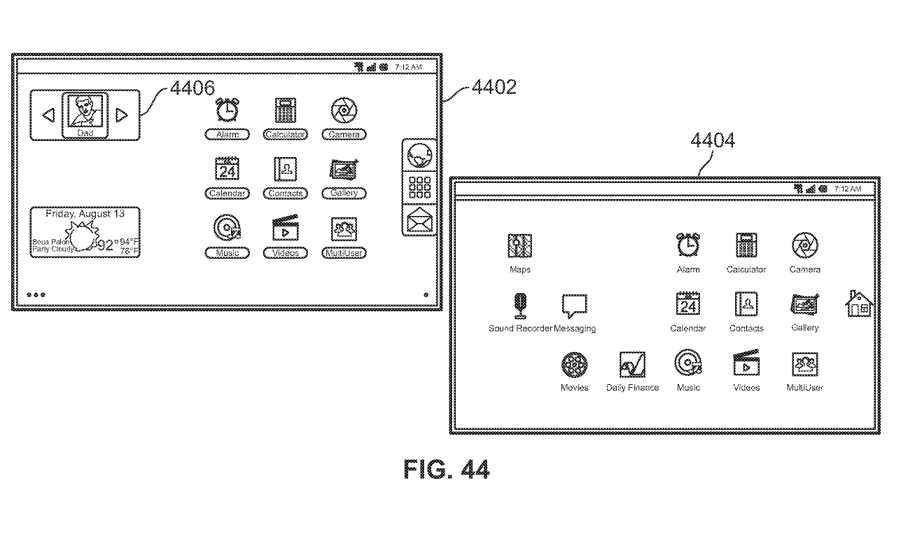

Moving to FIG. 44, an example of a home screen 4402 that may apply to any of the aforementioned tablets is shown. As an option, a multi-user widget 4406 can be part of home screen 4402. Also shown here is an example of an application tray 4404, or a page that presents multiple applications. Any suitable number of applications may be displayed here, and multiple pages may be displayed, depending on the number of applications to be presented.

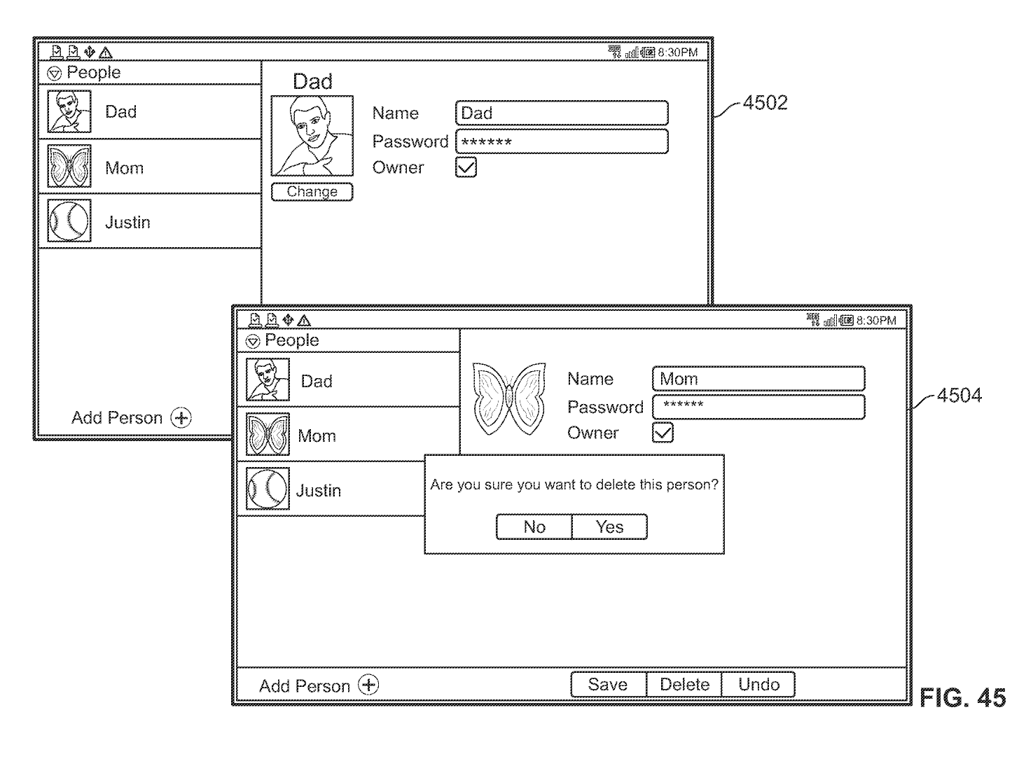

As previously noted, the tablets can support multiple user accounts. To help users access their accounts, a UI element (i.e., widget) can be implemented into the tablet, such as widget 4406 of FIG. 44. In response to activation of the widget, access to various UIs may be provided to help manage user accounts. For example, FIG. 45 illustrates a first UI 4502 and a second UI 4504 by which user accounts can be managed. Such a UI can permit a user to identify and access his/her account (out of multiple accounts). When selected, a profile for this user can be loaded. To protect a user's data, the user may be granted access to the profile only if the user meets a security requirement, such as entering an authorized passcode or providing a biometric measurement. The UI can also display which of the users is currently active, which can allow users to determine whose profile is currently displayed. The profile can be customized by a user, which may include selection of an identifier (like a small photo of the user), a particular wallpaper, browser favorites, contacts, media selections, applications, etc. Through the UIs, a user can also create new or delete existing users, rest or clear a user's passcode, lock/unlock a user's account or edit a user's access to certain features of his/her profile, like restricting access to certain applications.

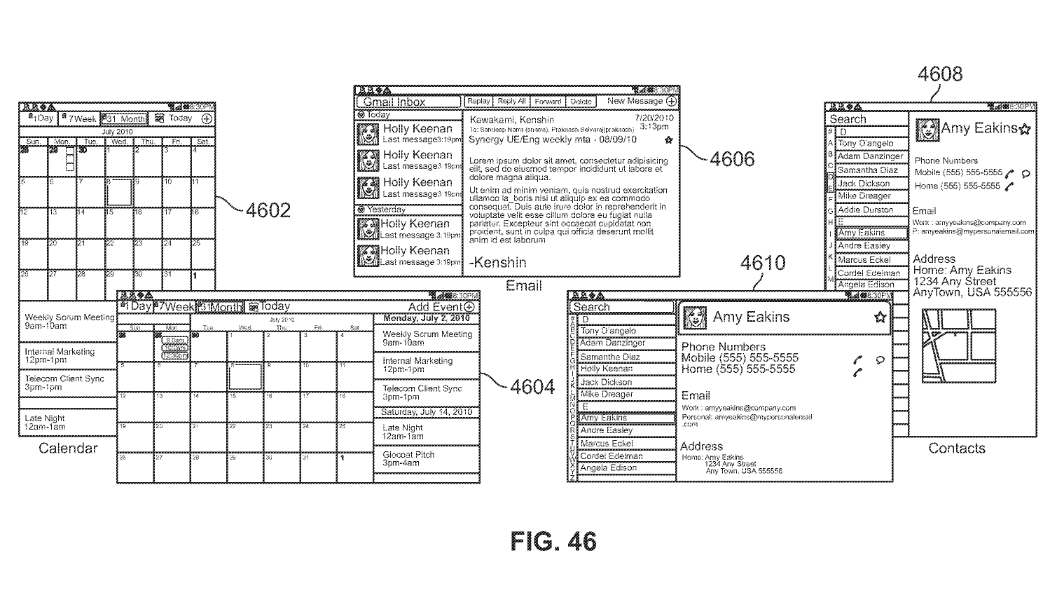

The tablets have the ability to display information in accordance with several orientations. For example, referring to FIG. 46, information can be displayed in accordance with portrait or landscape views. In particular, as shown in FIG. 46, calendar information may be shown using a portrait view 4602 or a landscape view 4604 and contacts information may be shown using a portrait view 4608 or a landscape view 4610. Moreover, multiple panes or at least portions of such panes may be displayed simultaneously, with some of them possibly overlapping one another. For example, as shown in FIG. 46, e-mail related information may be shown using a multiple-pane view 4606. In a like manner, multimedia experiences can be customized to fit a user's personal tastes. For example, a calendar entry or a reminder may contain personalized effects that can be selected by a user. Moreover, a user can customize how multi-media selections will be presented.

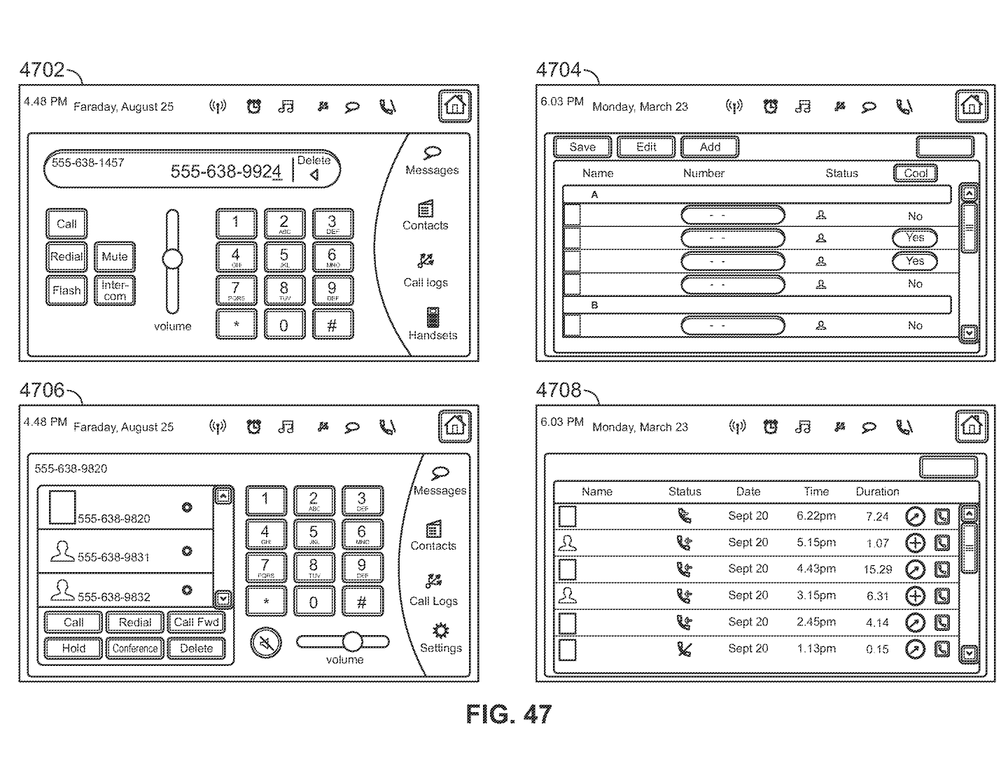

The tablets can also provide a UI for placing telephone calls, and examples of such are shown in FIG. 47. In particular, FIG. 47 shows a first telephony UI 4702, a second telephony UI 4704, a third telephony UI 4706 and a fourth telephony UI 4708. The tablets can present a UI for a residential setting and can support three-way calling, call waiting and call transfer. The tablets can also support various standards for voice, such as G.711u/a, G.726 ADPCM, G.729 and G.722 (wideband). On the enterprise side, the tablets can support, for example, multiple providers, multiple lines and conferencing. In either arrangement, the availability of a contact can be displayed to a user. For example, if a contact is away from his/her desk (which can be gleaned from no computer activity after a predetermined time or some other method), this status can be indicated next to the contact's name. A call history may also be part of the UI. The tablet can also support DECT handsets, such as when it is engaged with a docking station that includes a DECT handset.

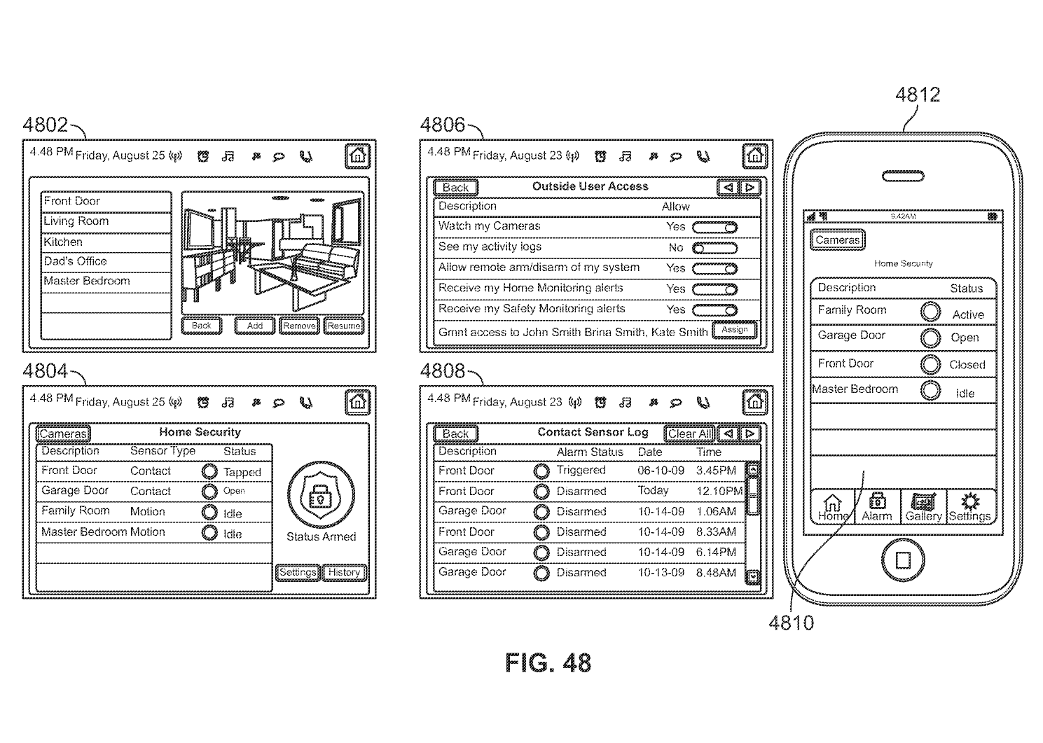

Moving to FIG. 48, the tablets can be useful for security and monitoring, and exemplary UIs for such processes are shown. In particular, FIG. 48 shows a first security and monitoring UI 4802, a second security and monitoring UI 4804, a third security and monitoring UI 4806 and a fourth security and monitoring UI 4808. By using such UIs, a user can select from multiple entries to view a particular room or location, and the status of one or more sensors and the overall system can be displayed. As another example, a user can select various settings in the security system, such as selecting a camera for watching, reviewing activity logs or other sensor logs, allowing remote arming or disarming of the system and permitting remote receipt of alarms and safety monitoring alerts. Through the UI, a user can also grant access to one or more other users. Of course, other settings can be selected other than these described here. As further shown in FIG. 48, a handset 4812, which may comprise one of the handsets that were previously described, can also be configured to cooperate with the system here to enable the receipt of remote alarm notifications and to remotely control various aspects of the system. Handset 4812 includes a touch-screen display 4810 for facilitating user interaction therewith.

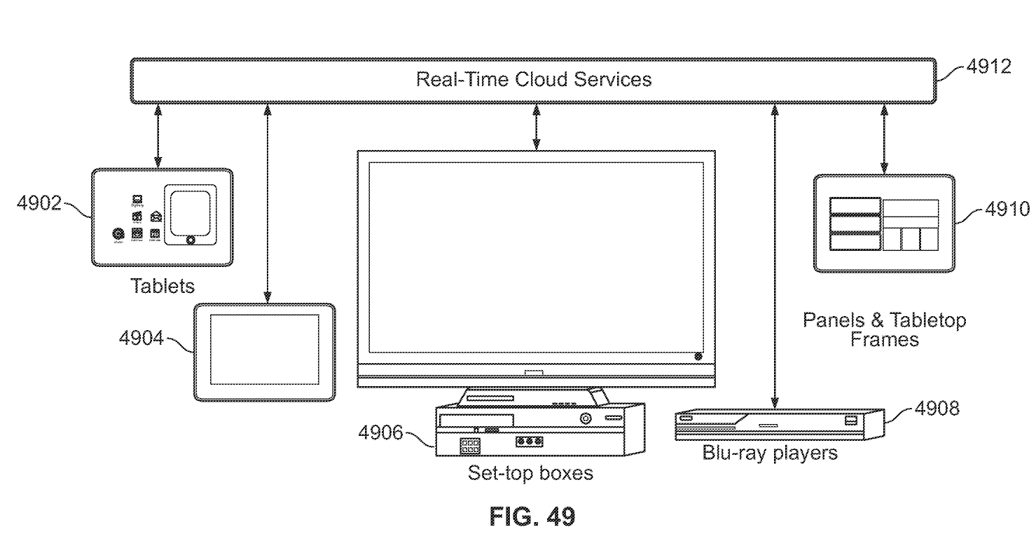

One or more home multi-media devices, such as a set-top box or a DVD player, can be part of the communication system, and one or more of the devices described above can be configured to communicate with or control the home multi-media devices. An exemplary arrangement is pictured in FIG. 49. As an example, home multi-media devices such as tablets 4902 and 4904, set-top boxes 4906, Blu-ray players 4908, and panels and tabletop frames 4910, and the devices that can be used to control them can be connected with cloud services 4912 of the communication system (described earlier). As such, the cloud services described above can apply in this setting, as well. In one example, a tablet or other mobile communication device can be loaded with an application that can be used to control any one of the home multi-media devices.

As part of this control, the tablet or other mobile device can include an application that can cause a suitable electronic program guide (EPG) to be displayed, which can be related to a set-top box, TV or other home multi-media device. As such, a user can easily make selections from the EPG to control the home multi-media devices. Other services can also be accessed at the tablet or other mobile device, like video on demand (VOD), for further control of the home multi-media devices.

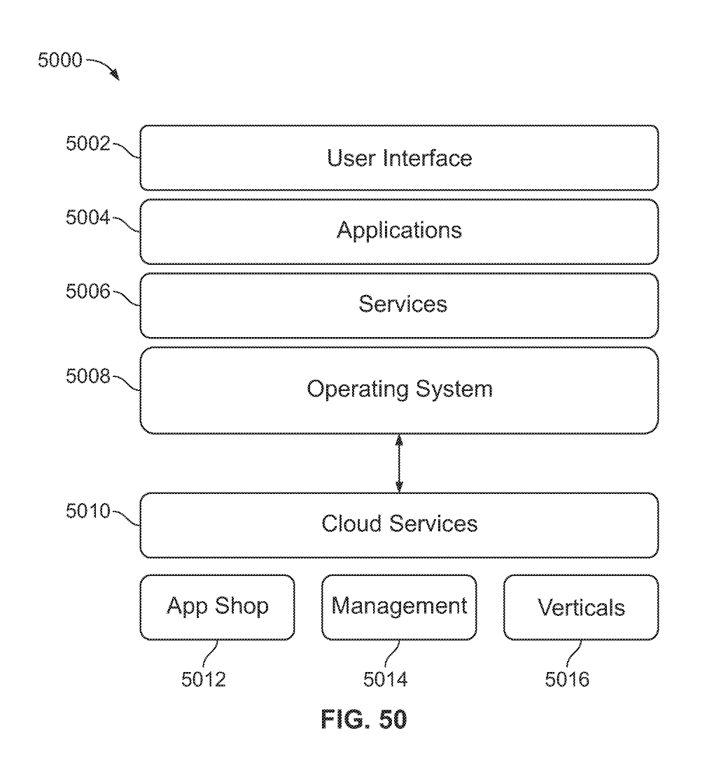

FIG. 50 is a block diagram of a managed ecosystem 5000 that may be implemented by the communication system described herein that can provide many service and new features and avoid the pitfalls of commoditization. As shown in FIG. 50, managed ecosystem 5000 includes number of device-side components including a user interface 5002, applications 5004, services 5006, and an operating system 5008 and a number of network-based components including cloud services 5010, an app shop 5012, a management system 5014 and verticals 5016. The services described herein can be added to any platform to turn a device into part of a managed ecosystem. New back-end services from numerous industries, like healthcare, media, communications and security, can be rolled out to multiple devices. This permits service providers, utilities, enterprises to at least partially control the devices.

### B. Dual Mode Fingerprint Scanner/User Interface Device

As discussed above in reference to at least FIGS. 3, 5 and 6, a handset 100 or other mobile electronic device can include a sensor, such as sensor 302, that can operate both as a fingerprint scanner and a user interface device. Thus, for example, such sensor may allow for single-handed authentication, web/document scrolling, or the like, making for even faster interactions with the mobile electronic device.

In some embodiments, the sensor may be implemented as a capacitance sensor that may operate both as a fingerprint scanner and as a user interface device for accepting user inputs that in turn control images presented to the user on a display of a mobile electronic device. Placement of the dual-mode capacitance sensor on the back of the device and the display on the front of the device adds additional convenience and functionality. For example, a user may perform single handed authentication by simply picking up the device. In addition, because of the dual-mode functionality provided by the dual-mode capacitance sensor, a user may, while viewing a display on the front of the device, use the dual-mode capacitance sensor on the back of the device to scroll through, select, and/or otherwise manipulate images provided on the display.

In a fingerprint scanning mode, input is collected when a user places a finger on the dual-mode capacitance sensor. The fingerprint scanning logic uses the input from the dual-mode capacitance sensor to create a digital image of the user's fingerprint. A template of the user's fingerprint may be created using the entire fingerprint pattern or identifying features of the fingerprint may be extracted and used to create a template. A template of an authorized user's fingerprints may be stored and used for future authorization purposes. For example, when a user purchases, is issued, or otherwise acquires a mobile electronic device incorporating the dual-mode capacitance sensor, the user or issuer of the mobile electronic device may scan the fingerprint of the intended user and save the fingerprint to the mobile electronic device as an authorized user of the device, thereby enrolling the user. Then, when the user wishes to access the device, the user merely need touch the dual-mode capacitance sensor to gain access to the device. In some embodiments, multiple users may be authorized to use the device. In such a case, each should be enrolled as described above. In some embodiments, an administrator or owner of the device may set different levels of access. For example, some users may be authorized to access all features of the device (full access). In other cases, some users may be granted access to only some of the device's features (partial access). For example, some users may be prohibited from changing settings of the device or from accessing, adding and/or deleting contacts, data, and/or applications. In enterprise environments, the levels of access may extend to include server content, access to buildings or portions of buildings (when the device is used as a card reader), etc.

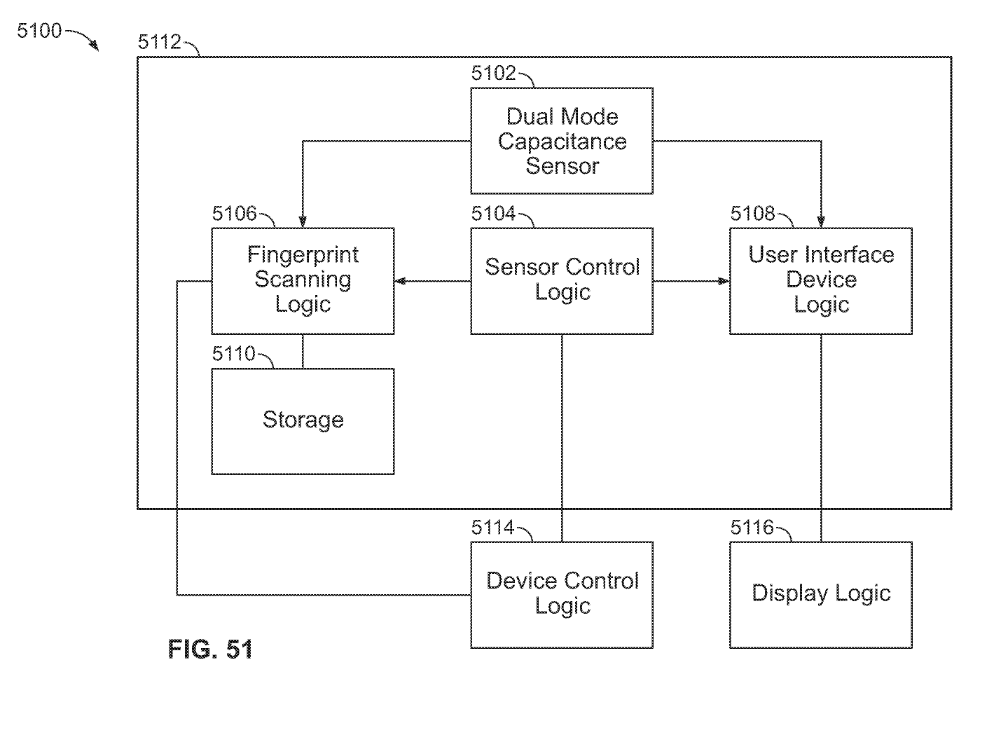

Embodiments of a dual-mode capacitance sensor may be implemented in a variety of environments. For instance, FIG. 51 illustrates a block diagram of a mobile electronic device 5100, according to an exemplary embodiment. As shown in FIG. 51, mobile electronic device 5100 includes a dual-mode capacitance sensor 5102, sensor control logic 5104, fingerprint scanning logic 5106, user interface device logic 5108, capacitance sensor chip 5112, storage 5110, device control logic 5114, and display logic 5116. The elements of mobile electronic device 5100 are described as follows.

Dual-mode capacitance sensor 5102 is a capacitance sensor that functions as a fingerprint scanner when operating in a first mode, and that functions as a user interface device when operating in a second mode. Dual-mode capacitance sensor 5102 receives input from a user's finger when a user touches or comes close to touching a surface of the sensor. Dual-mode capacitance sensor 5102 may include an array of pixels or a grid of electrodes, or a combination thereof, and a dielectric that form capacitors. An electric field is generated by applying a potential to the grid or array. Placing a finger on or near the grid infringes an electric field created between the capacitor plates and alters the capacitance in an area of infringement. A difference in capacitance between ridges and valleys of the fingerprint, or between portions of the scanner (array), may be measured to form an image of a fingerprint, determine a location of a finger, and/or track finger movement, etc. on the scanner. Dual-mode capacitance sensor 5102 receives inputs from a user for performing a finger print scanning function when operating in the first mode, and for performing a user interface device function when operating in the second mode. In some embodiments, mobile electronic device 5100 may include a provision allowing an authorized user to enable or disable one or both operating modes of dual-mode capacitance sensor 5100. Furthermore, in some embodiments, capacitance sensor chip 5112 has a proximity sensing capability that wakes up mobile electronic device 5100 when a user's finger nears dual-mode capacitance sensor 5102.

Sensor control logic 5104 is logic that is configured to determine a mode of operation of dual-mode capacitance sensor 5102. A mode of operation of dual-mode capacitance sensor 5102 may depend on a state of mobile electronic device 5100. For instance, mobile electronic device 5100 may be in a locked state or an unlocked state. When mobile electronic device 5100 is in a locked state, access to mobile electronic device 5100 may be denied to prevent unauthorized access of mobile electronic device 5100. Different events may result in mobile electronic device 5100 becoming locked. For example, mobile electronic device 5100 may be automatically locked after a period of inactivity, such as when mobile electronic device 5100 is in a “sleep” state, or when mobile electronic device 5100 is first powered on. A user may also have an option to manually lock mobile electronic device 5100, or to program a schedule of times during which mobile electronic device 5100 is locked and unlocked. If mobile electronic device 5100 is in a locked state, dual-mode capacitance sensor 5102 may operate in a first mode to provide a fingerprint scanning function. For example, mobile electronic device 5100 may remain in a locked state until an authorized user accesses mobile electronic device 5100. In order to access mobile electronic device 5100, a user may need to first be authenticated. Thus, dual-mode capacitance sensor 5102 may operate in a first mode to provide a fingerprint scanning function for performing biometric authentication of a user, for example, when mobile electronic device goes to sleep or otherwise becomes locked. If mobile electronic device 5100 is in an unlocked state, such as, for example, after a user is authenticated, dual-mode capacitance sensor 5102 may operate in a second mode of operation for performing a user interface device function.

In order to determine a mode of operation of dual-mode capacitance sensor 5102, sensor control logic 5104 may first determine a state of mobile electronic device 5100 (e.g., locked or unlocked). Sensor control logic 5104 may be further configured to enable functionality associated with different operating modes of dual-mode capacitance sensor 5102. For example, sensor control logic 5104 may determine how to process inputs to dual-mode capacitance sensor 5102, and may instruct other elements of mobile electronic device 5100 to process inputs received by dual-mode capacitance sensor 5102 in accordance with a mode of operation of dual-mode capacitance sensor 5102. For instance, when dual-mode capacitance sensor 5102 is operating in a first mode, sensor control logic 5104 may enable a fingerprint scanning function and when dual-mode capacitance sensor 5102 is operating in a second mode, sensor control logic 5104 may enable a user interface device function. Sensor control logic 5104 may be further configured to disable one or both operating modes of dual-mode capacitance sensor 5100 in response to a user command. For example, if for any reason a user wants to disable the fingerprint scanning function and/or the user interface device function of dual-mode capacitance sensor 5102, sensor control logic 5104 may provide the user with the option of disabling one or both operating modes. For example, sensor control logic 5104 may be programmable by a user.

Fingerprint scanning logic 5106 is logic that is configured to perform a fingerprint scanning function of dual-mode capacitance sensor 5102. Fingerprint scanning logic 5106 processes input received by dual-mode capacitance sensor 5102 when a user places a finger on dual-mode capacitance sensor 5102 to generate a digital image of a fingerprint of the user. Fingerprint scanning logic 5106 may extract identifying features of the fingerprint to generate digital data corresponding to the fingerprint of the user. In some embodiments, to register or enroll a user as an authorized user, fingerprint scanning logic 5106 may store a template of the digital data corresponding to the fingerprint of the authorized user. Fingerprint scanning logic 5606 may store the template in storage local to fingerprint scanning logic 5106, local to mobile electronic device 5100, or in a remote location, as will be described further below. Stored fingerprint data may be used to authenticate a user during subsequent attempts to access mobile electronic device 5100, for example.

In some embodiments, fingerprint scanning logic 5106 performs a fingerprint scanning function of dual-mode capacitance sensor 5102 to perform biometric authentication of a user. Fingerprint scanning logic 5106 processes input received by dual-mode capacitance sensor 5102 when a user places a finger on dual-mode capacitance sensor 5102. Fingerprint scanning logic 5106 processes the input to generate digital data corresponding to a fingerprint of the user. Fingerprint scanning logic 5106 is further configured to compare the generated digital data to known fingerprint data of authorized users. The known fingerprint data may have been generated and stored by fingerprint scanning logic 5106 as described above, or the known fingerprint data may have been generated and stored remotely. Fingerprint scanning logic 5106 is configured to access the known fingerprint data and compare the generated digital data with the known fingerprint data. Fingerprint scanning logic 5106 is further configured to determine if the generated digital data matches any of the known fingerprint data, and to authenticate the user when the generated digital data matches any of the known fingerprint data. Fingerprint scanning logic 5106 may be further configured to notify an operating system of mobile electronic device 5100 or a program running on mobile electronic device 5100 when a user is authenticated, i.e., when a match is found.

Capacitance sensor chip 5112 is an integrated circuit chip containing hardware for performing the fingerprint scanning function and the user interface device function. Sensor control logic 5104, fingerprint scanning logic 5106 and user interface device logic 5108 may be implemented in hardware, firmware and/or software of capacitance sensor chip 5112 alone or in conjunction with hardware, firmware and/or software of mobile electronic device 5100.

Storage 5110 is one or more storage devices in which known fingerprint data of authorized users may be stored. Storage 5110 is shown in FIG. 51 inside of capacitance sensor chip 5112 because storage 5110 may be, for example, a register of capacitance sensor chip 5112. However, storage 5110 is not limited to being an on-board component of capacitance sensor chip 5112, and may be, for example, a memory or storage device of mobile electronic device 5100, a memory or storage device of a device connected to mobile electronic device 5100 via one or more wired and/or wireless links, a database, or any other local or remote memory or storage device or any combination thereof.

Device control logic 5114 may control various functions of mobile electronic device 5100. One such function may be a locking/unlocking function of mobile electronic device 5100. In such a case, device control logic is configured to, among performing other functions, perform a function of locking and unlocking mobile electronic device 5100. Device control logic may be configured to unlock mobile electronic device 5100 upon authentication of a user to allow the user to access mobile electronic device 5100. For example, device control logic 5114 may unlock mobile electronic device 5100 in response to notification of authentication of a user from fingerprint scanning logic 5106. Device control logic is further configured to lock mobile electronic device 5100 to prevent unauthorized access of mobile electronic device 5100. For instance, in some embodiments, device control logic 5114 locks mobile electronic device 5100 in response to mobile electronic device 5100 entering a sleep state. In some embodiments, device control logic 5114 locks mobile electronic device 5100 when mobile electronic device 5100 is powered on. In some embodiments, device control logic 5114 locks mobile electronic device in response to a user command. A user command to lock mobile electronic device 5100 may be generated and received in real time (e.g., by a user pressing a button or voicing a command) or may be programmed by a user in advance. For instance, provision may be made for a user to program a length of time for mobile electronic device 5100 to be idle before device control logic 5114 locks mobile electronic device 5100, or a time of day at which to automatically lock mobile electronic device 5100.

In other embodiments, user authentication and access control may be implemented in other ways, as would be known to persons skilled in the relevant art(s). In some embodiments, an operating system of or a program running on mobile electronic device 5100 may perform the steps of comparing the digital data corresponding to a fingerprint of a user generated by fingerprint scanning logic 5106 to known fingerprint data of authorized users and perform the authentication of the user and/or may set an access level at which the user may access the device, e.g., full access, partial access, etc. In such an embodiment, fingerprint scanning logic 5106 stores the fingerprint pattern in memory such as a register for comparison, and sends it to the operating system or program for authentication. In some other embodiments, an operating system of or a program running on mobile electronic device 5100 may perform verification of authentication performed by fingerprint scanning logic 5606 and/or may set an access level of the user. In such embodiments, the operating system of or program running on mobile device 5100 or device control logic 5114 unlocks mobile electronic device 5100 in response to authentication of the user to allow the user to access mobile electronic device 5100.

User interface device logic 5108 is logic that is configured to perform a user interface device function of dual-mode capacitance sensor 5102. User interface device logic 5108 is configured to process inputs received by dual-mode capacitance sensor 5102 to perform user interface device functions. For instance, user interface device logic 5108 processes the inputs to determine a location and movement of a user's finger on dual-mode capacitance sensor 5102. User interface device logic 5108 interprets the location and movement of the user's finger as input commands, generates data containing the input commands, and sends the data containing the input commands to display logic 5116.

Display logic 5116 is logic configured to generate output to be presented on a display of mobile electronic device 5100. Display logic 5116 works in conjunction with user interface device logic 5108 to interface with a user. Display logic 5116 receives data containing input commands from user interface device logic 5108, interprets the data to obtain the input commands, and applies the input commands to the output to alter an appearance of the output on the display according to the input commands Display logic 5116 uses the input commands to generate the output such that the output presented on the display responds to the users input commands. For instance, the output may be in the form of graphical images presented on the display, and display logic 5116 in conjunction with user interface device logic 5108 allows a user to scroll through the images on the display by swiping a finger over the dual-mode capacitance sensor 5102. In some embodiments, a user may swipe his or her finger horizontally or vertically across dual-mode capacitance sensor 5102 to scroll horizontally or vertically through graphical images presented on the display. In some embodiments, a user's tap on dual-mode capacitance sensor 5102 may result in cursor placement or selection of an item on the display. User interface functions performed by user interface device logic 5108 and display logic 5116 are not limited to those disclosed herein and may include other user interface functions as may be apparent to those of skill in the art(s).

Sensor control logic 5104, fingerprint scanning logic 5106, user interface device logic 5108, device control logic 5114, and display logic 5116 may be implemented by hardware, software, firmware, or any combination thereof. For example, any of sensor control logic 5104, fingerprint scanning logic 5106, and user interface device logic 5108 may be implemented partially or entirely within capacitance sensing chip 5112 associated with dual-mode capacitance sensor 5102. Alternatively, any of sensor control logic 5104, fingerprint scanning logic 5106, and user interface device logic 5108 may be implemented partially or entirely as computer code configured to be executed in one or more processors, or as firmware stored on flash memory and/or embedded in one or more hardware devices, or as a combination of computer code, hardware logic/electrical circuitry, and/or firmware, for example.

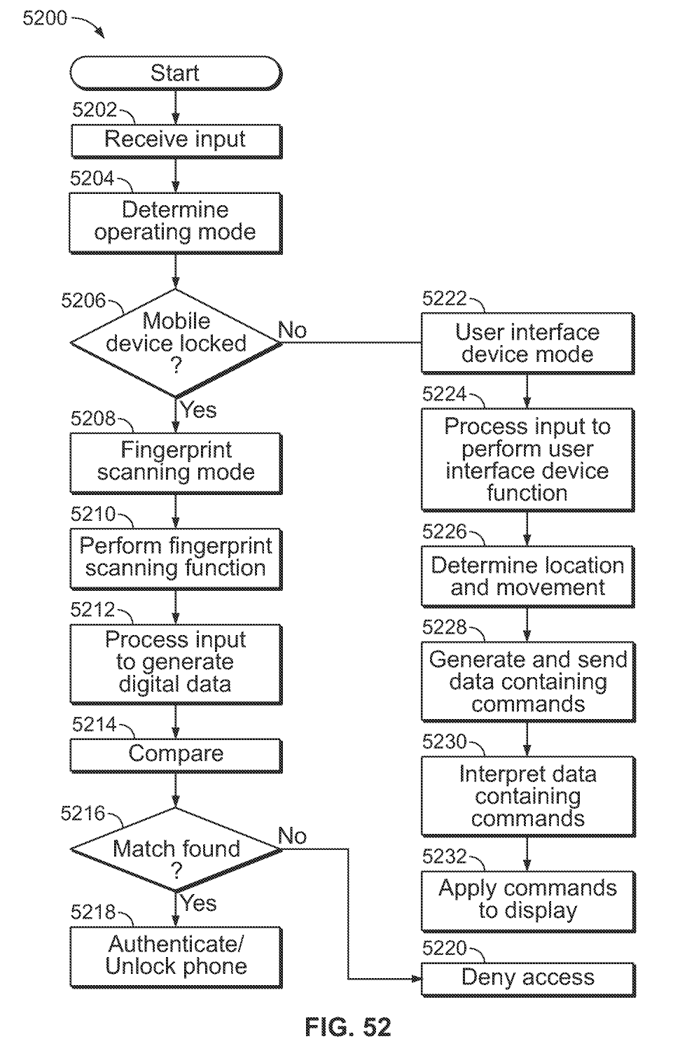

FIG. 52 illustrates a flowchart 5200 of a method by which a dual mode capacitance sensor may be used, according to an embodiment. Flowchart 5200 may be performed by mobile electronic device 5100 shown in FIG. 51, for example. However the method of flowchart 5200 is not limited to that embodiment. Further structural and operational embodiments will be apparent to persons skilled in the relevant art(s) based on the discussion regarding flowchart 5200. Flowchart 5200 is described as follows.

Flowchart 5200 begins with step 5202. At step 5202, input is received by dual-mode capacitance sensor 5102 when a user touches or comes close to touching a surface of dual-mode capacitance sensor 5102. Sensor control logic 5104 determines a mode of operation of dual-mode capacitance sensor 5102 in step 5204. In order to determine a mode of operation of dual-mode capacitance sensor 5102, sensor control logic 5104 determines whether mobile electronic device 5100 is in a locked state or an unlocked state at step 5206. However, sensor control logic 5104 may determine a mode of operation of dual mode capacitance sensor 5102 based on a variety of other factors, such as, for example, whether an authorized user is already logged on to mobile electronic device 5100. If mobile electronic device 5100 is in a locked state, sensor control logic 5104 determines at step 5208 that dual-mode capacitance sensor 5102 is operating in a fingerprint scanning mode, and control flows to step 5210 to perform a fingerprint scanning function at steps 5210-5216. At step 5212, fingerprint scanning logic 5206 processes the input of dual-mode capacitance sensor 5102 to generate digital data corresponding to a fingerprint of the user. At step 5214, the generated digital data is compared to known fingerprint data of authorized users. At step 5216, fingerprint scanning logic determines if the generated digital data matches any of the known fingerprint data. If the generated digital data matches any of the known fingerprint data, the user is authenticated at step 5218 and device control logic 5114 unlocks mobile electronic device 5100 to allow the user to access mobile electronic device 5100. If no match is found between the generated digital data and the known user fingerprint data at step 5216, no authentication occurs and access is denied at step 5220.

If, in step 5206, sensor control logic 5104 determines that mobile electronic device 5100 is unlocked, sensor control logic 5104 determines at step 5222 that dual-mode capacitance sensor 5102 is operating in a user interface device mode, and control flows to step 5224 to perform user interface device function at steps 5224-5232. At step 5224, user interface device logic 5108 processes inputs of dual-mode capacitance sensor 5102 to perform user interface device functions. At step 5226, user interface device logic 5108 processes inputs of dual-mode capacitance sensor 5102 to determine a location and movement of a user's finger on dual-mode capacitance sensor 5102. At step 5228, user interface device logic 5108 interprets the location and movement of the user's finger as input commands, generates data containing the input commands and sends the data to display logic 5116. At step 5230, display logic 5116 interprets the data to obtain the input commands and at step 5232, display logic 5116 applies the commands to output presented on a display to alter the appearance of the display responsive to the input commands.

With respect to FIG. 51, embodiments have been described herein with reference to mobile electronic device 5100. In some embodiments, mobile electronic device 5100 comprises a cell phone, a handheld device that allows voice communications with others, some other voice communications device, or the like. In other embodiments, mobile electronic device 5100 comprises a personal digital assistant (PDA), hand-held gaming device, notebook computer, printer, appliance including a set-top, media center, or other appliance, automobile-embedded or attached computing devices, other mobile devices, or the like.

A mechanical implementation of a mobile electronic device that includes a dual mode capacitance sensor according to an exemplary embodiment will now be described with continued reference to FIGS. 1-5. FIGS. 1-5 illustrate a handset 100, which may comprise one embodiment of mobile electronic device 5100. As shown in FIGS. 1, 2 and 4, handset 100 includes a front panel 102, a display 104, and a perforated audio element 106 positioned at a peripheral edge of display 104. Display 104 may comprise a touch screen display while perforated audio element 106 may comprise a portion of front panel 102 that houses one or more speakers.

As shown in FIGS. 3 and 5, handset 100 further includes a back panel 300, a dual-mode capacitance sensor 302, and a fold-out kickstand 500 that facilitates hands free use of handset 100. Back panel 300 functions as a housing for mobile electronic device 100. Dual-mode capacitance sensor 302 is provided on back panel 300.

Dual-mode capacitance sensor 302 may be an embodiment of dual-mode capacitance sensor 5102 of FIG. 51. Thus, the description of dual-mode capacitance sensor 5102 may apply equally to dual-mode capacitance sensor 302 and need not be repeated here for the sake of brevity, except to say that dual-mode capacitance sensor 302 performs both a fingerprint scanning function and a user interface device function depending on a mode of operation of dual-mode capacitance sensor 302. When dual-mode capacitance sensor 302 is performing a user interface device function, user inputs to dual-mode capacitance sensor 302 on back panel 300 manipulate graphical images presented on display 104 on front panel 102.

As shown in FIGS. 1-5, front panel 102 and back panel 300 have substantially rectangular dimensions. Dual-mode capacitance sensor 302 is positioned to be centered between long sides of back panel 300 and to be closer to one short side of back panel 300 than the other, such that, when long sides of back panel 300 are positioned vertically, dual-mode capacitance sensor 302 is positioned toward the top of back panel 300. By positioning dual-mode capacitance sensor 302 toward the top of the rear of handset 100, a user may comfortably hold handset 100 and scroll through images presented on display 104 on the front of handset 100 using just one hand. Similarly, a user may easily perform a one-handed logon to handset 100 by picking up the device when dual mode capacitance sensor 302 is operating in a fingerprint scanning mode, such as when handset 100 is locked and may require user authentication to be unlocked and accessed. It is noted, however, that dual-mode capacitance sensor 302 is not limited to such a position and may be positioned elsewhere on handset 100.

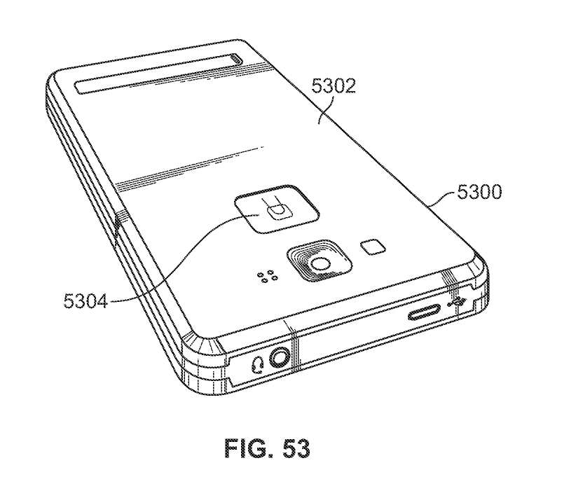

As shown in FIGS. 3 and 5, dual-mode capacitance sensor 302 is positioned in a recessed area of back panel 300. Placement of dual-mode capacitance sensor 302 in a recessed area of back panel 300 may aid in preventing accidental inputs to dual-mode capacitance sensor 302. Dual-mode capacitance sensor 302 may also be disposed under a plastic or glass protective overlay. For example, FIG. 53 shows an embodiment in which dual-mode capacitance sensor 302 has such a protective overlay.

As shown in FIG. 53, a mobile electronic device 5300 includes a back panel 5302 that is a slight variation of back panel 300. A dual-mode capacitance sensor is disposed in back panel 5302 under a protective overlay 5304. Positioning the dual-mode capacitance sensor under protective overlay 5304 may protect the dual-mode capacitance sensor from finger oils, dust, debris and spills, for example. Protective overlay 5304 may be formed of glass, plastic, or any other suitable material through which capacitance sensing can be performed, as should be readily understood by one of ordinary skill in the art(s). Protective overlay 5304 as shown in FIG. 53 is substantially flush with back panel 5302 and includes a graphic indicating the presence of the dual-mode capacitance sensor. Note that in alternate implementations, protective overlay 5304 or portion(s) thereof may be raised above back panel 5302 so that a user can determine where the dual-mode capacitance sensor is located by sense of touch.

Devices in which embodiments may be implemented may include storage, such as storage devices, memory devices, and further types of computer-readable media. Examples of such storage are non-volatile memory such as flash memory, ROM/PROM/EPROM/EEPROM, FeRAM, CBRAM, PRAM, SONOS, RRAM, Racetrack memory, NRAM, removable optical disks, digital video disks, etc., and volatile memory such as RAM, SRAM, DRAM, Z-RAM, TTRAM, A-RAM and ETA RAM. Such storage may store program modules that include logic for implementing sensor control logic 5104, fingerprint scanning logic 5106, user interface device logic 5108, device control logic 5114, display logic 5116, and/or instructions for performing the process of flowchart 5200, and/or further embodiments described herein. Any of sensor control logic 5104, fingerprint scanning logic 5106, and user interface device logic 5108 may be implemented partially or entirely within capacitance sensing chip 5112 associated with dual-mode capacitance sensor 5102. Alternatively, any of sensor control logic 5104, fingerprint scanning logic 5106, user interface device logic 5108, device control logic 5114, and display control logic 51616 may be implemented partially or entirely as computer code configured to be executed in one or more processors, such as a processing unit of mobile device 5100, or as hardware logic/electrical circuitry, or as firmware stored on flash memory and/or embedded in one or more hardware devices, or as a combination of computer code, hardware logic/electrical circuitry, and/or firmware, for example.

### C. Exemplary Docking Station Implementations

As discussed above, a communication system in accordance with an embodiment may comprise a docking station with which a mobile electronic device can be selectively engaged and disengaged, wherein the docking station is configured to be removably attached to a component. For example, the mobile electronic device may comprise handset 100 as described above in reference to at least FIGS. 1-6 and the docking station may comprise docking station 1100 as described above in reference to FIGS. 11-15 or docking station 2002 as described above in reference to FIGS. 20-22. However, these are only examples and are not intended to be limiting.

With continued reference to FIGS. 11-15, docking station 1100 may comprise an engaging structure 1202 with which a mobile electronic device, such as handset 100, can be selectively engaged and disengaged. Engaging structure 1202 is configured to at least physically support handset 100 when the mobile electronic device is engaged therewith. The manner in which engaging structure 1202 engages handset 100 may vary depending upon the implementation. For example, such engagement may be mechanical in nature. Mechanical engagements may include, for example, providing a recessed area or enclosure in which handset 100 may be disposed or providing a shelf, ledge or lip upon which handset 100 may be rested. Such mechanical engagements may also comprise the use of pins and accompanying apertures for securing handset 100 to engaging structure 1202. As another example, the engagement may be magnetic in nature. In accordance with this example, one or both of engaging structure 1202 and handset 100 may include one or more magnetic components for attracting the other and creating a secure engagement therewith. In still further embodiments, engaging structure 1202 may utilize a combination of mechanical and magnetic components to engage handset 100.

Docking station 1100 further includes a mounting element 1102 that is configured to enable docking station 1100 to be removably attached to a component. In accordance with certain use cases, the component may comprise a display component such as monitor 1200. When docking station 1100 is removably attached to monitor 1200 and handset 100 is engaged with engaging structure 1202, display 104 of handset 100 and a display of monitor 1200 will both be viewable by the same user. This advantageously enables the user to easily see images being displayed on display 104 of handset 100 without having to turn his/her head away from monitor 1200. However, this example is not intended to be limiting and docking station 1100 may be attached to a variety of different types of display components (e.g., laptop displays, televisions, or the like) or to components other than display components.

In the embodiments shown in FIGS. 11-15, handset 100 is shown as being engaged to engaging structure 1202 in such a way that display 104 is viewable in a landscape mode. It is to be understood that this presentation is exemplary only and that in accordance with different embodiments, handset 100 may be engaged to engaging structure 1202 or some other engaging structure in such a way that display 104 may be viewable in a portrait mode or some other mode.

In certain embodiments, docking station 1100 is configured to permit handset 100 to be tilted at a certain angle when engaged with engaging structure 1202 to improve a viewing experience. Such tilting may be achieved by utilizing a hinge to connect engaging structure 1202 to mounting element 1102 of docking station 1100, thereby enabling engaging structure 1202 to be adjusted to any number of suitable angles.

In the implementation shown in FIGS. 11-15, mounting element 1102 comprises a first mounting portion 1104 and a second mounting portion 1108. First mounting portion 1104 is connected to engaging structure 1202 and is configured to engage a top front edge 1204 of monitor 1200 when docking station 1100 is removably attached to monitor 1200. Second mounting portion 1108 is connected to first mounting portion 1104 and is configured to engage a rear portion 1206 of monitor 1200 when docking station 1100 is removably attached to monitor 1200.

In further accordance with this embodiment, first mounting portion 1104 is pivotally connected to second mounting portion 1108, such that a user may adjust the position of second mounting portion 1108 relative to first mounting portion 1104. This may enable a user to achieve a more secure attachment between docking station 1100 and monitor 1200. For example, a user may adjust second mounting portion 1108 so that second mounting portion 1108 is as close to rear portion 1206 of monitor 1200 as possible, thereby providing a more secure attachment between docking station 1100 and monitor 1200. In further accordance with such an embodiment, a friction hinge may be used to form the connection between first mounting portion 1104 and second mounting portion 1108. As will be appreciated by persons skilled in the relevant art(s), such a friction hinge will operate to ensure that second mounting portion 1108 remains in a fixed position relative to first mounting portion 1104 after a user has adjusted the position thereof.

In one embodiment, second mounting portion 1108 is weighted such that it acts as a counterweight to handset 100 when handset 100 is attached to engaging structure 1202 and docking station 1100 is removably attached to monitor 1200. By ensuring that second mounting portion 1108 is sufficiently heavy to act as a counterweight to handset 100, an embodiment further ensures that docking station 1100 will not pitch forward off of monitor 1200 when handset 100 is attached thereto.

In another implementation, at least one of first mounting portion 1104 and second mounting portion 1108 is biased toward the other, such as with a spring, to achieve a more secure attachment to monitor 1200.

To protect monitor 1200 from scratching or other damage, one or both of first mounting portion 1104 and second mounting portion 1108 may include a padding element. Such padding element may comprise, for example, plastic, rubber or some other suitable material. For example, as shown in FIG. 11, second mounting portion 1108 includes a padding element 1110 that is intended to minimize or avoid scratching or marking up of a back of monitor 1200 when docking station 1100 is removably attached thereto.

Although FIGS. 11-15 show an embodiment in which first mounting portion 1104 and second mounting portion 1108 are pivotally connected to each other, it is to be understood that first mounting portion 1104 and second mounting portion 1108 may be connected to each other in other in a variety of ways. For example, in one embodiment, first mounting portion 1104 and second mounting portion 1108 may each be part of a single integrated mounting element.

Docking station 1100 can increase the functionality of handset 100 in a variety of ways. In one embodiment, docking station 1100 comprises a housing that houses a camera 1106 that is capable of capturing images and transmitting such images to handset 100. Depending upon the implementation, camera 1106 may be capable of capturing still images, moving images or both. When docking station 1100 is removably attached to monitor 1200 in the manner shown in FIGS. 12-14, camera 1106 may capture images of an area in front of monitor 1200. For example, camera 1106 may capture images of a user in support of applications such as video teleconferencing, video chat, or the like. As another example, camera 1106 may capture images of a work area (e.g., a desktop work area) in front of monitor 1200. Camera 1106 may also capture images of documents or other physical objects that are positioned near monitor 1200. In certain embodiments, camera 1106 has a high enough resolution to enable capture of text or symbols on documents to enable a participant on a video teleconferencing call to view such text/symbols.

In accordance with certain embodiments, a position or field of view of camera 1106 is fixed. In accordance with other embodiments, a position or field of view of camera 1106 may be adjusted by a user. For example, docking station 1100 may include a user interface by which a user may adjust a pan, tilt and/or zoom of camera 1106 to change the position or field of view thereof. As another example, handset 100 may provide a user interface by which a user may adjust a pan, tilt and/or zoom of camera 1106 when handset 100 is engaged with docking station 1100. Such user control may be facilitated by transmitting control signals from handset 100 to docking station 1100 via a suitable communication interface.

Depending upon the implementation, any of a variety of interfaces may be used to carry data representing images captured by camera 1106 from docking station 1100 to handset 100. For example, such interfaces may include wired interfaces such as High Definition Multimedia Interface (HDMI), DisplayPort, Universal Serial Bus (USB) or the like. As a further example, such interfaces may include wireless interfaces such as Bluetooth®, WiFi (IEEE 802.11), or the like. In an embodiment in which a wired interface is used, the necessary connections between docking station 1100 and handset 100 may be formed by including metal connectors within engaging structure 1202 that are configured to interact with metal connectors of handset 100 when handset 100 is engaged therewith.

In accordance with certain embodiments, docking station 1100 may also include a suitable interface for transmitting data representing images captured by camera 106 to entities other entities than handset 100. For example, docking station 1100 may include a suitable wired or wireless network interface for transmitting data representing images captured by camera 106 to a remote entity over a network. As another example, docking station 1100 may include a suitable wired or wireless interface for transmitting data representing images captured by camera 106 to another docking station with which handset 1100 may be selectively engaged. An embodiment that supports such communication between docking stations will be described in more detail below.

Docking station 1100 can increase the functionality of handset 100 in other ways as well. For example, docking station 1100 can include structure to enable handset 100 to be charged. In particular, docking station 1100 may include an interface for transferring power to handset 1100 when handset 1100 is engaged with engaging structure 1202. The interface may include metal connectors that form part of engaging structure 1202 and are configured to interact with metal connectors of handset 100. Alternatively, the interface may utilize inductive charging to transfer power to handset 1100 such that no metal connectors are required. In an embodiment in which a metal connection is used, a metal connecting element of may be in the form of a logo and can be positioned on engaging structure 800. The metal element may be part of a charging circuit for docking station 1100, and it can be designed to engage exposed charging contacts of handset 100. Power supplied by docking station 1100 to handset 100 may be sourced from a Power over Ethernet (POE) connection or via a connection to an AC power source such as a utility, or one or more batteries. Docking station 1100 may include a voltage converter for performing the power supply function.

FIGS. 21 and 22 depict another example of a docking station 2002 with which a mobile electronic device can be selectively engaged and disengaged, wherein the docking station is configured to be removably attached to a component. In FIG. 21, a mobile electronic device in the form of handset 2004 is engaged to docking station 2002. In FIGS. 21 and 22, docking station 2002 is removably attached to a component in the form of display 2006. Docking station 2002 may provide any of the features and functionality described above in reference to docking station 1100.

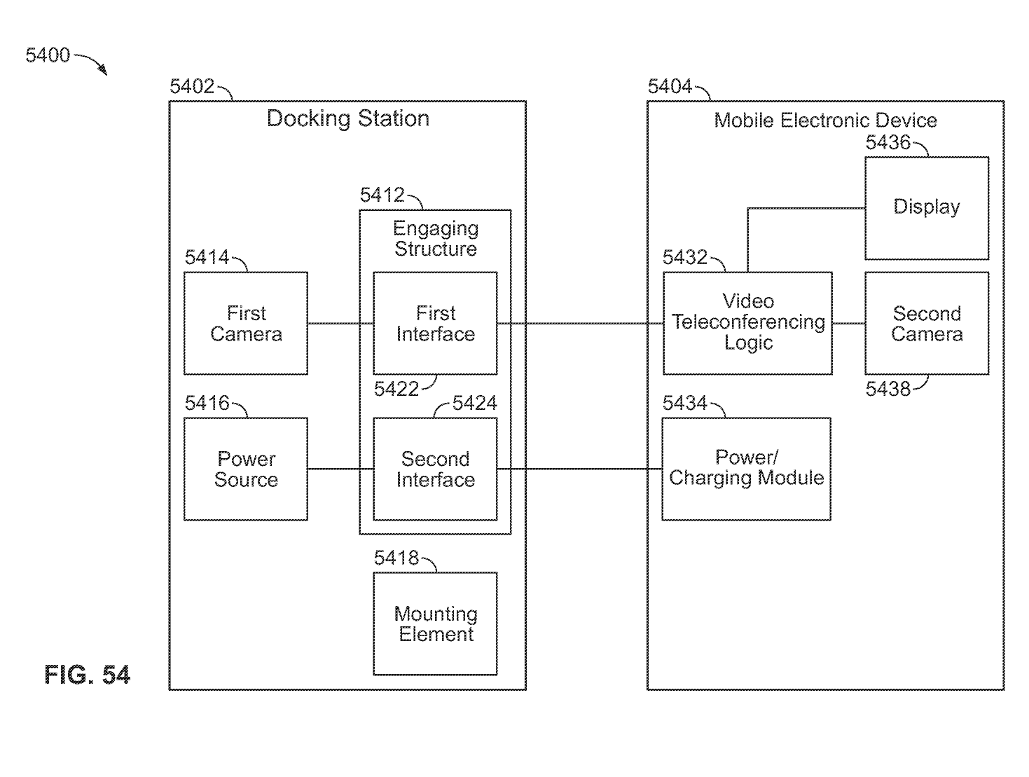

FIG. 54 is a block diagram of a system 5400 in accordance with an embodiment in which a camera of a docking station can be used to extend video teleconferencing abilities of a mobile electronic device. As shown in FIG. 54, system 5400 includes a docking station 5402 and a mobile electronic device 5404. In accordance with one implementation, docking station 5402 may comprise one implementation of docking station 1100 as previously described in reference to FIGS. 11-15 or docking station 2002 as previously described in reference to FIGS. 21 and 22. Furthermore, mobile electronic device 5404 may comprise one implementation of handset 100 as described above in reference to at least FIGS. 1-6 or handset 2004 as described above in reference to FIGS. 21 and 22. However, these examples are not intended to be limiting, and docking station 5402 and mobile electronic device 5404 may respectively represent any of a variety of docking stations and mobile electronic devices.

As further shown in FIG. 54, docking station 5402 includes an engaging structure 5412, a first camera 5414, a power source 5416, and a mounting element 5418 while mobile electronic device 5404 includes video teleconferencing logic 5432, a power/charging module 5434, a display 5436 and a second camera 5438. Each of these elements will now be described.

Engaging structure 5412 comprises a structure with which mobile electronic device 5404 can be selectively engaged and disengaged. Engaging structure 5412 is configured to physically support mobile electronic device 5404 when mobile electronic device 5404 is engaged therewith. The manner in which engaging structure 5412 engages mobile electronic device 5404 may vary depending upon the implementation and may include mechanical and/or magnetic engagement mechanisms such as those described above in reference to engaging structure 1202 shown in FIGS. 12, 14 and 15.

Engaging structure 5412 includes at least a first interface 5422 and a second interface 5424. First interface 5422 is configured to facilitate a physical connection between first camera 5414 of docking station 5402 and video teleconferencing logic 5432 of mobile electronic device 5404 when mobile electronic device 5404 is engaged with engaging structure 5412. Second interface 5424 is configured to facilitate a physical connection between power source 5416 of docking station 5402 and power/charging module 5434 of mobile electronic device 5404 when mobile electronic device 5404 is engaged with engaging structure 5412. Such interfaces may comprise, for example, metal connectors within engaging structure 5412 that are configured to interact with metal connectors of mobile electronic device 5404 when mobile electronic device 5404 is engaged with engaging structure 5412. Still other types of connections may be used.

Mounting element 5418 is an element that is configured to enable docking station 5402 to be removably attached to a component. Mounting element 5418 may be implemented in a manner consistent with mounting element 1102 as described above in reference to at least FIGS. 14 and 15, or in some other manner. In accordance with certain use cases, mounting element 5418 may be used to removably attach docking station 5402 to a display component such as a monitor, laptop display, television or the like, although these examples are not intended to be limiting. When docking station 5402 is removably attached to such a display component and mobile electronic device is engaged with engaging structure 5412, display 5436 of mobile electronic device 5404 and a display of the display component may both be viewable by the same user. This advantageously enables the user to easily see images being displayed on display 5436 of mobile electronic device 5404 without having to turn his/her head away from the display of the display component. It is noted that mounting element 5418 may be used to removably attach docking station 5402 to components other than display components.

First camera 5414 of docking station 5402 is capable of capturing images. Depending upon the implementation, first camera 5414 may be capable of capturing still images, moving images or both. Data representing such images may be transmitted from first camera 5414 to video teleconferencing logic 5432 via first interface 5422 when mobile electronic device 5404 is engaged with engaging structure 5412. When docking station 5402 is removably attached to a component, first camera 5414 may capture images of an area in front of the component. For example, first camera 5414 may capture images of a user. As another example, first camera 5414 may capture images of a work area (e.g., a desktop work area) in front of the component. First camera 5414 may also capture images of documents or other physical objects that are positioned near the component. In certain embodiments, first camera 5414 has a high enough resolution to enable capture of text or symbols on documents to enable a participant on a video teleconferencing call to view such text/symbols.

In accordance with certain embodiments, a position or field of view of first camera 5414 is fixed. In accordance with other embodiments, a position or field of view of first camera 5414 may be adjusted by a user. For example, docking station 5402 may include a user interface by which a user may adjust a pan, tilt and/or zoom of first camera 5414 to change the position or field of view thereof. As another example, mobile electronic device 5404 may provide a user interface by which a user may adjust a pan, tilt and/or zoom of first camera 5414 when mobile electronic device 5404 is engaged with docking station 5402. Such user control may be facilitated by transmitting control signals from mobile electronic device 5404 to docking station 5402 via a suitable interface. Such interface may comprise part of engaging structure 5412, for example.

Video teleconferencing logic 5432 is intended to represent logic within mobile electronic device 5404 that is capable of initiating and conducting a video teleconference with a remote video teleconferencing system or device. In accordance with various implementations, video teleconferencing logic 5432 may be implemented in software, through the execution of instructions by one or more general purpose or special-purpose processors, in hardware using analog and/or digital circuits, or as a combination of hardware and software.

When mobile electronic device 5404 is engaged with engaging structure 5412 of docking station 5402, video teleconferencing logic 5432 can conduct a video teleconference, in part, by receiving images captured by first camera 5414 via first interface 5422 and transmitting such images to the remote video teleconferencing system or device. Thus, for example, still or moving images of a user or of documents or other items located near a component upon which docking station 5402 is mounted may be captured by first camera 5414 and provided to video teleconferencing logic 5432 via first interface 5422. Video teleconferencing logic 5432 may then transmit such images to a remote video teleconferencing system or device as part of conducting a video teleconference. Such transmission may occur via a suitable interface of mobile electronic device 5404 (not shown in FIG. 54), such as a wired or wireless network interface. Video teleconferencing logic 5432 is also capable of receiving images from a remote video teleconferencing system or device and displaying such images via display 5436.

Video teleconferencing logic 5432 may optionally process images received from first camera 5414 prior to transmitting such images to the remote video teleconferencing system or device. For example, where the images are of documents in a workspace in front of a component, such as a monitor, the image may need to be inverted so that the documents will be readable to remote viewers of the image. Other image processing techniques for improving, optimizing or otherwise modifying the images may also be used. Furthermore, compression may be applied to the images to conserve bandwidth of the communication medium over which the images will be transmitted. Depending upon the implementation, such image processing functions may also be performed by an image processing component within docking station 5402.

As further shown in FIG. 54, mobile electronic device 5404 also includes second camera 5438 that is connected to video teleconferencing logic 5432. Like first camera 5414, second camera 5438 may be capable of capturing still images, moving images or both, and providing data representing such images to video teleconferencing logic 5432 for use in conducting a video teleconference. Furthermore, like first camera 5414, second camera 5438 may have a fixed position or field of view of may have a position or field of view that is adjustable by a user.

When mobile electronic device 5404 is engaged with docking station 5402, images may be provided to video teleconferencing logic 5432 from both first camera 5414 and second camera 5436, thereby enabling system 5400 to provide enhanced video teleconferencing capabilities. For example and without limitation, during a video teleconference, second camera 5438 may be used to capture images of a user participating in the video teleconference while first camera 5414 may be used to capture images of documents or other items in a workspace in front of the user, or vice versa, and images from both cameras may be transmitted to a remote video teleconferencing system or device for display thereon. As another example, during a video teleconference, second camera 5438 may be used to capture images of a first user participating in the video teleconference while first camera 5414 may be used to capture images of a second user participating in the video teleconference, or vice versa, and images from both cameras may be transmitted to a remote video teleconferencing system or device for display thereon. Still other useful configurations and uses may be achieved. In accordance with further embodiments, additional cameras may be included in docking station 5402 and/or in mobile electronic device 5404 beyond those shown in FIG. 54 to enable further camera views to be transmitted as part of conducting a video teleconference.

With continued reference to FIG. 54, power source 5416 of docking station 5402 is intended to represent a source of power that may be internal to docking station 5402, such as one or more batteries, or a source of power that may be external to docking station 5402 and connected thereto, such as a POE source or an AC power source such as a utility. Power provided by power source 5416 may be provided to power/charging module 5434 of mobile electronic device 5404 via second interface 5424 when mobile electronic device 5404 is engaged with engaging structure 5412. Such power may be used by power/charging module 5434 to power one or more active components of mobile electronic device 5404 while mobile electronic device 5404 is engaged with docking station 5402. Additionally or alternatively, such power may be used by power/recharging module 5434 to charge or recharge one or more batteries or other rechargeable power sources of mobile electronic device 5404.

Although FIG. 54 shows that images from first camera 5414 and power from power source 5416 are transferred from docking station 5402 to mobile electronic device 5404 via interfaces that are part of engaging structure 5412, in alternate embodiments, interfaces that are not part of engaging structure 5412 may be used. For example, any of a variety of wired or wireless interfaces that are not part of engaging structure 5412 may be used to transfer image information and/or power from docking station 5402 to mobile electronic device 5404.

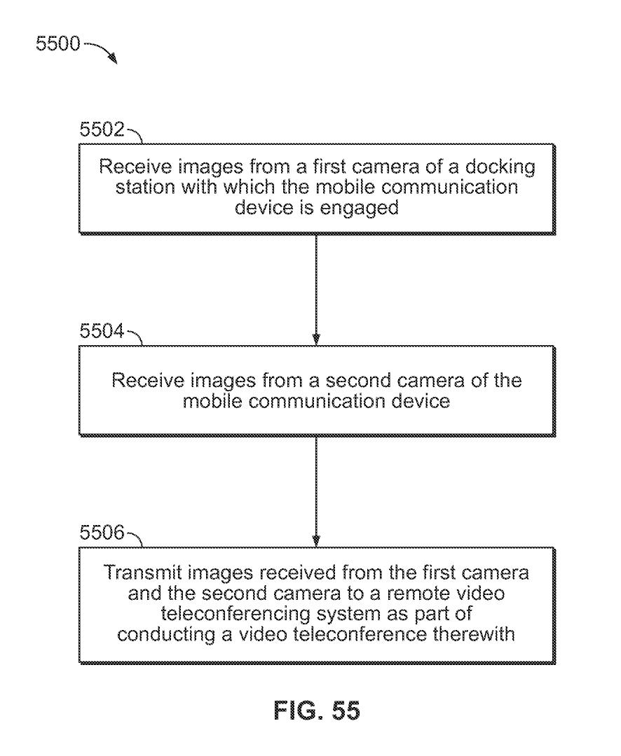

FIG. 55 depicts a flowchart 5500 of a method for conducting a video teleconference in accordance with an embodiment. The method of flowchart 5500 may be carried out by video teleconferencing logic of a mobile electronic device when the mobile electronic device is engaged with a docking station. For example, with continued reference to system 5400 of FIG. 54, the method of flowchart 5500 may be carried out by video teleconferencing logic 5432 of mobile electronic device 5404 when mobile electronic device is engaged with engaging structure 5412 of docking station 5412. However, the method is not limited to that implementation and may be carried out by other components, devices or systems.

As shown in FIG. 55, the method of flowchart 5500 begins at step 5502 in which video teleconferencing logic of a mobile electronic device receives images from a first camera of a docking station with which the mobile electronic device is engaged. For example, with continued reference to system 5400 of FIG. 54, this step may be performed when video teleconferencing logic 5432 of mobile electronic device 5404 receives images from first camera 5414 of docking station 5402 when mobile electronic device 5404 is engaged with engaging structure 5412 of docking station 5402.

At step 5504, the video teleconferencing logic receives images from a second camera of the mobile communication device. For example, with continued reference to system 5400 of FIG. 54, this step may be performed when video teleconferencing logic 5432 of mobile electronic device 5404 receives images from second camera 5438 of mobile electronic device 5404. Step 5504 may occur concurrently with or at a different time than step 5502.

At step 5506, the video teleconferencing logic transmits the images received from the first camera and the second camera to a remote video teleconferencing system or device as part of conducting a video teleconference with the remote video teleconferencing system or device. For example, with continued reference to system 5400 of FIG. 54, this step may be performed when video teleconferencing system 5432 of mobile electronic device 5404 transmits images received from first camera 5414 and second camera 5438 to a remote video teleconferencing system or device as part of conducting a video teleconference with the remote video teleconferencing system or device.

Since the video teleconferencing logic can transmit images received from the first and second camera as reflected by step 5506, the method of flowchart 5500 can enable enhanced video teleconferencing capabilities. For example and without limitation, during a video teleconference, the second camera may be used to capture images of a user participating in the video teleconference while the first camera may be used to capture images of documents or other items in a workspace in front of the user, or vice versa, and images from both cameras may be transmitted to a remote video teleconferencing system or device for display thereon. As another example, during a video teleconference, the second camera may be used to capture images of a first user participating in the video teleconference while the first camera may be used to capture images of a second user participating in the video teleconference, or vice versa, and images from both cameras may be transmitted to a remote video teleconferencing system or device for display thereon. Still other useful configurations and uses may be achieved.

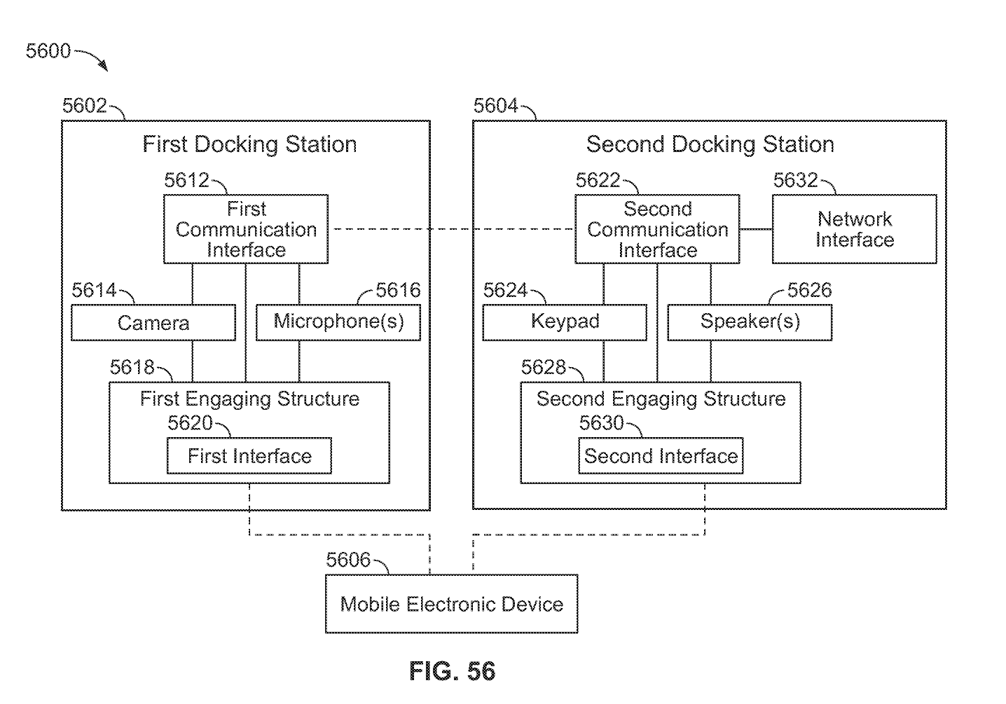

In accordance with certain implementations, various ones of the docking stations previously described herein can be configured to connect with one another so that the services or features offered by one docking station can be offered by one or more other docking stations. To help illustrate this, FIG. 56 depicts a block diagram of a system 5600 that includes a first docking station 5602, a second docking station 5604, and a mobile electronic device 5606 that can be selectively engaged with either first docking station 5602 or second docking station 5604, wherein first docking station 5602 and second docking station 5604 are also communicatively connected to each other.

As shown in FIG. 56, first docking station 5602 includes a first engaging structure 5618 with which mobile electronic device 5606 can be selectively engaged and disengaged, a camera 5614, one or more microphones 5616, and a first communication interface 5612. When mobile communication device 5606 is engaged with first engaging structure 5618, one or more components executing on mobile electronic device 5606 can receive images captured by camera 5614 and audio content captured by microphone(s) 5616 via a first interface 5620 which comprises part of first engaging structure 5618. It is noted that in alternate implementations, first interface 5620 is separate from first engaging structure 5618. In one embodiment, first docking station 5602 comprises a docking station configured to be mounted on a component, such as docking station 1100 as described above in reference to FIGS. 11-15 or docking station 2002 as described above in reference to FIGS. 20-22.

As further shown in FIG. 56, second docking station 5602 includes a second engaging structure 5628 with which mobile electronic device 5606 can be selectively engaged and disengaged, a keypad 5624, one or more speakers 5626, a second communication interface 5622, and a network interface 5632. When mobile electronic device 5606 is engaged with second engaging structure 5628, one or more components executing on mobile electronic device 5606 can receive keypad input from keypad 5624 via a second interface 5630 which comprises part of second engaging structure 5628. Furthermore, when mobile electronic device 5606 is engaged with second engaging structure 5628, one or more components executing on mobile electronic device 5606 can play audio content via speaker(s) 5626 by transmitting such audio content to speaker(s) 5626 via second interface 5630. Still further, when mobile electronic device 5606 is engaged with second engaging structure 5628, one or more components executing on mobile electronic device 5606 can transmit or receive information over a wired or wireless network connected to network interface 5632 by sending or receiving network data to or from network interface 5632 via second interface 5630. It is noted that in alternate implementations, second interface 5630 is separate from first engaging structure 5618. In one embodiment, second docking station 5602 comprises a docking station such as docking station 700 described above in reference to at least FIGS. 7-10 or docking stations 1602 and 1606 as described above in reference to FIG. 16.

First communication interface 5612 of first docking station 5602 may communicate with second communication interface 5622 of second docking station 5604 to allow information to be transferred between docking stations. Such communication may be carried out over any suitable wired or wireless communication medium. This can enable mobile electronic device 5606 to obtain the benefits of features and functionality offered by second docking station 5604 when mobile electronic device 5606 is engaged with first docking station 5602. Conversely, this can also enable mobile electronic device 5606 to obtain the benefits of features and functionality offered by first docking station 5602 when mobile electronic device 5606 is engaged with second docking station 5604.

For example, when mobile electronic device 5606 is engaged with first docking station 5602, keypad 5624 of second docking station 5604 may still be operable to receive keypad input from a user. Information representing such keypad input may be transmitted from second communication interface 5622 of second docking station 5604 to first communication interface 5612 of first docking station 5602 and then from first communication interface 5612 to mobile electronic device 5606 via first interface 5620. In this way, a user can use keypad 5624 of second docking station 5604 to interact with mobile electronic device 5606 even when mobile electronic device 5606 is engaged with first docking station 5602.

As another example, when mobile electronic device 5606 is engaged with first docking station 5602, speaker(s) 5626 of second docking station 5604 may still be operable to play audio content. Information representing such audio content may be transferred from mobile electronic device 5606 to first communication interface 5612 of first docking station 5602 via first interface 5620 and then from first communication interface 5612 to second communication interface of second docking interface 5604. Speaker(s) 5626 of second docking station 5604 may then obtain the audio content from second communication interface 5622 and play it. In this way, components executing on mobile electronic device 5606 can play audio content via speaker(s) 5626 of second docking station 5604 even when mobile electronic device 5606 is engaged with first docking station 5602.

As a further example, when mobile electronic device 5606 is engaged with first docking station 5602, network interface 5632 of second docking station 5604 may still be operable to send and receive information over a network. In this case, the communication path between first communication interface 5612 of first docking station 5602 and second communication interface 5622 of second docking station 5604 can be used to provide a link by which mobile electronic device 5606 can send and receive information over the network to which network interface 5632 provides access.

Another example will now be provided. When mobile electronic device 5606 is engaged with second docking station 5604, camera 5614 of first docking station 5602 may still be operable to capture images. These images may be transmitted from first communication interface 5612 of first docking station 5602 to second communication interface 5622 of second docking station 5604. Once the images have been received by second docking station 5604, they can be transferred to mobile electronic device 5606 via second interface 5630 for viewing thereon or for some other use thereby. For example, video teleconferencing logic executing on mobile electronic device 5606 may cause such images to be transmitted to a remote video teleconferencing system or device via network interface 5632 or some other interface. In a further embodiment, second docking station 5604 may cause the images received by second communication interface 5622 to be transferred directly to a remote entity via network interface 5632. In this way, a user and/or mobile electronic device 5606 can make use of camera 5614 on first docking station 5602 even when mobile electronic device 5606 is engaged with second docking station 5604.

A still further example will now be provided. When mobile electronic device 5606 is engaged with second docking station 5602, microphone(s) 5616 of first docking station 5602 may still be operable to capture audio content. This audio content may be transmitted from first communication interface 5612 of first docking station 5602 to second communication interface 5622 of second docking station 5604. Once the audio content has been received by second docking station 5604, it can be transferred to mobile electronic device 5606 via second interface 5630 for playback thereon or for some other use thereby. Additionally or alternatively, the audio content can be played by speaker(s) 5626. Still further, second docking station 5604 may cause the audio content received by second communication interface 5622 to be transferred directly to a remote entity via network interface 5632. In this way, a user and/or mobile electronic device 5606 can make use of microphone(s) 5616 on first docking station 5602 even when mobile electronic device 5606 is engaged with second docking station 5604.

Although system 5600 only shows two docking stations 5602 and 5604 that share a communication link, persons skilled in the relevant art(s) will readily appreciate that any number of docking stations may be configured to communicate with each other in accordance with various embodiments. The communication links connecting such docking stations may be shared links, peer-to-peer links, or the like. Thus, information obtained by a single docking station may be selectively transferred or broadcast to any number of other docking stations. Furthermore, although system 5600 was described as including only certain types of docking stations, it is to be understood that any of the docking station types described herein may be communicatively connected together.

### D. Mobile Electronic Device that Supports Multiple Profiles

As discussed above in reference to FIG. 26, an example handset 2600 in accordance with an embodiment can provide support for multiple profiles per user thereof. These profiles can be in the form of, for example, managed (e.g., enterprise) and unmanaged (e.g., residential) settings or personalities.

Example scenarios in which a mobile electronic device that supports multiple profiles may be useful will now be described. These example scenarios are provided herein by way of illustration only and are not intended to be limiting. As a first example, an enterprise may provide an employee with a mobile electronic device that is configured to execute enterprise-provided applications and access enterprise-provided data. By providing the mobile electronic device with support for multiple profiles in accordance with the teachings provided herein, the employee can establish a “home” profile on the device that is distinct from a “work” profile that provides access to the enterprise-provided applications and data. The “home” profile provides a mode of operation in which the employee can execute non-work-related applications and access non-work-related data in a manner that will not interfere with or compromise the enterprise-provided data and applications. Thus, the employee is provided with the benefit of having a mobile electronic device that can be used for both work and home, without compromising the integrity of the enterprise's applications or data.

In accordance with another example scenario, an employee may purchase a mobile electronic device for personal use and then decide (or be required by an enterprise) to also use that device to execute work-related applications and access work-related data. In accordance with embodiments described herein, the employee can establish a “work” profile on the mobile electronic device that is distinct from a “home” profile. While the mobile electronic device is operating in a mode associated with the “work” profile, work-related applications can be executed and work-related data can be accessed in a secure manner. While the mobile electronic device is operating in a mode associated with the “home” profile, non-work-related applications can be executed and non-work related data can be accessed in a manner that will not interfere with or compromise the enterprise-provided data and applications. Thus, the employee can use her personal mobile electronic device for work instead of having to be issued a device by her employer. The employee may prefer this arrangement, for example, if she would rather use her mobile electronic device than a device issued by her employer. The employer may also prefer this arrangement to conserve costs.

Although only “home” and “work” profiles are described in the foregoing examples, it will be understood by persons skilled in the relevant art(s) based on the teachings provided herein that any number of different profile types may be supported by a single mobile electronic device. Moreover, a single mobile electronic device may support multiple users, and each user supported by the device may have any number of distinct profiles associated therewith.

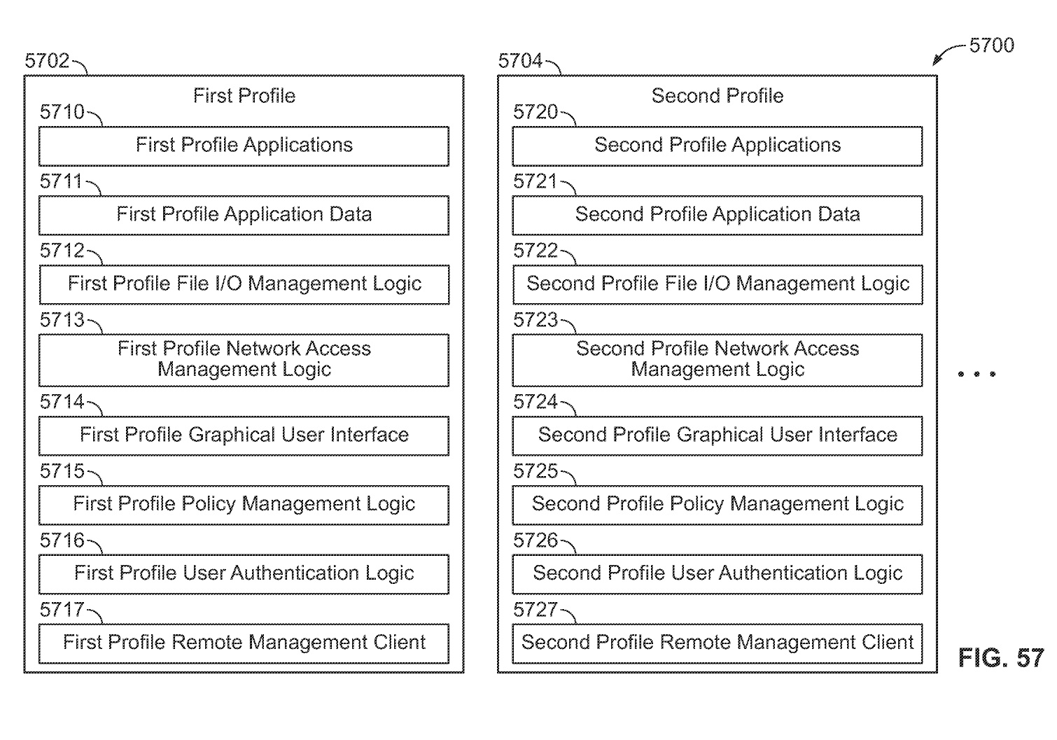

FIG. 57 is a block diagram of a set of profiles 5700 that may be supported by a single mobile electronic device in accordance with an embodiment. As shown in FIG. 57, set of profiles 5700 may include at least a first profile 5702 and a second profile 5704, although more profiles may be supported depending upon the implementation. As will be further described herein, each profile may be characterized by any of a number of profile-specific features, attributes or settings.

For example, each profile may have its own set of applications. Thus, as shown in FIG. 57, first profile 5702 includes first profile applications 5710 and second profile 5704 includes second profile applications 5720. For example, in an embodiment in which first profile 5702 comprises a “home” profile and second profile 5704 comprises a “work” profile, first profile applications 5710 may comprise applications that have been obtained by a user and are useful to the user in a home or personal context while second profile applications 5720 may comprise applications that are provided by an enterprise and are useful to the user for performing work-related functions.

In accordance with certain embodiments, first profile applications 5710 and second profile applications 5720 may each include different instances of the same application. Thus, with continued reference to the embodiment in which first profile 5702 comprises a “home” profile and second profile 5704 comprises a “work” profile, first profile applications 5710 may include a first instance of an e-mail application that a user uses for sending, receiving and managing personal e-mails and second profile applications 5720 may include a second instance of the same e-mail application that the user uses for sending, receiving and managing work-related e-mails. In a like manner, first profile applications 5710 may include a first instance of any of a calendar application, a contacts application, a notes application, a tasks application, an Internet browser, or the like, and second profile applications 5720 may include a second instance of such application.

Each profile may also have its own application data, which may comprise data received, output, processed, or managed by the applications associated with that profile. Thus, as shown in FIG. 57, first profile 5702 includes first profile application data 5711 which is data associated with first profile applications 5710 and second profile 5704 includes second profile application data 5721 which is data associated with second profile applications 5720.

In certain embodiments, application data associated with one profile may be stored in a different area within a local memory of the mobile electronic device than the application data associated with another profile. Such separation of application data may help to ensure that application data associated with one profile is not accessed or modified by applications associated with another profile. Storing application data associated with different profiles in different areas within local memory may comprise storing such data in different directories within the same file system, or storing such data in different file systems entirely, wherein such different file systems may be real and/or virtual filing systems. Still other approaches may be used to store application data associated with different profiles in different areas of local memory.

Furthermore, in certain embodiments, application data associated with one profile may be stored in an unencrypted format while application data associated with another profile may be stored in an encrypted format. Thus, for example, with continued reference to the embodiment in which first profile 5702 comprises a “home” profile and second profile 5704 comprises a “work” profile, first profile application data 5711 may be stored in an unencrypted format while second profile application data 5721 may be stored in an encrypted format. By ensuring that the application data associated with the “work” profile is stored in an encrypted format, an embodiment can ensure that enterprise-related data remains secure even when it is stored locally on the user's mobile electronic device. For example, encryption of the application data may serve to protect such data from rogue applications and other malware. In accordance with one embodiment, for an extra level of security, a different encryption key may be used storing data associated with each application associated with the “work” profile, such that no application will be capable of decrypting the application data associated with another application.

It is noted that, in certain embodiments, data sharing may be allowed between the applications associated with the same profile, but prohibited between applications associated with different profiles.

Each profile may have different file I/O management logic associated therewith. Thus, as shown in FIG. 57, first profile 5702 may include first profile file I/O management logic 5712 and second profile 5704 may include second profile file I/O management logic 5722. The file I/O management logic associated with a particular profile may be provided by a mobile operating system (OS) or may be provided outside of the mobile OS. The file I/O management logic associated with a particular profile may control where application data associated with that profile is stored and may also control whether that data is stored in an encrypted or unencrypted format as discussed above. It is possible that file I/O management logic may also be included in or otherwise uniquely associated with one or more applications within a given profile.

Each profile may have different network access management logic associated therewith. Thus, as shown in FIG. 57, first profile 5702 may include first profile network access management logic 5713 and second profile 5704 may include second profile network access management logic 5723. The network access management logic associated with a particular profile may be provided by a mobile OS or may be provided outside of the mobile OS. The network access management logic associated with a particular profile may control how requests to open a network connection are handled when such requests are issued by an application or other entity associated with the profile. Thus, for example, the network access management logic may be configured to establish connections to a public network or may be configured to establish connections to a private network or a virtual private network (VPN). The VPN may require user authentication and secure data with encryption technology to prevent disclosure of private information to unauthorized parties. The network access management logic may further prohibit access to certain networks when the mobile electronic device or a user thereof is in a certain environment.

For example, with continued reference to the embodiment in which first profile 5702 comprises a “home” profile and second profile 5704 comprises a “work” profile, first profile network access management logic 5713 may allow first profile applications 5710 to establish network connections over one or more public or private networks whereas second profile network access management logic 5723 may only allow second profile applications 5720 to establish network connections over a particular VPN or may place some other restrictions on which networks can be accessed and/or in what environments certain networks can be accessed. These restrictions may help to secure enterprise-related data that is transmitted over a network.

Each profile may also have a different graphical user interface (GUI) associated therewith. Thus, as shown in FIG. 57, first profile 5702 may include a first profile GUI 5714 and second profile 5704 may include a second profile GUI 5724 that is different than first profile GUI 5714. Each GUI associated with a profile may have a different appearance and/or provide different features and functionality than a GUI associated with another profile. Thus, for example, first profile GUI 5714 and second profile GUI 5724 may each provide a different wallpaper, screensaver, application representation, toolbar appearance, or the like, than the other. Moreover, first profile GUI 5714 and second profile GUI 5724 may each provide different GUI components by which a user can interact with the mobile electronic device.

Each profile may have different policy management logic associated therewith. Thus, as shown in FIG. 57, first profile 5702 may include first profile policy management logic 5715 and second profile 5704 may include second profile policy management logic 5725. The policy management logic may comprise logic that enforces enterprise-related policies with respect to activities and/or interactions carried out on a mobile electronic device. Some profiles may have no policy management logic associated therewith. Thus, for example, with continued reference to an embodiment in which first profile 5702 comprises a “home” profile and second profile 5704 comprises a “work” profile, the “home” profile may actually have no policy management logic associated therewith since home-related usage of the mobile electronic device need not comply with enterprise policies while the “work” profile may have policy management logic associated therewith to ensure that work-related usage of the mobile electronic device does comply with enterprise policies.

The policy management logic may perform functions such as enforcing an installation or execution policy with respect to an application. By way of example, the policy management logic may operate to validate an application license prior to allowing an application to be installed or executed. Various licensing models may be supported, such as floating licenses (e.g., licenses where a server must be contacted to obtain permission to execute an application because only a predetermined number of people can execute the application at any one time), time-limited licenses, or the like. The policy management logic may operate to restrict application installation or execution in various other ways as well. For example, for compliance reasons, an enterprise may wish to restrict access to applications that in turn access certain data outside of a company premises. Thus, the policy management logic may operate to prevent certain applications from being run when the user of a mobile electronic device is determined to be outside of the company premises or some other predefined area(s). In addition to enforcing policies that geographically restrict an application, the policy management logic may also restrict application execution based on the identity of a network to which the mobile electronic device is currently connected (e.g., in the case of a Wireless LAN, this may be determined by a Service Set Identifier (SSID)), such that the application can only be executed when the mobile electronic device is connected to an approved network. As another example, the policy management logic may restrict application execution based on time of day restrictions (e.g., an application may be executed only from 10 A.M. to 4 P.M.). The policy management logic may also explicitly allow or prohibit the installation or execution of certain applications.

The policy management logic may also control access at the workspace/account level. For example, the policy management logic may determine whether a particular virtual workspace is allowed to run based on various policy criteria. Restrictions may include account suspension, account disablement, geolocation constraints, time constraints or network connectivity constraints.

The policy management logic may also perform operations to determine if an application is valid prior to allowing the application to be installed. For example, in an embodiment, the policy management logic may operate to validate a digital signature associated with an application or application package downloaded from a remote entity. As used herein, the term application package refers to a set of files or other resources that may be downloaded from a remote entity and that are used to install an application on a mobile device. If the digital signature associated with the application or application package is valid, then the application may be installed. Still other restrictions relating to application installation may be applied.

The policy management logic may operate to enforce one or more policies that are defined by an enterprise or an agent thereof (e.g., an information technology (IT) administrator of an enterprise) and that are accessed or obtained from a remote entity via a network. Policies obtained from such a remote entity may optionally be stored in local memory of the mobile electronic device.

Each profile may have different user authentication logic associated therewith. Thus, as shown in FIG. 57, first profile 5702 may include first profile user authentication logic 5716 and second profile 5704 may include second profile user authentication logic 5726. User authentication logic may comprise logic that carries out an authentication process with respect to a user before providing access to one or more resources associated with a profile (e.g., the applications associated with the profile). The user authentication logic may carry out any of a variety of well-known user authentication processes, including password or PIN based authentication processes, biometric-based authentication processes such as fingerprint scanning, multi-factor authentication processes, or the like. Some profiles may have no user authentication logic associated therewith. Thus, for example, with continued reference to an embodiment in which first profile 5702 comprises a “home” profile and second profile 5704 comprises a “work” profile, the “home” profile may actually have no user authentication logic associated therewith since restricting access to home-related applications and data may not be a significant concern. In contrast, second profile 5704 may have user authentication logic associated therewith since restricting access to enterprise-related application and data may be a significant concern. As another example, a “home” profile may have a less stringent user authentication process than a “work” profile. In accordance with further embodiments, for extra security, certain applications within a profile may also have a user authentication process uniquely associated therewith.

Each profile may have a different remote management client associated therewith. Thus, as shown in FIG. 57, first profile 5702 may include a first profile remote management client 5717 and second profile 5704 may include a second profile remote management client 5727. A remote profile management client may comprise a computer program or other logic that executes on the mobile electronic device and that is configured to enable a remote entity to manage applications and other features or functionality that are associated with a particular profile. For example, when the mobile electronic device is operating in a mode associated with first profile 5702, first profile remote management client 5717 may operate to enable a first remote server to manage first profile applications 5710, first profile application data 5711, or other profile-specific features and functionality associated with first profile 5702. Likewise, when the mobile electronic device is operating in a mode associated with second profile 5704, second profile remote management client 5727 may operate to enable a second remote server to manage second profile applications 5720, second profile application data 5721, or other profile-specific features and functionality associated with second profile 5704. Thus, in accordance with certain embodiments, each profile on the mobile electronic device may be managed by a different remote entity or enterprise. In accordance with other embodiments, one profile may be unmanaged and not have any remote management client associated therewith, whereas another profile may be managed and have a remote management client associated therewith.

A remote management client may enable a remote server to perform any of a wide variety of management operations with respect to applications or other features or functionality associated with a profile. For example, a remote management client may enable a remote server to download and/or install an application or an application update, uninstall an application, add, modify or delete application data, notify an application of an event, or perform a variety of other operations with respect to an application or application data. The remote management client may also enable a remote server to transmit policies, such as one or more enterprise policies, that are to be enforced by policy management logic associated with the profile. The remote management client may further enable a remote server to monitor usage of applications associated with a particular profile.

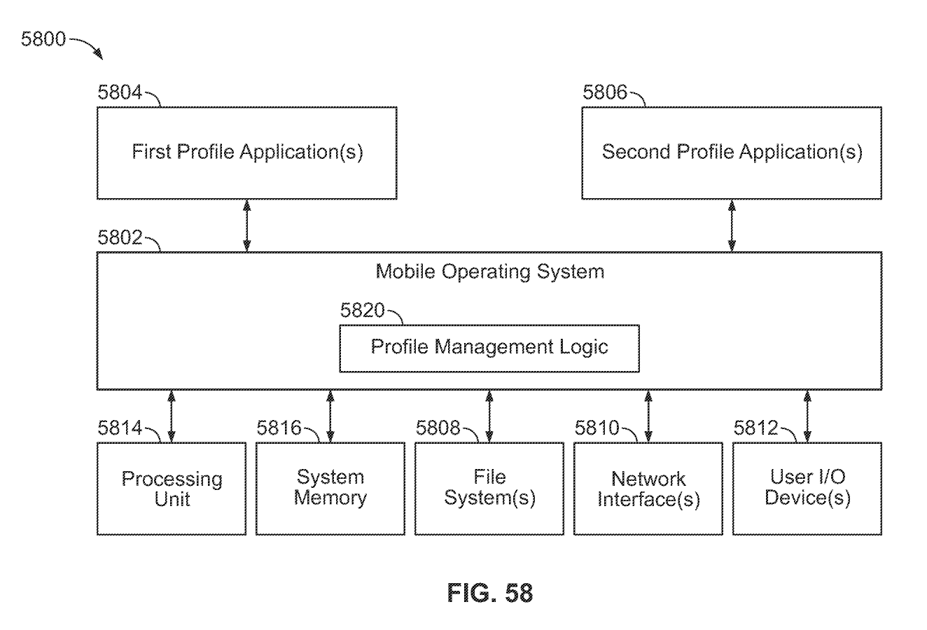

Various approaches may be used to provide support for multiple profiles on a single mobile electronic device. For example, a mobile OS can be developed and/or modified to provide multi-profile support. By way of example, FIG. 58 depicts an example architecture 5800 of a mobile electronic device that includes a mobile OS 5802 configured to provide support for multiple profiles. It is noted that the logic necessary for providing multi-profile support can be implemented in the mobile OS kernel and/or in supporting software, such as through the creation of multiple distinct application directories or registries that can be swapped between based on the selected profile.

As shown in FIG. 58, mobile OS 5802 provides a platform upon which one or more first profile applications 5804 associated with a first profile and one or more second profile applications 5806 associated with a second profile may be executed. For example, mobile OS 5802 may enable a user to execute any of first profile application(s) 5804 or any of second profile application(s) 5806. Furthermore, mobile OS 5802 may operate to service resource requests generated during execution of such applications, such as requests to store or retrieve data from a file system 5808 of the mobile electronic device, to send or receive data via one or more network interfaces 5810 of the mobile electronic device, or to output or obtain information via one or more user input/output devices 5812. As further shown in FIG. 58, architecture 5800 includes a processing unit 5814 and system memory 5816. Processing unit 5814 is configured to execute software instructions that are loaded into system memory 5816. As will be appreciated by persons skilled in the relevant art(s), mobile OS 5802, first profile application(s) 5804 and second profile application(s) 5806 may be stored by file system(s) 5808 and loaded into system memory 5816 for execution by processing unit 5814.

As further shown in FIG. 58, mobile OS 5802 includes profile management logic 5820. Profile management logic 5820 enables mobile OS 5802 to operate in a first profile mode in which only first profile application(s) 5804 are made accessible to a user or in a second profile mode in which only second profile application(s) 5806 are made accessible to the user. Processing unit 5814 is configured to execute any of first profile application(s) 5804 responsive to user selection thereof when mobile OS 5802 is operating in the first profile mode and to execute any of second profile application(s) 5806 responsive to user selection thereof when mobile OS 5802 is operating in the second profile mode.

Although FIG. 58 shows only first profile application(s) 5804 and second profile application(s) 5806 that are made accessible to a user when mobile OS 5802 is operating in the first and second profile modes, respectively, it is to be understood that architecture 5800 may support any number of different profile applications that may be made accessible to a user when mobile OS 5802 is operating in a corresponding profile mode. For example, architecture 5800 may further include one or more third profile applications associated with a third profile and profile management logic 5820 may enable mobile OS 5802 to operate in a third profile mode in which only the third profile application(s) are made accessible to the user. Processing unit 5814 may be configured to execute any of the third profile application(s) responsive to user selection thereof when mobile OS 5802 is operating in the third profile mode.

Profile management logic 5820 may further enable mobile OS 5802 to store data associated with first profile application(s) 5804 in a first area of memory of the mobile electronic device and to store data associated with second profile application(s) 5806 in a second area of memory of the mobile electronic device. Storing application data associated with the different profile applications in different areas within the local memory may comprise storing such data in different directories within the same file system, or storing such data in different file systems entirely, wherein such different file systems may be real and/or virtual filing systems. Still other approaches may be used to store application data associated with different profiles in different areas of local memory.

Profile management logic 5820 may also enable mobile OS 5802 to store data associated with first profile application(s) 5804 in an unencrypted format and to store data associated with second profile application(s) 5806 in an encrypted format. In further accordance with such an embodiment, profile management logic 5802 may enable mobile OS 5802 to store data associated with each one of the second application(s) in an encrypted format that is determined at least in part by an encryption key that is uniquely associated with the second application.

To achieve different types of data storage for first profile application(s) 5804 and second profile application(s) 5806, profile management logic 5820 may cause mobile OS 5802 to utilize different file I/O management logic when operating in the first profile mode than is used when operating in the second profile mode.

Profile management logic 5820 may also enable mobile OS 5802 to manage a network connection request made by at least one of second profile application(s) 5806 in a manner that is different than a manner in which network connection requests made by any of first profile application(s) 5804 are managed. For example, profile management logic 5820 may enable mobile OS 5802 to establish connections to any of a variety of public or private networks to service network connection requests made by first profile application(s) 5804 but may cause mobile OS 5802 to establish connections to a particular VPN to service network connection requests made by second profile application(s) 5804. Profile management logic 5820 may also cause mobile OS 5802 to prohibit access by second profile application(s) 5806 to certain networks when the mobile electronic device or a user thereof is in a certain environment.

To manage network connection requests generated by first profile application(s) 5804 differently than network connection requests generated by second profile application(s) 5806, profile management logic 5820 may cause mobile OS 5802 to utilize different network access management logic when operating in the first profile mode than is used when operating in the second profile mode.

Profile management logic 5820 may further enable mobile OS 5802 to present a first GUI to a display of the mobile electronic device when mobile OS 5802 is operating in the first profile mode and to present a second GUI to a display of the mobile electronic device when mobile OS 5802 is operating in the second profile mode. Each of the first and second GUI may have a different appearance and/or provide different features and functionality than a GUI associated with another profile.

Profile management logic 5820 may also enable mobile OS 5802 to enforce at least one policy with respect to the installation or execution of at least one of second profile application(s) 5806 that is not enforced with respect to the installation or execution of any of first profile applications 5804. Various examples of policies that may be enforced with respect to installation or execution of at least one of second profile application(s) were described above in reference to FIG. 57, and thus will not be described again here for the sake of brevity. To enforce policies with respect to second profile application(s) 5806 that are not enforced with respect to first profile application(s) 5804, profile management logic 5820 may cause mobile OS 5802 to utilize different policy management logic when operating in the first profile mode than is used when operating in the second profile mode.

Profile management logic 5820 may further enable mobile OS 5802 to cause processing unit 5814 to execute a user authentication process (which may be temporarily stored in system memory 5816) while operating in the second profile mode, wherein the user authentication process is uniquely associated with the second profile and is configured to authenticate a user prior to providing access to one or any of second profile application(s) 5806. Such user authentication process may use, for example, password or PIN based, biometric-based, or multi-factor user authentication techniques. Such user authentication process may not be used to restrict access to first profile application(s) 5804. Furthermore, profile management logic 5820 may also enable mobile OS 5802 to cause processing unit 5814 to execute a different user authentication process (which may be temporarily stored in system memory 5816) while operating in the first profile mode, wherein the different user authentication process in uniquely associated with the first profile and is configured to authenticate a user prior to providing access to one or any of first profile application(s) 5804. Such different user authentication process may not be used to restrict access to second profile application(s) 5806.

Profile management logic 5820 may further enable mobile OS 5802 to cause processing unit 5814 to execute a remote management client (which may be temporarily stored in system memory 5816) while operating in the second profile mode, wherein the remote management client is uniquely associated with the second profile and is configured to enable a remote entity to manage one or more of second profile application(s) 5806. As discussed above in reference to FIG. 57, such a remote management client may be configured to enable a remote entity to perform a variety of operations with respect to second profile application(s) 5806 including but not limited to downloading and/or installing an application or an application update, uninstalling an application, adding, modifying or deleting application data, notify an application of an event, or performing a variety of other operations with respect to an application or application data. Such remote management client may not enable the remote entity to manage any of first profile application(s) 5804. Furthermore, profile management logic 5820 may also enable mobile OS 5802 to cause processing unit 5814 to execute a different remote management client (which may be temporarily stored in system memory 5816) while operating in the first profile mode, wherein the different remote management client is uniquely associated with the first profile and is configured to enable a different remote entity to manage one or more of first profile application(s) 5804. Such different remote management client may not enable the different remote entity to manage any of second profile application(s) 5806.

The foregoing approach to implementing multi-profile support on a mobile electronic device was premised at least in part on customizing the mobile OS. There may be scenarios, however, where it is not possible or desirable to implement any customizations to the mobile OS. For example, in accordance with one scenario discussed above, an employee may wish to use her previously-purchased mobile electronic device (e.g., an iPhone® or Android™ phone) to support multiple profiles, such as a “home” profile and a “work” profile. In accordance with such a scenario, the implementation of multiple profiles on the mobile electronic device would ideally be achieved without having to modify the mobile OS (e.g., the iOS® or Android® OS) or a general system configuration that already exists on the mobile electronic device.

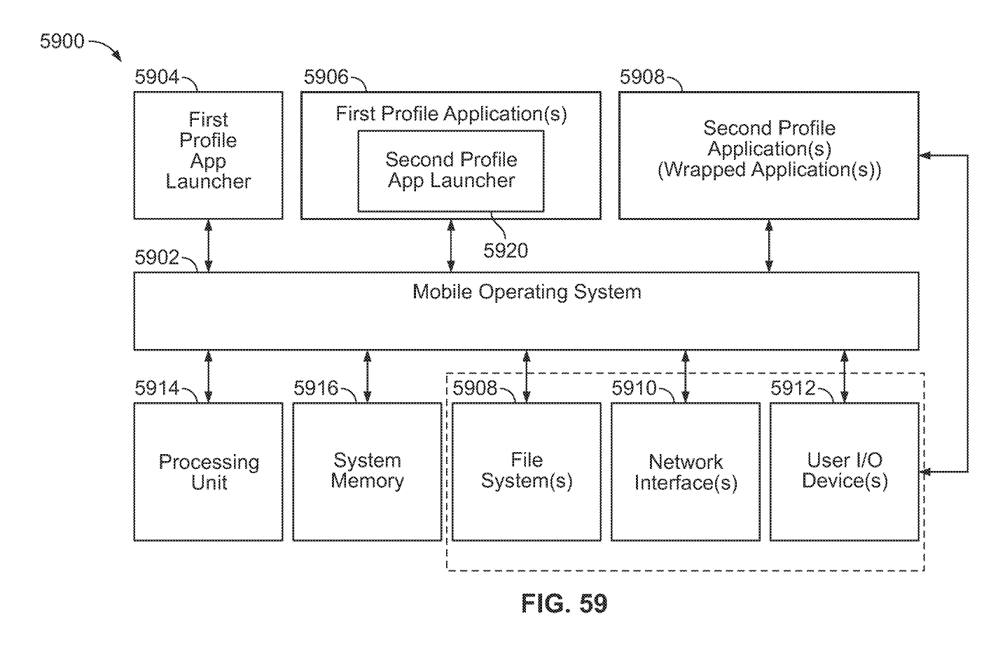

To address this issue, another approach to implementing multi-profile support on a mobile electronic device may be taken. This approach will now be described with reference to FIG. 59. In particular, FIG. 59 depicts an example architecture 5900 of a mobile electronic device that is configured to provide support for multiple profiles in a manner that does not require modifying a mobile OS 5902 thereof.

As shown in FIG. 59, mobile OS 5902 provides a platform upon which a first profile application launcher 5904, one or more first profile applications 5906 associated with a first profile, and one or more second profile applications 5908 associated with a second profile may be executed. Mobile OS 5902 may operate to service resource requests generated during execution of any of these programs, such as requests to store or retrieve data from a file system 5908 of the mobile electronic device, to send or receive data via one or more network interfaces 5910 of the mobile electronic device, or to output or obtain information via one or more user input/output devices 5912. As further shown in FIG. 59, architecture 5900 includes a processing unit 5914 and system memory 5916. Processing unit 5914 is configured to execute software instructions that are loaded into system memory 5916. As will be appreciated by persons skilled in the relevant art(s), mobile OS 5902, first profile application launcher 5904, first profile application(s) 5906 and second profile application(s) 5908 may be stored by file system(s) 5908 and loaded into system memory 5916 for execution by processing unit 5914.

First profile application launcher 5904 is intended to represent software that is launched by mobile OS 5902 and that operates to present a first GUI to a display of the mobile electronic device. The first GUI provides a means by which a user can access and selectively execute any of first profile application(s) 5906. First profile application launcher 5904 may be launched by mobile OS 5902 at system startup, for example. First profile application launcher 5904 may generate a desktop that provides a user with a view of application icons and folders from which the user can run any of first profile application(s) 5906. In accordance with certain embodiments, first profile application launcher 5904 may comprise a default or primary application launcher that is originally installed on the mobile electronic device and first profile application(s) 5906 may comprise the set of applications made available to the user via first profile application launcher 5904.

In accordance with the embodiment shown in FIG. 59, to implement multi-profile support on the mobile electronic device, a user or other entity may cause a second profile application launcher 5920 to be installed on the mobile electronic device such that second profile application launcher 5920 is made accessible to the user as one of first profile application(s) 5906. Second profile application launcher 5920 is essentially a secondary application launcher that can be selectively executed by the user by interacting with the first GUI provided by first profile application launcher 5904. When second profile application launcher 5920 is executed, it provides a second GUI by which the user can access second profile application(s) 5908. Processing unit 5914 is configured to execute any of first profile application(s) 5906 responsive to user selection thereof when the first GUI associated with first profile application launcher 5904 is being displayed and to execute any of second profile application(s) 5908 responsive to user selection thereof when the second GUI associated with second profile application launcher 5920 is being displayed.

Second profile application launcher 5920 may be configured to perform any of the profile-specific features described above in FIGS. 57 and 58. Thus, for example, second profile application launcher 5920 may include application management logic that, when executed by processing unit 5914, can: store data associated with second profile application(s) 5908 in a different area of memory than data associated with first profile application(s) 5804; store data associated with second profile application(s) 5908 in an encrypted format; manage network connection requests made by at least one of second profile application(s) 5908 in a manner that is different than a manner in which network connection requests made by any of first profile application(s) 5906 are managed; enforce at least one policy with respect to the installation or execution of at least one of second profile application(s) 5908 that is not enforced with respect to the installation or execution of any of first profile applications 5906; cause processing unit 5914 to execute a user authentication process configured to authenticate a user prior to providing access to one or any of second profile application(s) 5908; and/or cause processing unit 5914 to execute a remote management client configured to enable a remote entity to manage one or more of second profile application(s) 5908.

Additionally, each of second profile application(s) 5908 may be installed with additional application management logic that may be said to “wrap” the application and that may operate to perform any of the various profile-specific features described above when executed by processing unit 5914. In accordance with certain embodiments, wrapping of the application may be achieved by replacing standard libraries that are referenced by the application with custom libraries. Alternatively, wrapping the application may comprise modifying the application so that selected references to standard libraries that are included in the application are replaced with references to custom libraries. Such modification make be carried out manually or in an automated fashion. The custom libraries referred to above may be installed at the same time the modified application is installed or at some other time. As a result, selected resource requests (e.g., file I/O requests, network connection requests, or the like) generated by the application may be serviced by application management logic that “wraps” the application instead of by mobile OS 5902. This application management logic may operate to modify the way in which a particular resource request is handled and/or perform additional operations entirely.

In one embodiment, a remote entity creates a “wrapped” application by receiving and modifying an application package. The application package be received in a compressed form and then decompressed. The application package may comprise a file that includes an application, one or more supporting libraries and/or resources, and a set of instructions relating to installation of the application. The remote entity may modify the application as discussed above and/or add custom libraries or resources to the application package. The remote entity may then recreate the application package by combining the modified application with the modified supporting libraries and resources into a new file and then compressing the new file and making it available for download. The remote entity may also digitally sign the application or application package so that its authenticity can be verified by a mobile electronic device.

In accordance with the foregoing implementation, first profile application launcher 5904 must be able to determine which applications installed on the mobile electronic device are included within first profile application(s) 5906 and second profile application launcher 5920 must be able to determine which applications installed on the mobile electronic device are included within second profile application(s) 5908. This may be achieved in a variety of ways depending upon the implementation. In one embodiment, an attribute may be included within an application file that will render the application invisible to first profile application launcher 5904. Second profile application launcher, on the other hand, may scan the same set of applications and specifically look for that attribute. In another embodiment, a registry may be maintained that specifies which applications belong with which profiles. In a still further embodiment, applications may be installed into different directories associated with each profile, thereby logically partitioning the applications associated with one profile from the applications associated with another.

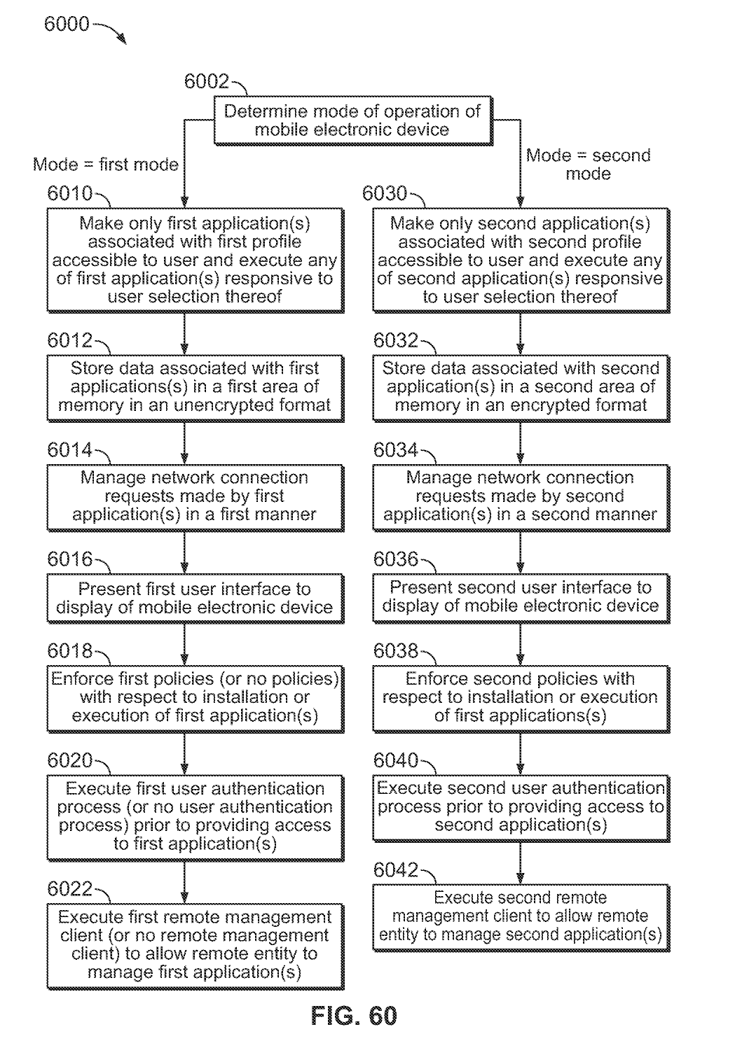

FIG. 60 depicts a flowchart 6000 of a method for supporting multiple profiles on a mobile electronic device in accordance with an embodiment. The method of flowchart 6000 may be performed, for example, by a mobile electronic device having architecture 5800 of FIG. 58 or by a mobile electronic device having architecture 5900 of FIG. 59. However, the method is not limited to those implementations and may be implemented by other mobile electronic devices as well.

As shown in FIG. 60, the method of flowchart 6000 begins at step 6002 in which a mode of operation of a mobile electronic device is determined, wherein the mode of operation may comprise a first mode of operation associated with a first profile or a second mode of operation associated with a second profile. In the embodiment described above in reference to FIG. 58, profile management logic 5820 within mobile OS 5802 determines the mode of operation. In the embodiment described above in reference to FIG. 59, the mode of operation is determined based on whether application access is currently being controlled by first profile application launcher 5904 or by second profile application launcher 5920.

As shown at step 6010, if it is determined that the mode is the first mode, then only one or more first applications associated with the first profile are made accessible to a user and any of the first application(s) may be executed responsive to user selection thereof. However, as shown at step 6030, if it is determined that the mode is the second mode, then only one or more second applications associated with the second profile are made accessible to the user and any of the second application(s) may be executed responsive to user selection thereof, as shown at step 6030.

As shown at step 6012, if it is determined that the mode is the first mode, then data associated with the first application(s) is stored in a first area of memory in an unencrypted format. However, as shown at step 6032, if it is determined that the mode is the second mode, then data associated with the second application(s) is stored in an encrypted format in a second area of memory that is different from the first area of memory.

As shown at step 6014, if it is determined that the mode is the first mode, then network connection requests made by the first application(s) are managed in a first manner. However, as shown at step 6034, if it is determined that the mode is the second mode, then network connection requests made by the second application(s) are managed in a second manner that is different than the first manner.

As shown at step 6016, if it is determined that the mode is the first mode, then a first user interface is presented to a display of the mobile electronic device. However, as shown at step 6036, if it is determined that the mode is the second mode, then a second user interface that is different from the first user interface is presented to the display of the mobile electronic device.

As shown at step 6018, if it is determined that the mode is the first mode, then first policies (or no policies) are enforced with respect to the installation or execution of the first application(s). However, as shown at step 6038, if it is determined that the mode is the second mode, then second policies that are different than the first policies are enforced with respect to the installation or execution of the second application(s).

As shown at step 6020, if it is determined that the mode is the first mode, then a first user authentication process (or no user authentication process) is executed prior to providing the user with access to the first application(s). However, as shown at step 6040, if it is determined that the mode is the second mode, then a second user authentication process that is different than the first user authentication process is executed prior to providing the user with access to the second application(s).

As shown at step 6022, if it is determined that the mode is the first mode, then a first remote management client (or no remote management client) is executed to allow a remote entity to manage the first application(s). However, as shown at step 6042, if it is determined that the mode is the second mode, then a second remote management client that is different from the first remote management client is executed to allow a remote entity to manage the second application(s).

Although the foregoing description focused on supporting multiple profiles on a mobile electronic device, embodiments can also support multiple users on a single mobile electronic device, wherein each user may then have one or more profiles associated therewith. Thus, in accordance with one embodiment, the mobile electronic device may maintain a separate user partition for each of a plurality of users, wherein each user partition includes applications, data and other functionality and features that are to be made accessible to a particular user. Within each user partition, the mobile electronic device may further maintain a separate profile partition for each of a plurality of profiles associated with a user. Such an embodiment may require distinct user logins for multi-user access. Once a particular user has logged in, the user may then selectively activate one of a plurality of profiles that are associated with the particular user.

Furthermore, although the foregoing description focused on maintaining a separation between profiles, in certain embodiments, communication between profiles may be enabled. For example, in accordance with one embodiment, messages or notifications generated by an application associated with a first profile may be displayed while a mobile electronic device is operating in a mode associated with a second profile. Thus, in accordance with such an embodiment, a notification of an event (e.g., receipt of e-mail or text message) generated by an e-mail application associated with a “work” profile may be provided to the user while the user is interacting with “home” profile applications. To provide an extra level of security, such notifications may be pre-processed to ensure that the notifications do not disclose sensitive information.

Additionally, in accordance with certain embodiments, various applications, application data, and other features and functionality may be designated as belonging to multiple profiles such that the applications, application data, and other features and functionality are accessible when the mobile electronic device is operating in modes associated with such multiple profiles.

### E. Attribute-Based Presentation of Available Applications in an Application Store

As discussed above, in accordance with certain embodiments, an application store can be configured to selectively present applications to a particular mobile electronic device based on whether the applications are deemed compatible with the particular mobile electronic device. This enables a user of the mobile electronic device to more easily identify applications that are suitable for installation and/or execution upon the mobile electronic device. As a coarse example, an application store in accordance with such an embodiment would not present a user of a mobile electronic device that runs an Android™ OS with applications designed to run only on a Microsoft Windows® OS. As a finer example, an application store in accordance with such an embodiment would not present a user of a mobile electronic device that runs an Android™ OS and does not include a GPS receiver with applications designed to run on an Android™ OS that require a GPS receiver.

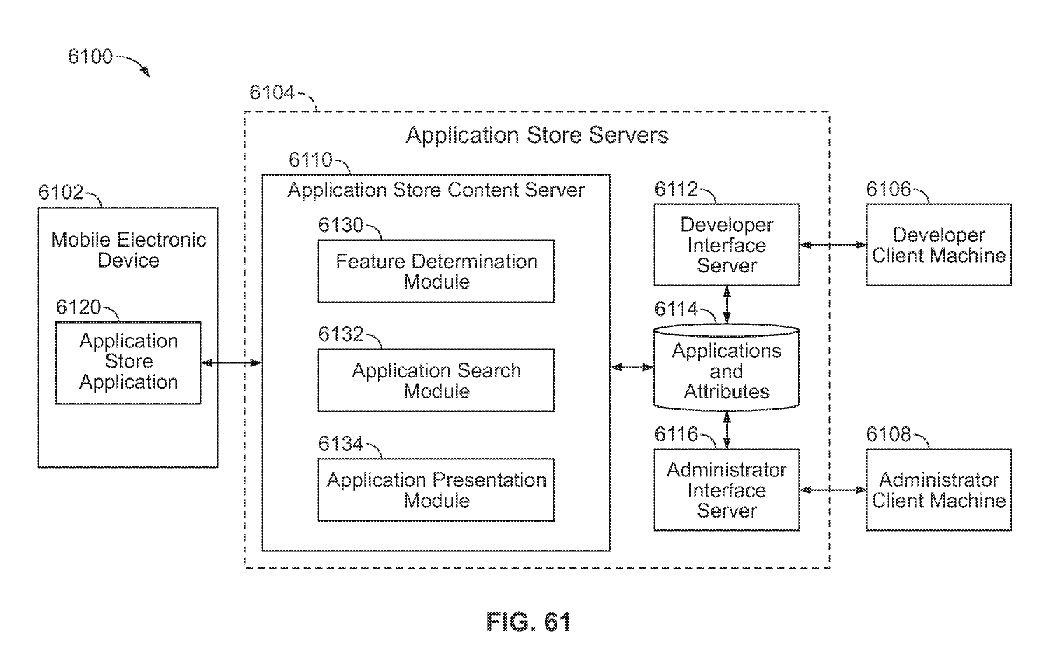

FIG. 61 is a block diagram of an example system 6100 that performs attribute-based presentation of available applications in an application store in accordance with an embodiment. As shown in FIG. 61, system 6100 includes a mobile electronic device 6102, a number of application store servers 6104, a developer client machine 6106 and an administrator client machine 6108. Each of these components will now be described.

Developer client machine 6106 is intended to represent a computing device that is capable of being used by a developer to upload applications to the application store. As shown in FIG. 61, developer client machine 6106 is communicatively connected to a developer interface server 6112 within application store servers 6104. In accordance with certain implementations, such connection may be established over one or more networks (including wired and/or wireless networks, public and/or private networks, local area and/or wide area networks, or the like) using any of a variety of well-known networking protocols. However, the connection between developer client machine 6106 and developer interface server 6112 may be achieved using other connection mediums and protocols as well.

Developer interface server 6112 is configured to serve one or more user interfaces (UIs) to developer client machine 6106. Such UIs may comprise, for example and without limitation, Web pages or portions thereof that include UI components with which a developer can interact. In particular, developer interface server 6112 is configured to serve a UI to developer client machine 6106 that a developer can interact with to upload an application from developer client machine 6106 to developer interface server 6112 or to some other component within application store servers 6104. Developer interface server 6112 is further configured to serve a UI to developer client machine 6106 that enables or requires the developer to provide information about the application that is being uploaded. The information that can be provided may include, for example, an application name, one or more categories with which the application should be associated, a text description of the application, a rating of the application or the like. In addition, the UI may enable or require the developer to specify or select one or more attributes associated with the application that is being uploaded.

Some example attributes that may be specified or selected by the developer will now be described. One attribute may be a target OS upon which the application can be executed. For example, the target OS may be the Android™ OS, Microsoft Windows® 8, or the like.

Another example attribute is a minimum supported OS version for the application. For example, this attribute may specify that at least version 3.0 of a particular OS must be installed on a mobile electronic device in order to run the application.

Yet another example attribute is a latest-released version of an OS upon which the application has been tested. For example, this attribute may specify that the application has been tested on version 3.2 of a particular OS, but has not been tested on any later-released version of the same OS.

A further example attribute is a particular product or device type supported by the application. For example, this attribute may specify that the application is suitable for installation and execution on a Motorola Droid®, a Cisco Cius™ or some other product or device type. A rationale for including this attribute is to identify applications that may be written with a specific deployment platform in mind.

A still further example attribute is a hardware feature of a mobile electronic device that is required to run or access some or all the features of the application. Example hardware features that may be required and thus specified via an attribute include but are not limited to: an accelerometer, a magnetometer, a GPS receiver, a microphone, a camera, multiple cameras (e.g., dual cameras), and multiple displays (e.g., dual displays). A rationale for including such an attribute is to recognize that some devices may have subset or superset of hardware features required for running or accessing some or all the features of an application. As an example, the Android™ application store enumerates a required set of hardware features that a mobile electronic device must have, such as a GPS receiver. However, many software applications may not require a GPS receiver and will work perfectly well on a mobile electronic device that does not include a GPS receiver. Conversely, an application may be written that requires dual displays even though that is outside of the scope of the hardware features defined for Android™

An additional example attribute is one or more display resolutions supported by the application. For example, this attribute may specify one or more particular display resolutions supported by the application (e.g., 800×600, 1024×768, 1920×1080). This attribute may also specify a minimum display resolution supported by the application, a maximum display resolution supported by the application, that any display resolution is supported by the application, or that any “standard” display resolution is supported by the application. A rationale for including such an attribute is to identify whether an application was written to support just one or a few specific resolutions, to support any “standard” resolution (wherein what constitutes a “standard” resolution may be defined by an entity that manages an application store, or some other entity), to support “non-standard” resolutions, or to support arbitrary resolutions.

The attributes selected or specified for an application may be generalized further to include an indication that an application should be made available to mobile electronic devices manufactured or sold by a particular device vendor, to mobile electronic devices that use a particular service provider (e.g., an application may be available to only AT&T customers), or to a particular type or level of customer (e.g., an application may only be available to “gold-level” customers).

The foregoing list of attributes has been provided herein by way of example only and is not intended to be limiting. Persons skilled in the relevant art(s) based on the teachings provided herein will appreciate that still other attributes may be selected or specified for an application.

Developer interface server 6112 (or some other component within application store servers 6104) operates to store an application uploaded from developer client machine 6106 in association with the attributes specified or selected for the application in a storage system 6114. Various approaches may be used to maintain an association between an application and its attributes. For example, in one embodiment, the attributes associated with an application may be encoded into a list of metadata that describes the application and is stored in conjunction with the application. In another embodiment, the attributes associated with an application may be stored in a relational database that maps attributes to applications. Such a relational database may advantageously support rapid execution of queries for applications that have or do not have certain attributes.

As shown in FIG. 61, mobile electronic device 6102 includes an application store application 6120. When application store application 6120 is executed on mobile electronic device 6102, it enables mobile electronic device 6102 to establish a connection with an application store content server 6110 within application store servers 6104 and to request and obtain content therefrom. In accordance with certain implementations, such connection may be established over one or more networks (including wired and/or wireless networks, public and/or private networks, local area and/or wide area networks, or the like) using any of a variety of well-known networking protocols. However, the connection between mobile electronic device 6102 and application store content server 6110 may be achieved using other connection mediums and protocols as well.

Application store content server 6110 is configured to provide requested content to application store application 6120 that relates to applications available in an application store. Such content may include, for example, names of applications that are available for download to mobile electronic device 6102, descriptions of such applications (including textual descriptions and example screenshots), prices associated with such applications, ratings associated with such applications, licensing terms associated with such applications, or the like. Applications store content server 6110 may also be configured to cause applications stored in storage system 6114 or updates associated therewith to be downloaded to mobile electronic device 6102. Such downloading may occur responsive to a user selection or purchase of an application as carried out via application store application 6120 executing on mobile electronic device 6102.

Application store application 6120 is configured to request lists of available applications available from application store content server 6110 and to display such lists when they are returned from application store content server 6110. Application store application 6120 may enable a user of mobile electronic device 6102 to specify search criteria to be used in identifying a subset of applications available in the application store. Such search criteria may comprise for example one or more search terms input by the user. Such search criteria may also comprise one or more predefined search criteria presented to the user in a selectable manner by application store application 6120. Such predefined search criteria may include, for example, applications available in a specific category (e.g., games, utilities, social networking, music, productivity, sports, news, etc.), featured applications, most popular applications, newest applications, or the like. Search criteria may be used to obtain partial results (e.g., such as the first 100 matching apps, the next 100 matching apps, etc.).

Search criteria input or selected by a user of application store application 6120 are transmitted to application store content server 6110. Application store content server 6110 uses such search criteria to identify applications available in the application store that satisfy the search criteria and that also have attributes that indicate that the application is suitable for installation and/or execution upon mobile electronic device 6102. Application store content server 6110 then transmits a list of the identified applications to application store application 6120 for presentation to the user. To perform these functions, application store content server includes a feature determination module 6130, an application search module 6132 and an application presentation module 6134. The manner in which these modules operate will now be described.

Feature determination module 6130 is configured to determine one or more features of mobile electronic device 6102. For example, feature determination module 6130 may operate to determine one or more of the following features of mobile electronic device 6102: an OS of mobile electronic device 6102, an OS version of mobile electronic device 6102, one or more display resolutions supported by mobile electronic device 6102, a product type of mobile electronic device 6102, a vendor of mobile electronic device 6102, a service provider used by mobile electronic device 6102, or a customer type associated with mobile electronic device 6102. Feature determination module 6130 may also operate to determine whether mobile electronic device includes one or more of the following hardware features: an accelerometer, a magnetometer, a GPS receiver, a microphone, a camera, multiple cameras, multiple displays, or the like. These features are described herein by way of example only and are not intended to be limiting. Persons skilled in the relevant art(s) will appreciate that feature determination module 6130 may determine still other features of mobile electronic device 6102.

Various techniques may be used by feature determination module 6130 to determine the features of mobile electronic device 6102. In one embodiment, application store application 6120 is configured to query mobile electronic device 6102 to determine its features and then transfers information about the determined features to feature determination module 6130. In further accordance with this embodiment, such information may be transferred each time application store application 6120 initiates an application search. Alternatively, the features of mobile electronic device 6102 may be uploaded to feature determination module 6130 only when application store application 6120 is first used. In accordance with this approach, feature determination module 6130 may then store such features for future reference. For example, feature determination module 6130 may store such features in association with a unique identifier (ID) of mobile electronic device 6102. In further accordance with this example, feature determination module 6130 may store such features in association with the unique ID of mobile electronic device 6102 in a database that maps unique IDs of mobile electronic devices to features of mobile electronic devices. During subsequent application searches, application store application 6120 may transmit the unique ID of mobile electronic device 6102 to application store content server 6110 and feature determination module 6130 may use the unique ID to access the stored features associated with mobile electronic device 6102.

In another embodiment, an application store administrator may maintain a table or database of known mobile electronic device types and the features associated with such mobile electronic device types. Such table or database may be stored in a storage location that is accessible to feature determination module 6130. The administrator may update such table or database when a new device type is introduced into the market or when a new attribute is added to the list of attributes associated with applications. Feature determination module 6130 may then determine a device type of mobile electronic device 6102 (e.g., based on information provided by application store application 6120 or some other entity operating on mobile electronic device 6102) and then use the table or database to determine its associated features.

Once feature determination module 6130 has determined the feature(s) of mobile electronic device 6102 it passes those features to application search module 6132. Application search module 6132 uses the search criteria received from application store application 6120 and the feature(s) of mobile electronic device 6102 received from feature determination module 6130 to identify applications stored in storage system 6114 that satisfy the search criteria and that also have attributes that match the feature(s) of mobile electronic device 6102 and are thus suitable for installation and/or execution on mobile electronic device 6102.

With respect to identifying the applications that satisfy the search criteria, application search module 6132 may use any of a variety of well-known search algorithms or processes suitable for performing that task. With respect to identifying applications that have attributes that match the feature(s) of mobile electronic device 6102, application search module 6132 is configured to compare the feature(s) of mobile electronic device 6120 to the attributes associated with each application that is eligible for inclusion in the search results to be produced by application search module 6132. In accordance with one implementation, application search module 6132 first identifies applications that satisfy the search criteria and then applies feature-to-attribute matching to the identified applications to further narrow the results. In accordance with an alternate implementation, application search module 6132 first applies feature-to-attribute matching to identify applications that are suitable for installation and/or execution on mobile electronic device 6102 and then applies the search criteria to the identified applications to further narrow the results. In accordance with yet another implementation, application search module 6132 jointly applies the search criteria and feature-to-attribute matching to all eligible applications to identify applications that both satisfy the search criteria and are suitable for installation and/or execution on mobile electronic device 6102.

In accordance with certain embodiments, comparing the feature(s) of mobile electronic device 6102 to the attribute(s) associated with a particular application may include any of the following: comparing an OS of mobile electronic device 6102 to an attribute that specifies a target OS for the application; comparing an OS version of mobile electronic device 6102 to an attribute that specifies a minimum supported OS version for the application; comparing an OS version of mobile electronic device 6102 to an attribute that specifies a latest version of an OS upon which the application has been tested; comparing a product type of mobile electronic device 6102 to an attribute that specifies a product type supported by the application; comparing one or more display resolutions supported by mobile electronic device 6102 to one or more display resolutions supported by the application; comparing a vendor of mobile electronic device 6102 to an attribute that specifies a vendor of mobile electronic devices; comparing a service provider used by mobile electronic device 6102 to an attribute that specifies a service provider; or comparing a customer type associated with mobile electronic device 6102 to an attribute that specifies a particular customer type. In accordance with further embodiments, comparing the feature(s) of mobile electronic device 6102 to the attribute(s) associated with a particular application may include comparing the feature(s) of mobile electronic device 6102 to an attribute that specifies a hardware feature that is supported by the application, wherein the hardware feature may comprise any of: an accelerometer, a magnetometer, a GPS receiver, a microphone, a camera, multiple cameras or multiple displays.

The type of comparison that must be carried out to determine a feature-to-attribute match may vary depending upon the features and attributes being matched. For example, in some cases, the comparison will involve determining if a feature specified as being required by an attribute of an application matches a feature of mobile electronic device 6102. Thus, for example, if an application has a “needs-GPS” attribute, then mobile electronic device 6102 must have a corresponding “has-GPS” feature. For firmware or OS versions, a comparison may be performed to determine if a firmware/OS version running on mobile electronic device 6102 (as specified by the features of mobile electronic device 6102) exceeds a minimum required version specified as an application attribute. To perform resolution matching, the comparison may involve requiring an exact match (e.g., mobile electronic device 6102 has a “supports 1024×768” feature and the application also has a “supports 1024×768” attribute) or an inequality (e.g., mobile electronic device 6102 supports resolutions that are less than a maximum resolution specified as an attribute of the application). Still other types of comparisons may be used to perform feature-to-attribute matching.

In accordance with one embodiment, application search module 6132 may determine a set of attributes necessary to install and/or execute an application on mobile electronic device 6102 based on the determined feature(s) of mobile electronic device 6102. Application search module 6132 may then compare the set of attributes to the attributes associated with each application eligible for inclusion in the search results. In further accordance with such an embodiment, application search module 6132 may perform this comparison by querying a relational database that maps attributes to applications to quickly identify applications that have attributes that match the set of attributes.

Although a number of features and attributes are described above, as well as methods for comparing the same, persons skilled in the relevant art(s) will appreciate that these features, attributes and methods of comparison have been described herein by way of example only and that a wide variety of other features of mobile electronic devices, attributes associated with applications, and methods of comparing the same may be used to perform attribute-based presentation of available applications in an application store.

After application search module 6132 has identified applications in the application store that both satisfy the search criteria and are suitable for installation and/or execution on mobile electronic device 6102, application presentation module 6134 operates to transmit to application store application 6120 executing on mobile electronic device 6102 a list of the identified applications for presentation to a display of mobile electronic device 6102. Such list may include a variety of information about the identified applications, including application name, a description of the application, screenshots associated with application, ratings associated with the application, a price of the application, licensing terms associated with the application, or the like. The user of mobile electronic device 6102 may use such list to find out about and optionally purchase applications in which they may be interested.

As further shown in FIG. 61, system 6100 also includes an administrator client machine 6108. Administrator client machine 6108 is intended to represent a computing device that is capable of being used by an application store administrator to manage various operations of an application store. Administrator client machine 6108 is communicatively connected to an administrator interface server 6116 within application store servers 6104. In accordance with certain implementations, such connection may be established over one or more networks (including wired and/or wireless networks, public and/or private networks, local area and/or wide area networks, or the like) using any of a variety of well-known networking protocols. However, the connection between administrator client machine 6108 and administrator interface server 6116 may be achieved using other connection mediums and protocols as well.

Administrator interface server 6116 is configured to serve one or more UIs to administrator client machine 6108. Such UIs may comprise, for example and without limitation, Web pages or portions thereof that include UI components with which an administrator can interact. In particular, administrator interface server 6112 is configured to serve a UI to administrator client machine 6108 that an administrator can interact with to manage the various types of attributes that a developer may specify for an application when uploading an application to the application store. For example, using this UI, an administrator may add a new attribute, modify an existing attribute, or remove an existing attribute.

The foregoing description of system 6100 refers to a number of “servers.” As used herein, the term server refers to one or more computer programs that are executed at least in part to serve the requests of other computer programs, which may be referred to as “clients.” A server may also refer to a physical computer that runs such computer program(s).

Furthermore, although the foregoing description of system 6100 suggests that a client-server model is used to manage interaction between developer client machine 6106 and developer interface server 6112, between administrator client machine 6108 and administrator interface server 6116, and between mobile electronic device 6102 and application store content server 6110, persons skilled in the relevant art(s) will readily appreciate that other computing models and architectures may be used to manage the flow of information between an application store and entities that communicate therewith.

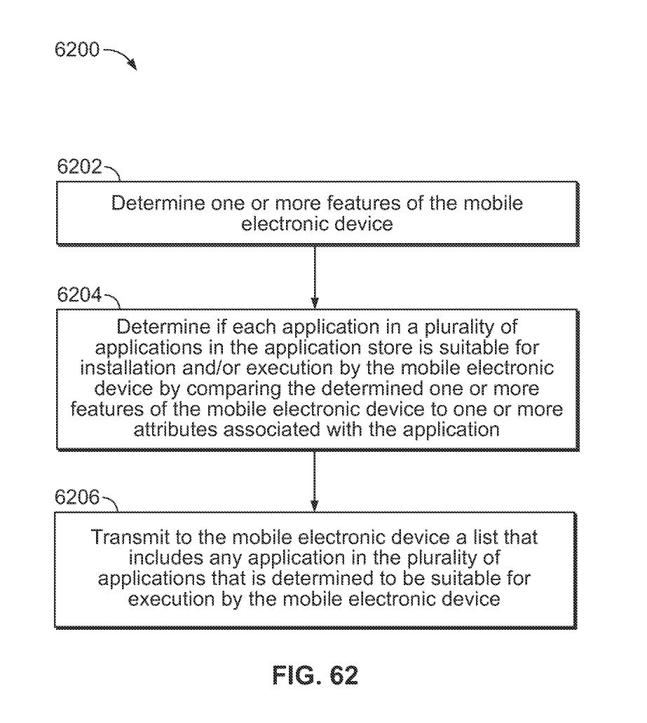

FIG. 62 depicts a flowchart 6200 of a method for performing attribute-based presentation of applications available in an application store to a mobile electronic device. The method of flowchart 6200 may be certain components of system 6100 as described above in reference to FIG. 61. However, the method is not limited to that implementation and may be performed by other components or systems entirely.

As shown in FIG. 62, the method of flowchart 6200 begins at step 6202, in which one or more features of a mobile electronic device are determined. For example, with continued reference to system 6100 of FIG. 61, feature determination module 6130 of application store content server 6110 may perform this step to determine feature(s) of mobile electronic device 6102.

At step 6204, a determination is made for each of a plurality of applications in the application store. The plurality of applications may be all available applications in the application store. Alternatively, the plurality of applications may comprise applications in the application store that have been identified by conducting an application search based on search criteria selected and/or input by a user of the mobile electronic device. The determination is whether each application is suitable for installation and/or execution by the mobile electronic device. The determination is made by comparing the determined feature(s) of the mobile electronic device to one or more attributes associated with each application in the plurality of applications. For example, with continued reference to system 6100 of FIG. 61, application search module 6132 of application store content server 6110 may perform this step.

At step 6206, a list that includes any application in the plurality of applications that is determined to be suitable for execution by the mobile electronic device during step 6204 is transmitted to the mobile electronic device. For example, with continued reference to system 6100 of FIG. 61, application presentation module 6134 of application store content server 6110 may perform this step.

In accordance with an embodiment of the method of flowchart 6200, step 6202 may include querying the mobile electronic device to determine the one or more features. In accordance with another embodiment of the method of flowchart 6200, step 6202 may include obtaining an identifier of the mobile electronic device and using the identifier to obtain the one or more features of the mobile electronic device from a database that maps identifiers of mobile electronic devices to features of mobile electronic devices.

Depending upon the implementation, the process of comparing the determined one or more features of the mobile electronic device to the attribute(s) associated with the application as described in reference to step 6204 may comprise: comparing an operating system of the mobile electronic device to an attribute that specifies a target operating system for the application; comparing an operating system version of the mobile electronic device to an attribute that specifies a minimum supported operating system version for the application; comparing an operating system version of the mobile electronic device to an attribute that specifies a latest version of an operating system upon which the application has been tested; comparing a product type of the mobile electronic device to an attribute that specifies a product type supported by the application; comparing the determined one or more features of the mobile electronic device to an attribute that specifies a hardware feature that is required by the application wherein the hardware feature that is required by the application may comprise, for example and without limitation, any of an accelerometer, a magnetometer, a GPS receiver, a microphone, a camera, multiple cameras, or multiple displays; comparing one or more display resolutions supported by the mobile electronic device to an attribute that specifies one or more display resolutions supported by the application; comparing a vendor of the mobile electronic device to an attribute that specifies a vendor of mobile electronic devices; comparing a service provider used by the mobile electronic device to an attribute that specifies a service provider; comparing a customer type associated with the mobile electronic device to an attribute that specifies a particular customer type. These example feature-to-attribute comparisons are provided herein by way of example only. Persons skilled in the relevant art(s) will appreciate that other features, other attributes, and other types of comparisons there between may be used.

In accordance with an embodiment of the method of flowchart 6200, the process of comparing the determined feature(s) of the mobile electronic device to the attribute(s) associated with the application includes obtaining the attribute(s) associated with the application from descriptive metadata associated with the application. In accordance with a further embodiment, comparing the determined feature(s) of the mobile electronic device to the attribute(s) associated with the application includes obtaining the attribute(s) associated with the application from a relational database that maps attributes to applications.

In accordance with another embodiment of the method of flowchart 6200, the process of determining if each application in the plurality of applications is suitable for installation and/or execution by the mobile electronic device comprises determining a set of attributes necessary to install and/or execute an application on the mobile electronic device based on the determined one or more features of the mobile electronic device, and comparing the set of attributes to the attribute(s) associated with each application in the plurality of applications. In further accordance with such an embodiment, comparing the set of attributes to the attribute(s) associated with each application in the plurality of applications may include querying a relational database that maps attributes to applications to identify applications that have attributes that match the set of attributes.

In one implementation of the method of flowchart 6200, the method further includes providing an interface by which a developer can submit a new application to the application store and specify one or more attributes associated with the new application. The method may also include providing an interface that enables an administrator to add or remove attributes associated with applications.

### F. Example Computer System Implementations

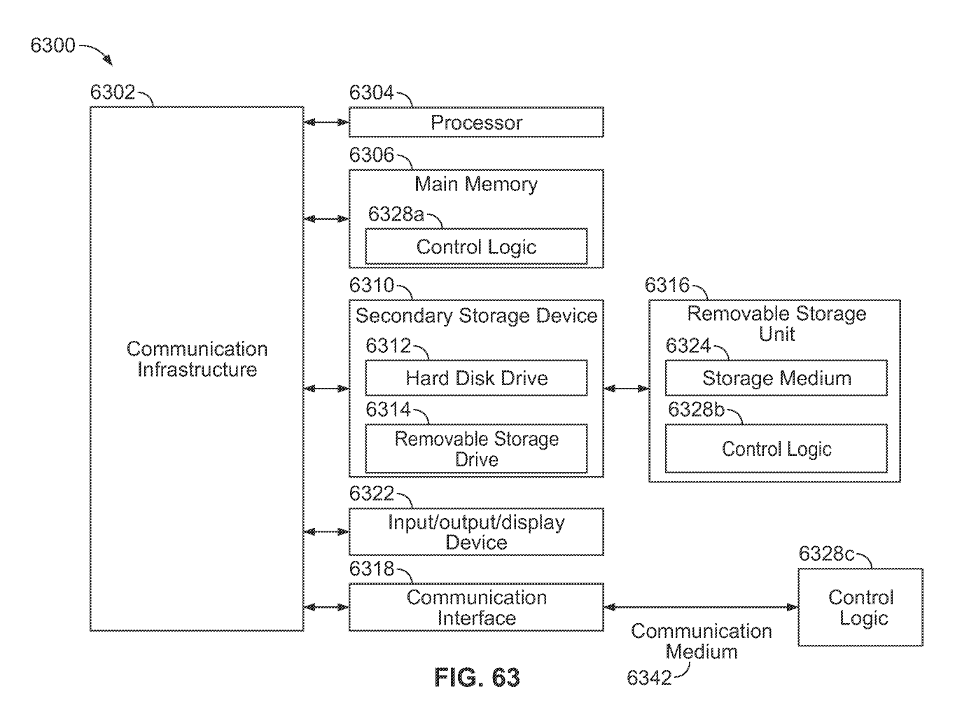

The embodiments described herein, including devices, apparatuses, systems, and/or methods/processes, and/or apparatuses, may be implemented using a computing device, such as computing device 6300 shown in FIG. 63. For example, each of the handsets or other mobile electronic devices, docking stations, client machines and servers, as well as any of the sub-systems or components contained therein may be implemented using one or more computing devices 6300.

Computing device 6300 can be any commercially available and well known computer capable of performing the functions described herein, such as computers available from International Business Machines, Apple, Sun, HP, Dell, Cray, etc. Computing device 6300 may be any type of computer, including a desktop computer, a server, etc. Computing device 6300 may also represent a tablet computer, a netbook, a laptop computer, a smart phone, a personal digital assistant, a video game console, a personal media player, or the like.

Computing device 6300 includes one or more processors (also called central processing units, or CPUs), such as a processor 6304. Processor 6304 is connected to a communication infrastructure 6302, such as a communication bus. In some embodiments, processor 6304 can simultaneously operate multiple computing threads.

Computing device 6300 also includes a primary or main memory 6306, such as random access memory (RAM). Main memory 6306 has stored therein control logic 6328A (computer software), and data.

Computing device 6300 also includes one or more secondary storage devices 6310. Secondary storage devices 6310 include, for example, a hard disk drive 6312 and/or a removable storage device or drive 6314, as well as other types of storage devices, such as memory cards and memory sticks. For instance, computing device 6300 may include an industry standard interface, such a universal serial bus (USB) interface for interfacing with devices such as a memory stick. Removable storage drive 6314 represents a floppy disk drive, a magnetic tape drive, a compact disk drive, an optical storage device, tape backup, etc.

Removable storage drive 6314 interacts with a removable storage unit 6316. Removable storage unit 6316 includes a computer useable or readable storage medium 6324 having stored therein computer software 6328B (control logic) and/or data. Removable storage unit 6316 represents a floppy disk, magnetic tape, compact disk, DVD, optical storage disk, or any other computer data storage device. Removable storage drive 6314 reads from and/or writes to removable storage unit 6316 in a well known manner.

Computing device 6300 also includes input/output/display devices 6322, such as monitors, keyboards, pointing devices, etc.

Computing device 6300 further includes a communication or network interface 6318. Communication interface 6318 enables computing device 6300 to communicate with remote devices. For example, communication interface 6318 allows computing device 6300 to communicate over communication networks or mediums 6342, such as LANs, WANs, the Internet, etc. Communication interface 6318 may interface with remote sites or networks via wired or wireless connections.

Control logic 6328C may be transmitted to and from computing device 6300 via communication medium 6342.

Any apparatus or manufacture comprising a computer useable or readable medium having control logic (software) stored therein is referred to herein as a computer program product or program storage device. This includes, but is not limited to, computing device 6300, main memory 6306, secondary storage devices 6310, and removable storage unit 6316. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other non-transitory media such as flash memory cards, digital video discs, RAM devices, ROM devices, and the like. Such computer-readable storage media may store program modules that include computer program logic for implementing the features of embodiments described herein. Embodiments are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### G. Conclusion

While various embodiments have been described above, it should be understood that they have been presented by way of example only, and not limitation. It will be understood by those skilled in the relevant art(s) that various changes in form and details may be made therein without departing from the spirit and scope of the appended claims. Accordingly, the breadth and scope of the subject matter described herein should not be limited by any of the above-described exemplary embodiments, but should be defined only in accordance with the following claims and their equivalents.

What is claimed is:

1. A method for performing attribute-based presentation of applications available in an application store to a mobile electronic device, comprising:
determining one or more features of the mobile electronic device;
determining if each application in a plurality of applications in the application store is suitable for installation and/or execution by the mobile electronic device by comparing the determined one or more features of the mobile electronic device to one or more attributes associated with the application; and
transmitting to the mobile electronic device a list that includes any application in the plurality of applications that is determined to be suitable for execution by the mobile electronic device.

2. The method of claim 1, wherein comparing the determined one or more features of the mobile electronic device to the attribute(s) associated with the application includes:
comparing an operating system of the mobile electronic device to an attribute that specifies a target operating system for the application.

3. The method of claim 1, wherein comparing the determined one or more features of the mobile electronic device to the attribute(s) associated with the application includes:
comparing an operating system version of the mobile electronic device to an attribute that specifies a minimum supported operating system version for the application.

4. The method of claim 1, wherein comparing the determined one or more features of the mobile electronic device to the attribute(s) associated with the application includes:
comparing an operating system version of the mobile electronic device to an attribute that specifies a latest version of an operating system upon which the application has been tested.

5. The method of claim 1, wherein comparing the determined one or more features of the mobile electronic device to the attribute(s) associated with the application includes:
comparing a product type of the mobile electronic device to an attribute that specifies a product type supported by the application.

6. The method of claim 1, wherein comparing the determined one or more features of the mobile electronic device to the attribute(s) associated with the application includes:
comparing the determined one or more features of the mobile electronic device to an attribute that specifies a hardware feature that is required by the application.

7. The method of claim 6, wherein the hardware feature that is required by the application comprises:
an accelerometer;
a magnetometer;
a Global Positioning System (GPS) receiver;
a microphone;
a camera;
multiple cameras; or
multiple displays.

8. The method of claim 1, wherein comparing the determined one or more features of the mobile electronic device to the attribute(s) associated with the application includes:
comparing one or more display resolutions supported by the mobile electronic device to an attribute that specifies one or more display resolutions supported by the application.

9. The method of claim 1, wherein comparing the determined one or more features of the mobile electronic device to the attribute(s) associated with the application includes:
comparing a vendor of the mobile electronic device to an attribute that specifies a vendor of mobile electronic devices.

10. The method of claim 1, wherein comparing the determined one or more features of the mobile electronic device to the attribute(s) associated with the application includes:
comparing a service provider used by the mobile electronic device to an attribute that specifies a service provider.

11. The method of claim 1, wherein comparing the determined one or more features of the mobile electronic device to the attribute(s) associated with the application includes:
comparing a customer type associated with the mobile electronic device to an attribute that specifies a particular customer type.

12. The method of claim 1, wherein comparing the determined one or more features of the mobile electronic device to the attribute(s) associated with the application includes:
obtaining the attribute(s) associated with the application from descriptive metadata associated with the application.

13. The method of claim 1, wherein comparing the determined one or more features of the mobile electronic device to the attribute(s) associated with the application includes:
obtaining the attribute(s) associated with the application from a relational database that maps attributes to applications.

14. The method of claim 1, wherein determining if each application in the plurality of applications is suitable for installation and/or execution by the mobile electronic device by comparing the determined one or more features of the mobile electronic device to the attribute(s) associated with the application comprises:
determining a set of attributes necessary to install and/or execute an application on the mobile electronic device based on the determined one or more features of the mobile electronic device; and
comparing the set of attributes to the attribute(s) associated with each application in the plurality of applications.

15. The method of claim 14, wherein comparing the set of attributes to the attribute(s) associated with each application in the plurality of applications comprises:
querying a relational database that maps attributes to applications to identify applications that have attributes that match the set of attributes.

16. The method of claim 1 wherein determining the one or more features of the mobile electronic device comprises:
querying the mobile electronic device to determine the one or more features.

17. The method of claim 1, wherein determining the one or more features of the mobile electronic device comprises:
obtaining an identifier of the mobile electronic device;
using the identifier to obtain the one or more features of the mobile electronic device from a database that maps identifiers of mobile electronic devices to features of mobile electronic devices.

18. The method of claim 1, further comprising:
identifying the plurality of applications by executing an application search based on search criteria selected and/or input by a user of the mobile electronic device.

19. The method of claim 1, further comprising:
providing an interface by which a developer can submit a new application to the application store and specify one or more attributes associated with the new application.

20. The method of claim 1, further comprising:
providing an interface that enables an administrator to add or remove attributes associated with applications.

21. A system that performs attribute-based presentation of applications available in an application store to a mobile electronic device, comprising:
a feature determination module configured to determine one or more features of the mobile electronic device;
an application search module configured to determine if each application in a plurality of applications in the application store is suitable for installation and/or execution by the mobile electronic device by comparing the determined one or more features of the mobile electronic device to one or more attributes associated with the application; and
an application presentation module configured to transmit to the mobile electronic device a list that includes any application in the plurality of applications that is determined by the application search module to be suitable for execution by the mobile electronic device.

22. The system of claim 21, wherein the application search module is configured to compare the determined one or more features of the mobile electronic device to the attribute(s) associated with the application by comparing an operating system of the mobile electronic device to an attribute that specifies a target operating system for the application.

23. The system of claim 21, wherein the application search module is configured to compare the determined one or more features of the mobile electronic device to the attribute(s) associated with the application by comparing an operating system version of the mobile electronic device to an attribute that specifies a minimum supported operating system version for the application.

24. The system of claim 21, wherein the application search module is configured to compare the determined one or more features of the mobile electronic device to the attribute(s) associated with the application by comparing an operating system version of the mobile electronic device to an attribute that specifies a latest-released version of an operating system upon which the application has been tested.

25. The system of claim 21, wherein the application search module is configured to compare the determined one or more features of the mobile electronic device to the attribute(s) associated with the application by comparing a product type of the mobile electronic device to an attribute that specifies a product type supported by the application.

26. The system of claim 21, wherein the application search module is configured to compare the determined one or more features of the mobile electronic device to the attribute(s) associated with the application by comparing the determined one or more features of the mobile electronic device to an attribute that specifies a hardware feature that is required by the application.

27. The system of claim 26, wherein the hardware feature that is required by the application comprises:
an accelerator;
a magnetometer;
a Global Positioning System (GPS) receiver;
a microphone;
a camera;
multiple cameras; or
multiple displays.

28. The system of claim 21, wherein the application search module is configured to compare the determined one or more features of the mobile electronic device to the attribute(s) associated with the application by comparing one or more display resolutions supported by the mobile electronic device to an attribute that specifies one or more display resolutions supported by the application.

29. The system of claim 21, wherein the application search module is configured to compare the determined one or more features of the mobile electronic device to the attribute(s) associated with the application by comparing a vendor of the mobile electronic device to an attribute that specifies a vendor of mobile electronic devices.

30. The system of claim 21, wherein the application search module is configured to compare the determined one or more features of the mobile electronic device to the attribute(s) associated with the application by comparing a service provider used by the mobile electronic device to an attribute that specifies a service provider.

31. The system of claim 21, wherein the application search module is configured to compare the determined one or more features of the mobile electronic device to the attribute(s) associated with the application by comparing a customer type associated with the mobile electronic device to an attribute that specifies a particular customer type.

32. The system of claim 21, wherein the application search module is configured to obtain the attribute(s) associated with the application from descriptive metadata associated with the application.

33. The system of claim 21, wherein the application search module is configured to obtain the attribute(s) associated with the application from a relational database that maps attributes to applications.

34. The system of claim 21, wherein the application search module is configured to determine a set of attributes necessary to install and/or execute an application on the mobile electronic device based on the determined one or more features of the mobile electronic device and to compare the set of attributes to the attribute(s) associated with each application in the plurality of applications.

35. The system of claim 34, wherein the application search module is configured to query a relational database that maps attributes to applications to identify applications that have attributes that match the set of attributes.

36. The system of claim 21, wherein the feature determination module is configured to receive the one or more features from an application store application that queries the mobile electronic device to determine the one or more features.

37. The system of claim 21, wherein the feature determination module is configured to obtain an identifier of the mobile electronic device and to use the identifier to obtain the one or more features of the mobile electronic device from a database that maps identifiers of mobile electronic devices to features of mobile electronic devices.

38. The system of claim 21, wherein the application search module is further configured to identify the plurality of applications by executing an application search based on search criteria selected and/or input by a user of the mobile electronic device.

39. The system of claim 21, further comprising:
a developer interface server configured to provide an interface by which a developer can submit a new application to the application store and specify one or more attributes associated with the new application.

40. The system of claim 21, further comprising:
an administrator interface server configured to provide an interface that enables an administrator to add or remove attributes associated with applications.

41. A computer program product comprising a computer-readable medium having computer logic recorded thereon for enabling a processing unit to perform attribute-based presentation of applications available in an application store to a mobile electronic device, the computer program logic comprising:
first computer program logic that, when executed by the processing unit, causes the processing unit to determine one or more features of the mobile electronic device;
second computer program logic that, when executed by the processing unit, causes the processing unit to determine if each application in a plurality of applications in the application store is suitable for installation and/or execution by the mobile electronic device by comparing the determined one or more features of the mobile electronic device to one or more attributes associated with the application; and
third computer program logic that, when executed by the processing unit, causes the processing unit to transmit to the mobile electronic device a list that includes any application in the plurality of applications that is determined to be suitable for execution by the mobile electronic device.
